(19) United States
(12) Patent Application Publication
(10) Pub. No.: US 2022/0404592 A1
(43) Pub. Date: Dec. 22, 2022

(54) OPTICAL IMAGING LENS

(71) Applicant: GENIUS ELECTRONIC OPTICAL (XIAMEN) CO., LTD., Xiamen (CN)

(72) Inventors: Jia-Sin Jhang, Taichung City (TW); Maozong Lin, Xiamen (CN); JianPeng Li, Xiamen (CN)

(73) Assignee: GENIUS ELECTRONIC OPTICAL (XIAMEN) CO., LTD., Xiamen (CN)

(21) Appl. No.: 17/893,208

(22) Filed: Aug. 23, 2022

Related U.S. Application Data
(63) Continuation of application No. 16/931,458, filed on Jul. 17, 2020.

(30) Foreign Application Priority Data
Mar. 31, 2020 (CN) 202010246311.1

(51) Int. Cl. G02B 13/00; G02B 9/62; G02B 27/00

(52) U.S. Cl. CPC G02B 13/0045; G02B 9/62; G02B 27/0025

(57) ABSTRACT

An optical imaging lens including a first lens element, a second lens element, a third lens element, a fourth lens element, a fifth lens element and a sixth lens element sequentially along an optical axis from an object-side to an image-side is provided. The optical imaging lens satisfies the condition of V1+V2+V3+V5≤100.000. Furthermore, other optical imaging lenses are also provided.

### CROSS-REFERENCE TO RELATED APPLICATION

This application is a continuation application of and claims the priority benefit of U.S. application Ser. No. 16/931,458, filed on Jul. 17, 2020, now pending, which claims the priority benefit of China application serial no. 202010246311.1, filed on Mar. 31, 2020. The entirety of each of the above-mentioned patent applications is hereby incorporated by reference herein and made a part of this specification.

### BACKGROUND

### Technical Field

The disclosure relates to an optical element, and in particular, to an optical imaging lens.

### Description of Related Art

Specifications of portable electronic apparatus change rapidly, and the optical imaging lens serving as key components are also developed in diversified ways. The main lens of the portable electronic apparatus not only requires a larger aperture and needs to be maintained a shorter system length, but also pursues higher pixels and higher resolution. However, the higher pixels demand implies that image height of the lens must be increased by the way of adopting a larger image sensor to receive imaging rays so as to increase pixel requirements. However, the large aperture design can make the lens to receive more imaging rays, and that would cause the design difficulty increase. The high pixels design makes the resolution of the lens need to be improved, and acts in concert with large aperture design make the whole lens design more difficult. Besides, according to the ideal image height formula, if the optical imaging lens increases the field of view, and the distortion increases at the same time.

Therefore, how to add multiple lenses within a limited system length range and to increase resolution, aperture, field of view angle and image height and maintain distortion at the same time is a problem that needs to be challenged and solved.

### SUMMARY

The disclosure provides an optical imaging lens, which can increase optical imaging quality such as resolution, aperture, field of view angle and image height at the same time and maintain distortion under a situation of a small volume.

An embodiment of the disclosure provides an optical imaging lens, sequentially including a first lens element, a second lens element, a third lens element, a fourth lens element, a fifth lens element, and a sixth lens element from an object side to an image side along an optical axis. Each of the first lens element to the sixth lens element includes an object-side surface facing the object side and allowing imaging rays to pass through and an image-side surface facing the image side and allowing the imaging rays to pass through. The first lens element is arranged to be a lens element in a first order from the object side to the image side and the first lens element has negative refracting power. The second lens element is arranged to be a lens element in a second order from the object side to the image side, and a periphery region of the image-side surface of the second lens element is concave. The third lens element is arranged to be a lens element in a third order from the object side to the image side, and an optical axis region of the image-side surface of the third lens element is convex. The fourth lens element is arranged to be a lens element in a fourth order from the object side to the image side, and an optical axis region of the image-side surface of the fourth lens element is concave. The fifth lens element is arranged to be a lens element in a fifth order from the object side to the image side, and an optical axis region of the object-side surface of the fifth lens element is concave. The sixth lens element is arranged to be a lens element in a last order from the object side to the image side, a periphery region of the image-side surface of the sixth lens element is convex on a reference plane parallel to the optical axis. The optical imaging lens satisfies the following conditional expression: V1+V2+V3≤110.000, wherein V1 is an abbe number of the first lens element, V2 is an abbe number of the second lens element, and V3 is an abbe number of the third lens element.

An embodiment of the disclosure provides an optical imaging lens, sequentially including a first lens element, a second lens element, a third lens element, a fourth lens element, a fifth lens element, and a sixth lens element from an object side to an image side along an optical axis. Each of the first lens element to the sixth lens element includes an object-side surface facing the object side and allowing imaging rays to pass through and an image-side surface facing the image side and allowing the imaging rays to pass through. The first lens element is arranged to be a lens element in a first order from the object side to the image side and the first lens element has negative refracting power. The second lens element is arranged to be a lens element in a second order from the object side to the image side, and a periphery region of the image-side surface of the second lens element is concave. The third lens element is arranged to be a lens element in a third order from the object side to the image side, a periphery region of the object-side surface of the third lens element is concave and an optical axis region of the image-side surface of the third lens element is convex. The fourth lens element is arranged to be a lens element in a fourth order from the object side to the image side. The fifth lens element is arranged to be a lens element in a fifth order from the object side to the image side, the fifth lens element has positive refracting power and an optical axis region of the object-side surface of the fifth lens element is concave. The sixth lens element is arranged to be a lens element in a last order from the object side to the image side. The optical imaging lens satisfies the following conditional expression: V1+V2+V3≤110.000, wherein V1 is an abbe number of the first lens element, V2 is an abbe number of the second lens element, and V3 is an abbe number of the third lens element.

An embodiment of the disclosure provides an optical imaging lens, sequentially including a first lens element, a second lens element, a third lens element, a fourth lens element, a fifth lens element, and a sixth lens element from an object side to an image side along an optical axis. Each of the first lens element to the sixth lens element includes an object-side surface facing the object side and allowing imaging rays to pass through and an image-side surface facing the image side and allowing the imaging rays to pass through. The first lens element is arranged to be a lens element in a first order from the object side to the image side and the first lens element has negative refracting power. The second lens element is arranged to be a lens element in a second order from the object side to the image side, and a periphery region of the image-side surface of the second lens element is concave. The third lens element is arranged to be a lens element in a third order from the object side to the image side. The fourth lens element is arranged to be a lens element in a fourth order from the object side to the image side and an optical axis region of the image-side surface of the fourth lens element is concave. The fifth lens element is arranged to be a lens element in a fifth order from the object side to the image side, the fifth lens element has positive refracting power and an optical axis region of the object-side surface of the fifth lens element is concave. The sixth lens element is arranged to be a lens element in a last order from the image side to the object side, an optical axis region of the object-side surface of the sixth lens element is convex. The optical imaging lens satisfies the following conditional expressions: ImgH/D11t21≥4.000 and D52t62/D12t22≥1.600, wherein ImgH is an image height of the optical imaging lens, D11t21 is a distance from the object-side surface of the first lens element to the object-side surface of the second lens element along the optical axis, D52t62 is a distance from the image-side surface of the fifth lens element to the image-side surface of the sixth lens element along the optical axis, and D12t22 is a distance from the image-side surface of the first lens element to the image-side surface of the second lens element along the optical axis.

Based on the above, the optical imaging lens in the embodiments of the disclosure has the following beneficial effects: as designed to satisfy the foregoing concave-convex surface and free form surface arrangement of lens elements and refracting power conditions and satisfy the foregoing conditional expressions, the optical imaging lens can increase optical imaging quality such as resolution, aperture, field of view angle and image height at the same time and maintain distortion under a situation of a small volume.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram to describe a surface structure of a lens element.

FIG. 2 is a schematic diagram to describe a concave-convex surface structure and a ray focus of a lens element.

FIG. 3 is a schematic diagram to describe a surface structure of a lens element in an example 1.

FIG. 4 is a schematic diagram to describe a surface structure of a lens element in an example 2.

FIG. 5 is a schematic diagram to describe a surface structure of a lens element in an example 3.

FIG. 6A is a radial cross-sectional view of the free form surface of the free-form lens element.

FIG. 6B is a schematic front view of the free-form lens element of FIG. 6A viewed from the Z-axis direction.

FIG. 6C and FIG. 6D are partial cross-sectional schematic views of the free form surface of FIG. 6B at coordinates (−b, a) and coordinates (a, b), respectively.

FIG. 7A is a schematic diagram of an optical imaging lens according to a first embodiment of the disclosure.

FIG. 7B is an enlarged radial cross-sectional view of the sixth lens element of FIG. 7A crossed by different planes.

FIG. 7C is a schematic diagram of the appearance of the sixth lens element of FIG. 7A.

FIG. 8A to FIG. 8D are diagrams of longitudinal spherical aberrations and astigmatic aberrations of the optical imaging lens according to the first embodiment.

FIG. 9 shows detailed optical data of the optical imaging lens according to the first embodiment of the disclosure.

FIG. 10A and FIG. 10B show an aspheric surface parameter of the optical imaging lens according to the first embodiment of the disclosure.

FIG. 10C and FIG. 10D show parameters of the X^{m}Yⁿ of the optical imaging lens according to the first embodiment of the disclosure.

FIG. 10E shows Sag values corresponding to two selected coordinate values on the XY plane of the sixth lens element according to the first embodiment of the disclosure.

FIG. 11A is a schematic diagram of an optical imaging lens according to a second embodiment of the disclosure.

FIG. 11B is an enlarged radial cross-sectional view of the sixth lens element of FIG. 11A crossed by different planes.

FIG. 11C is a schematic diagram of the appearance of the sixth lens element of FIG. 11A.

FIG. 12A to FIG. 12D are diagrams of longitudinal spherical aberrations and astigmatic aberrations of the optical imaging lens according to the second embodiment.

FIG. 13 shows detailed optical data of the optical imaging lens according to the second embodiment of the disclosure.

FIG. 14A and FIG. 14B show an aspheric surface parameter of the optical imaging lens according to the second embodiment of the disclosure.

FIG. 14C and FIG. 14D show parameters of the X^{m}Yⁿ of the optical imaging lens according to the second embodiment of the disclosure.

FIG. 14E shows Sag values corresponding to two selected coordinate values on the XY plane of the sixth lens element according to the second embodiment of the disclosure.

FIG. 15A is a schematic diagram of an optical imaging lens according to a third embodiment of the disclosure.

FIG. 15B is an enlarged radial cross-sectional view of the sixth lens element of FIG. 15A crossed by different planes.

FIG. 15C is a schematic diagram of the appearance of the sixth lens element of FIG. 15A.

FIG. 16A to FIG. 16D are diagrams of longitudinal spherical aberrations and astigmatic aberrations of the optical imaging lens according to the third embodiment.

FIG. 17 shows detailed optical data of the optical imaging lens according to the third embodiment of the disclosure.

FIG. 18A and FIG. 18B show an aspheric surface parameter of the optical imaging lens according to the third embodiment of the disclosure.

FIG. 18C and FIG. 18D show parameters of the X^{m}Yⁿ of the optical imaging lens according to the third embodiment of the disclosure.

FIG. 18E shows Sag values corresponding to two selected coordinate values on the XY plane of the sixth lens element according to the third embodiment of the disclosure.

FIG. 19A is a schematic diagram of an optical imaging lens according to a fourth embodiment of the disclosure.

FIG. 19B is an enlarged radial cross-sectional view of the sixth lens element of FIG. 19A crossed by different planes.

FIG. 19C is a schematic diagram of the appearance of the sixth lens element of FIG. 19A.

FIG. 20A to FIG. 20D are diagrams of longitudinal spherical aberrations and astigmatic aberrations of the optical imaging lens according to the fourth embodiment.

FIG. 21 shows detailed optical data of the optical imaging lens according to the fourth embodiment of the disclosure.

FIG. 22A and FIG. 22B show an aspheric surface parameter of the optical imaging lens according to the fourth embodiment of the disclosure.

FIG. 22C and FIG. 22D show parameters of the X^{m}Yⁿ of the optical imaging lens according to the fourth embodiment of the disclosure.

FIG. 22E shows Sag values corresponding to two selected coordinate values on the XY plane of the sixth lens element according to the fourth embodiment of the disclosure.

FIG. 23A is a schematic diagram of an optical imaging lens according to a fifth embodiment of the disclosure.

FIG. 23B is an enlarged radial cross-sectional view of the sixth lens element of FIG. 23A crossed by different planes.

FIG. 23C is a schematic diagram of the appearance of the sixth lens element of FIG. 23A.

FIG. 24A to FIG. 24D are diagrams of longitudinal spherical aberrations and astigmatic aberrations of the optical imaging lens according to the fifth embodiment.

FIG. 25 shows detailed optical data of the optical imaging lens according to the fifth embodiment of the disclosure.

FIG. 26A and FIG. 26B show an aspheric surface parameter of the optical imaging lens according to the fifth embodiment of the disclosure.

FIG. 26C and FIG. 26D show parameters of the X^{m}Yⁿ of the optical imaging lens according to the fifth embodiment of the disclosure.

FIG. 26E shows Sag values corresponding to two selected coordinate values on the XY plane of the sixth lens element according to the fifth embodiment of the disclosure.

FIG. 27A is a schematic diagram of an optical imaging lens according to a sixth embodiment of the disclosure.

FIG. 27B is an enlarged radial cross-sectional view of the sixth lens element of FIG. 27A crossed by different planes.

FIG. 27C is a schematic diagram of the appearance of the sixth lens element of FIG. 27A.

FIG. 28A to FIG. 28D are diagrams of longitudinal spherical aberrations and astigmatic aberrations of the optical imaging lens according to the sixth embodiment.

FIG. 29 shows detailed optical data of the optical imaging lens according to the sixth embodiment of the disclosure.

FIG. 30A and FIG. 30B show an aspheric surface parameter of the optical imaging lens according to the sixth embodiment of the disclosure.

FIG. 30C and FIG. 30D show parameters of the X^{m}Yⁿ of the optical imaging lens according to the sixth embodiment of the disclosure.

FIG. 30E shows Sag values corresponding to two selected coordinate values on the XY plane of the sixth lens element according to the sixth embodiment of the disclosure.

FIG. 31A is a schematic diagram of an optical imaging lens according to a seventh embodiment of the disclosure.

FIG. 31B is an enlarged radial cross-sectional view of the sixth lens element of FIG. 31A crossed by different planes.

FIG. 31C is a schematic diagram of the appearance of the sixth lens element of FIG. 31A.

FIG. 32A to FIG. 32D are diagrams of longitudinal spherical aberrations and astigmatic aberrations of the optical imaging lens according to the seventh embodiment.

FIG. 33 shows detailed optical data of the optical imaging lens according to the seventh embodiment of the disclosure.

FIG. 34A and FIG. 34B show an aspheric surface parameter of the optical imaging lens according to the seventh embodiment of the disclosure.

FIG. 34C and FIG. 34D show parameters of the X^{m}Yⁿ of the optical imaging lens according to the seventh embodiment of the disclosure.

FIG. 34E shows Sag values corresponding to two selected coordinate values on the XY plane of the sixth lens element according to the seventh embodiment of the disclosure.

FIG. 35A is a schematic diagram of an optical imaging lens according to an eighth embodiment of the disclosure.

FIG. 35B is an enlarged radial cross-sectional view of the sixth lens element of FIG. 35A crossed by different planes.

FIG. 35C is a schematic diagram of the appearance of the sixth lens element of FIG. 35A.

FIG. 36A to FIG. 36D are diagrams of longitudinal spherical aberrations and astigmatic aberrations of the optical imaging lens according to the eighth embodiment.

FIG. 37 shows detailed optical data of the optical imaging lens according to the eighth embodiment of the disclosure.

FIG. 38A and FIG. 38B show an aspheric surface parameter of the optical imaging lens according to the eighth embodiment of the disclosure.

FIG. 38C and FIG. 38D show parameters of the X^{m}Yⁿ of the optical imaging lens according to the eighth embodiment of the disclosure.

FIG. 38E shows Sag values corresponding to two selected coordinate values on the XY plane of the fifth lens element according to the eighth embodiment of the disclosure.

FIG. 39 is a schematic diagram of an optical imaging lens according to a ninth embodiment of the disclosure.

FIG. 40A to FIG. 40D are diagrams of longitudinal spherical aberrations and astigmatic aberrations of the optical imaging lens according to the ninth embodiment.

FIG. 41 shows detailed optical data of the optical imaging lens according to the ninth embodiment of the disclosure.

FIG. 42A and FIG. 42B show an aspheric surface parameter of the optical imaging lens according to the ninth embodiment of the disclosure.

FIG. 42C shows parameters of the X^{m}Yⁿ of the optical imaging lens according to the ninth embodiment of the disclosure.

FIG. 43A is a schematic diagram of an optical imaging lens according to a tenth embodiment of the disclosure.

FIG. 43B is an enlarged radial cross-sectional view of the sixth lens element of FIG. 43A crossed by different planes.

FIG. 43C is a schematic diagram of the appearance of the sixth lens element of FIG. 43A.

FIG. 44A to FIG. 44D are diagrams of longitudinal spherical aberrations and astigmatic aberrations of the optical imaging lens according to the tenth embodiment.

FIG. 45 shows detailed optical data of the optical imaging lens according to the tenth embodiment of the disclosure.

FIG. 46A and FIG. 46B show an aspheric surface parameter of the optical imaging lens according to the tenth embodiment of the disclosure.

FIG. 46C and FIG. 46D show parameters of the X^{m}Yⁿ of the optical imaging lens according to the tenth embodiment of the disclosure.

FIG. 46E shows Sag values corresponding to two selected coordinate values on the XY plane of the sixth lens element according to the tenth embodiment of the disclosure.

FIG. 47A is a schematic diagram of an optical imaging lens according to an eleventh embodiment of the disclosure.

FIG. 47B is an enlarged radial cross-sectional view of the sixth lens element of FIG. 47A crossed by different planes.

FIG. 47C is a schematic diagram of the appearance of the sixth lens element of FIG. 47A.

FIG. 48A to FIG. 48D are diagrams of longitudinal spherical aberrations and astigmatic aberrations of the optical imaging lens according to the eleventh embodiment.

FIG. 49 shows detailed optical data of the optical imaging lens according to the eleventh embodiment of the disclosure.

FIG. 50A and FIG. 50B show an aspheric surface parameter of the optical imaging lens according to the eleventh embodiment of the disclosure.

FIG. 50C and FIG. 50D show parameters of the X^{m}Yⁿ of the optical imaging lens according to the eleventh embodiment of the disclosure.

FIG. 50E shows Sag values corresponding to two selected coordinate values on the XY plane of the sixth lens element according to the eleventh embodiment of the disclosure.

FIG. 51A is a schematic diagram of an optical imaging lens according to a twelfth embodiment of the disclosure.

FIG. 51B is an enlarged radial cross-sectional view of the sixth lens element of FIG. 51A crossed by different planes.

FIG. 51C is a schematic diagram of the appearance of the sixth lens element of FIG. 51A.

FIG. 52A to FIG. 52D are diagrams of longitudinal spherical aberrations and astigmatic aberrations of the optical imaging lens according to the twelfth embodiment.

FIG. 53 shows detailed optical data of the optical imaging lens according to the twelfth embodiment of the disclosure.

FIG. 54A and FIG. 54B show an aspheric surface parameter of the optical imaging lens according to the twelfth embodiment of the disclosure.

FIG. 54C and FIG. 54D show parameters of the X^{m}Yⁿ of the optical imaging lens according to the twelfth embodiment of the disclosure.

FIG. 54E shows Sag values corresponding to two selected coordinate values on the XY plane of the sixth lens element according to the twelfth embodiment of the disclosure.

FIG. 55A is a schematic diagram of an optical imaging lens according to a thirteenth embodiment of the disclosure.

FIG. 55B is an enlarged radial cross-sectional view of the sixth lens element of FIG. 55A crossed by different planes.

FIG. 55C is a schematic diagram of the appearance of the sixth lens element of FIG. 55A.

FIG. 56A to FIG. 56D are diagrams of longitudinal spherical aberrations and astigmatic aberrations of the optical imaging lens according to the thirteenth embodiment.

FIG. 57 shows detailed optical data of the optical imaging lens according to the thirteenth embodiment of the disclosure.

FIG. 58A and FIG. 58B show an aspheric surface parameter of the optical imaging lens according to the thirteenth embodiment of the disclosure.

FIG. 58C and FIG. 58D show parameters of the X^{m}Yⁿ of the optical imaging lens according to the thirteenth embodiment of the disclosure.

FIG. 58E shows Sag values corresponding to two selected coordinate values on the XY plane of the sixth lens element according to the thirteenth embodiment of the disclosure.

FIG. 59A is a schematic diagram of an optical imaging lens according to a fourteenth embodiment of the disclosure.

FIG. 59B is an enlarged radial cross-sectional view of the sixth lens element of FIG. 59A crossed by different planes.

FIG. 59C is a schematic diagram of the appearance of the sixth lens element of FIG. 59A.

FIG. 60A to FIG. 60D are diagrams of longitudinal spherical aberrations and astigmatic aberrations of the optical imaging lens according to the fourteenth embodiment.

FIG. 61 shows detailed optical data of the optical imaging lens according to the fourteenth embodiment of the disclosure.

FIG. 62A and FIG. 62B show an aspheric surface parameter of the optical imaging lens according to the fourteenth embodiment of the disclosure.

FIG. 62C and FIG. 62D show parameters of the X^{m}Yⁿ of the optical imaging lens according to the fourteenth embodiment of the disclosure.

FIG. 62E shows Sag values corresponding to two selected coordinate values on the XY plane of the sixth lens element according to the fourteenth embodiment of the disclosure.

FIG. 63A is a schematic diagram of an optical imaging lens according to a fifteenth embodiment of the disclosure.

FIG. 63B is an enlarged radial cross-sectional view of the sixth lens element of FIG. 63A crossed by different planes.

FIG. 63C is a schematic diagram of the appearance of the sixth lens element of FIG. 63A.

FIG. 64A to FIG. 64D are diagrams of longitudinal spherical aberrations and astigmatic aberrations of the optical imaging lens according to the fifteenth embodiment.

FIG. 65 shows detailed optical data of the optical imaging lens according to the fifteenth embodiment of the disclosure.

FIG. 66A and FIG. 66B show an aspheric surface parameter of the optical imaging lens according to the fifteenth embodiment of the disclosure.

FIG. 66C and FIG. 66D show parameters of the X^{m}Yⁿ of the optical imaging lens according to the fifteenth embodiment of the disclosure.

FIG. 66E shows Sag values corresponding to two selected coordinate values on the XY plane of the sixth lens element according to the fifteenth embodiment of the disclosure.

FIG. 67 is a schematic diagram of an optical imaging lens according to a sixteenth embodiment of the disclosure.

FIG. 68A to FIG. 68D are diagrams of longitudinal spherical aberrations and astigmatic aberrations of the optical imaging lens according to the sixteenth embodiment.

FIG. 69 shows detailed optical data of the optical imaging lens according to the sixteenth embodiment of the disclosure.

FIG. 70A and FIG. 70B show an aspheric surface parameter of the optical imaging lens according to the sixteenth embodiment of the disclosure.

FIG. 70C shows Sag values corresponding to two selected coordinate values on the XY plane of the sixth lens element according to the sixteenth embodiment of the disclosure.

FIG. 71A is a schematic diagram of an optical imaging lens according to a seventeenth embodiment of the disclosure.

FIG. 71B is an enlarged radial cross-sectional view of the fifth lens element of FIG. 71A crossed by different planes.

FIG. 71C is a schematic diagram of the appearance of the fifth lens element of FIG. 71A.

FIG. 72A to FIG. 72D are diagrams of longitudinal spherical aberrations and astigmatic aberrations of the optical imaging lens according to the seventeenth embodiment.

FIG. 73 shows detailed optical data of the optical imaging lens according to the seventeenth embodiment of the disclosure.

FIG. 74A and FIG. 74B show an aspheric surface parameter of the optical imaging lens according to the seventeenth embodiment of the disclosure.

FIG. 74C and FIG. 74D show parameters of the X^{m}Yⁿ of the optical imaging lens according to the seventeenth embodiment of the disclosure.

FIG. 74E shows Sag values corresponding to two selected coordinate values on the XY plane of the lens element according to the seventeenth embodiment of the disclosure.

FIG. 75 shows numerical values of important parameters and relational expressions of the optical imaging lens of the first to seventh embodiments of the disclosure.

FIG. 76 shows numerical values of important parameters and relational expressions of the optical imaging lens of the eighth to fourteenth embodiments of the disclosure.

FIG. 77 shows numerical values of important parameters and relational expressions of the optical imaging lens of the fifteenth to seventeenth embodiments of the disclosure.

### DESCRIPTION OF THE EMBODIMENTS

The terms “optical axis region”, “periphery region”, “concave”, and “convex” used in this specification and claims should be interpreted based on the definition listed in the specification by the principle of lexicographer.

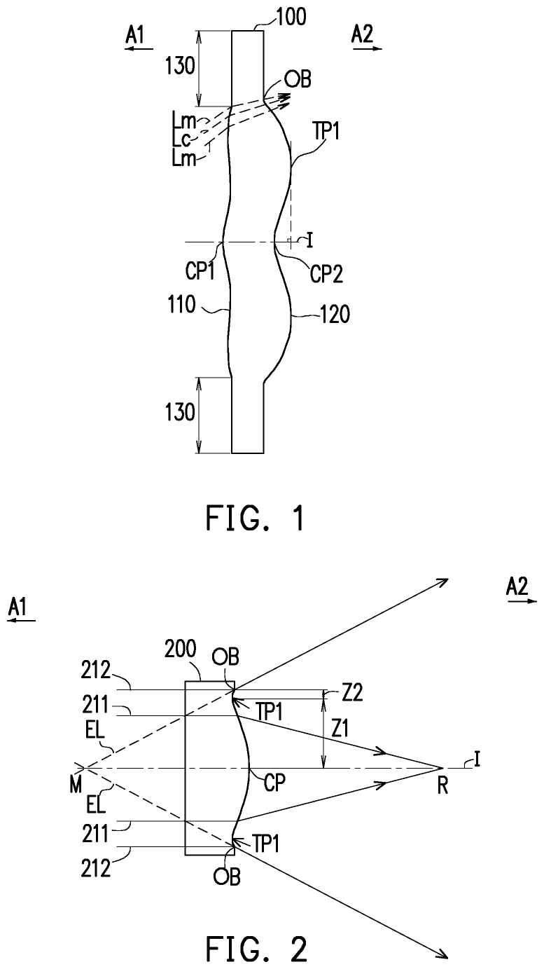

In the present disclosure, the optical system may comprise at least one lens element to receive imaging rays that are incident on the optical system over a set of angles ranging from parallel to an optical axis to a half field of view (HFOV) angle with respect to the optical axis. The imaging rays pass through the optical system to produce an image on an image plane. The term “a lens element having positive refracting power (or negative refracting power)” means that the paraxial refracting power of the lens element in Gaussian optics is positive (or negative). The term “an object-side (or image-side) surface of a lens element” refers to a specific region of that surface of the lens element at which imaging rays can pass through that specific region. Imaging rays include at least two types of rays: a chief ray Lc and a marginal ray Lm (as shown in FIG. 1). An object-side (or image-side) surface of a lens element can be characterized as having several regions, including an optical axis region, a periphery region, and, in some cases, one or more intermediate regions, as discussed more fully below.

FIG. 1 is a radial cross-sectional view of a lens element 100. Two referential points for the surfaces of the lens element 100 can be defined: a central point, and a transition point. The central point of a surface of a lens element is a point of intersection of that surface and the optical axis I. As illustrated in FIG. 1, a first central point CP1 may be present on the object-side surface 110 of lens element 100 and a second central point CP2 may be present on the image-side surface 120 of the lens element 100. The transition point is a point on a surface of a lens element, at which the line tangent to that point is perpendicular to the optical axis I. The optical boundary OB of a surface of the lens element is defined as a point at which the radially outermost marginal ray Lm passing through the surface of the lens element intersects the surface of the lens element. All transition points lie between the optical axis I and the optical boundary OB of the surface of the lens element. If multiple transition points are present on a single surface, then these transition points are sequentially named along the radial direction of the surface with reference numerals starting from the first transition point. For example, the first transition point, e.g., TP1, (closest to the optical axis I), the second transition point, e.g., TP2, (as shown in FIG. 4), and the Nth transition point (farthest from the optical axis I).

The region of a surface of the lens element from the central point to the first transition point TP1 is defined as the optical axis region, which includes the central point. The region located radially outside of the farthest Nth transition point from the optical axis I to the optical boundary OB of the surface of the lens element is defined as the periphery region. In some embodiments, there may be intermediate regions present between the optical axis region and the periphery region, with the number of intermediate regions depending on the number of the transition points.

The shape of a region is convex if a collimated ray being parallel to the optical axis I and passing through the region is bent toward the optical axis I such that the ray intersects the optical axis I on the image side A2 of the lens element. The shape of a region is concave if the extension line of a collimated ray being parallel to the optical axis I and passing through the region intersects the optical axis I on the object side A1 of the lens element.

Additionally, referring to FIG. 1, the lens element 100 may also have a mounting portion 130 extending radially outward from the optical boundary OB. The mounting portion 130 is typically used to physically secure the lens element to a corresponding element of the optical system (not shown). Imaging rays do not reach the mounting portion 130. The structure and shape of the mounting portion 130 are only examples to explain the technologies, and should not be taken as limiting the scope of the present disclosure. The mounting portion 130 of the lens elements discussed below may be partially or completely omitted in the following drawings.

Referring to FIG. 2, optical axis region Z1 is defined between central point CP and first transition point TP1. Periphery region Z2 is defined between TP1 and the optical boundary OB of the surface of the lens element. Collimated ray 211 intersects the optical axis I on the image side A2 of lens element 200 after passing through optical axis region Z1, i.e., the focal point of collimated ray 211 after passing through optical axis region Z1 is on the image side A2 of the lens element 200 at point R in FIG. 2. Accordingly, since the ray itself intersects the optical axis I on the image side A2 of the lens element 200, optical axis region Z1 is convex. On the contrary, collimated ray 212 diverges after passing through periphery region Z2. The extension line EL of collimated ray 212 after passing through periphery region Z2 intersects the optical axis I on the object side A1 of lens element 200, i.e., the focal point of collimated ray 212 after passing through periphery region Z2 is on the object side A1 at point M in FIG. 2. Accordingly, since the extension line EL of the ray intersects the optical axis I on the object side A1 of the lens element 200, periphery region Z2 is concave. In the lens element 200 illustrated in FIG. 2, the first transition point TP1 is the border of the optical axis region and the periphery region, i.e., TP1 is the point at which the shape changes from convex to concave.

Alternatively, there is another way for a person having ordinary skill in the art to determine whether an optical axis region is convex or concave by referring to the sign of “Radius” (the “R” value), which is the paraxial radius of shape of a lens surface in the optical axis region. The R value is commonly used in conventional optical design software such as Zemax and CodeV. The R value usually appears in the lens data sheet in the software. For an object-side surface, a positive R value defines that the optical axis region of the object-side surface is convex, and a negative R value defines that the optical axis region of the object-side surface is concave. Conversely, for an image-side surface, a positive R value defines that the optical axis region of the image-side surface is concave, and a negative R value defines that the optical axis region of the image-side surface is convex. The result found by using this method should be consistent with the method utilizing intersection of the optical axis by rays/extension lines mentioned above, which determines surface shape by referring to whether the focal point of a collimated ray being parallel to the optical axis I is on the object-side or the image-side of a lens element. As used herein, the terms “a shape of a region is convex (concave),” “a region is convex (concave),” and “a convex- (concave-) region,” can be used alternatively.

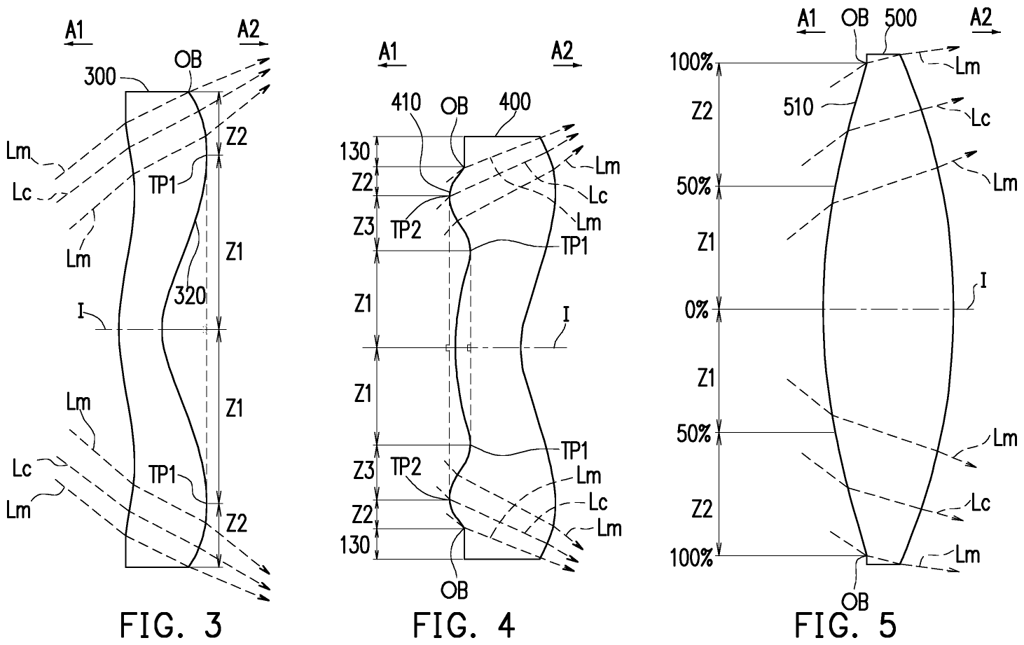

FIG. 3, FIG. 4 and FIG. 5 illustrate examples of determining the shape of lens element regions and the boundaries of regions under various circumstances, including the optical axis region, the periphery region, and intermediate regions as set forth in the present specification.

FIG. 3 is a radial cross-sectional view of a lens element 300. As illustrated in FIG. 3, only one transition point TP1 appears within the optical boundary OB of the image-side surface 320 of the lens element 300. Optical axis region Z1 and periphery region Z2 of the image-side surface 320 of lens element 300 are illustrated. The R value of the image-side surface 320 is positive (i.e., R>0). Accordingly, the optical axis region Z1 is concave.

In general, the shape of each region demarcated by the transition point will have an opposite shape to the shape of the adjacent region(s). Accordingly, the transition point will define a transition in shape, changing from concave to convex at the transition point or changing from convex to concave. In FIG. 3, since the shape of the optical axis region Z1 is concave, the shape of the periphery region Z2 will be convex as the shape changes at the transition point TP1.

FIG. 4 is a radial cross-sectional view of a lens element 400. Referring to FIG. 4, a first transition point TP1 and a second transition point TP2 are present on the object-side surface 410 of lens element 400. The optical axis region Z1 of the object-side surface 410 is defined between the optical axis I and the first transition point TP1. The R value of the object-side surface 410 is positive (i.e., R>0). Accordingly, the optical axis region Z1 is convex.

The periphery region Z2 of the object-side surface 410, which is also convex, is defined between the second transition point TP2 and the optical boundary OB of the object-side surface 410 of the lens element 400. Further, intermediate region Z3 of the object-side surface 410, which is concave, is defined between the first transition point TP1 and the second transition point TP2. Referring once again to FIG. 4, the object-side surface 410 includes an optical axis region Z1 located between the optical axis I and the first transition point TP1, an intermediate region Z3 located between the first transition point TP1 and the second transition point TP2, and a periphery region Z2 located between the second transition point TP2 and the optical boundary OB of the object-side surface 410. Since the shape of the optical axis region Z1 is designed to be convex, the shape of the intermediate region Z3 is concave as the shape of the intermediate region Z3 changes at the first transition point TP1, and the shape of the periphery region Z2 is convex as the shape of the periphery region Z2 changes at the second transition point TP2.

FIG. 5 is a radial cross-sectional view of a lens element 500. Lens element 500 has no transition point on the object-side surface 510 of the lens element 500. For a surface of a lens element with no transition point, for example, the object-side surface 510 the lens element 500, the optical axis region Z1 is defined as the region between 0-50% of the distance between the optical axis I and the optical boundary OB of the surface of the lens element and the periphery region is defined as the region between 50%-100% of the distance between the optical axis I and the optical boundary OB of the surface of the lens element. Referring to lens element 500 illustrated in FIG. 5, the optical axis region Z1 of the object-side surface 510 is defined between the optical axis I and 50% of the distance between the optical axis I and the optical boundary OB. The R value of the object-side surface 510 is positive (i.e., R>0). Accordingly, the optical axis region Z1 is convex. For the object-side surface 510 of the lens element 500, because there is no transition point, the periphery region Z2 of the object-side surface 510 is also convex. It should be noted that lens element 500 may have a mounting portion (not shown) extending radially outward from the periphery region Z2.

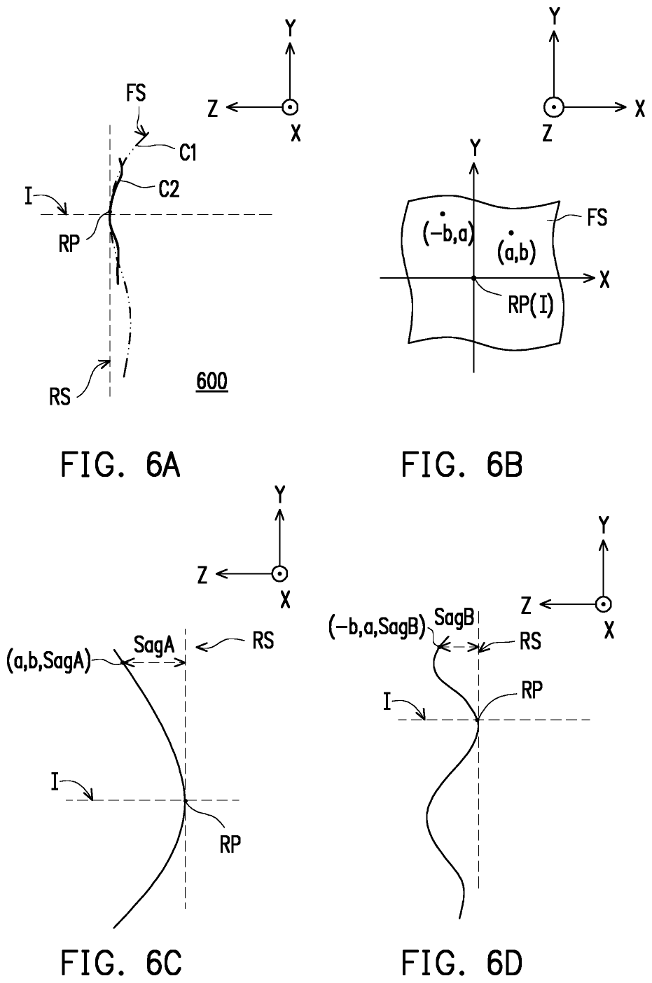

FIG. 6A is a radial cross-sectional view of the free form surface of the free-form lens element. FIG. 6B is a schematic front view of the free-form lens element of FIG. 6A viewed from the Z-axis direction. FIG. 6C and FIG. 6D are partial cross-sectional schematic views of the free form surface of FIG. 6B at coordinates (−b, a) and coordinates (a, b), respectively.

For convenience of explanation, the free-form lens element 600 can be regarded as being in the space formed by the X-axis, Y-axis, and Z-axis, the X-axis, the Y-axis, and the Z-axis are perpendicular to each other, and the Z-axis coincides with the optical axis I, and the free-form lens element 600 has a free form surface FS. Please refer to FIG. 6A. First of all, define a first reference plane and a second reference plane which are different from each other. The first reference plane and the second reference plane each contains the optical axis I. That is, the optical axis I falls completely in the first reference plane, and the optical axis I falls completely in the second reference plane. And the first reference plane, for example, further includes the X-axis, and the second reference plane, for example, further includes the Y-axis, in other words, the first reference plane can be regarded as parallel to the XZ plane formed by the X-axis and the Z-axis, the second reference plane can be regarded as parallel to the YZ plane formed by the Y-axis and the Z-axis, the first reference plane and the second reference plane intersect at the optical axis I without overlapping. The free form surface FS of free-form lens element 600 contains first curve C1 and second curve C2, the first curve C1 is the curve where the free form surface FS is crossed by the first reference plane, and the second curve C2 is the curve where the free form surface FS is crossed by the second reference plane. The characteristics of the free form surface FS of the embodiment of the present disclosure are: if the first curve C1 in the first reference plane is rotated to the second reference plane with the optical axis I as the rotation axis, the first curve C1 is at least partially offset from the second curve C2, and vice versa. In other words, when rotating to the same plane, the first and second curves C1, C2 will not completely overlap (or do not coincide).

The free form surface FS of the embodiment of the present disclosure may have further characteristics. From another point of view, define a reference point RP and a reference plane RS, the reference point RP is the point where the free form surface FS intersects the optical axis I, and the normal vector of the reference plane RS is in the Z direction and the reference plane RS includes the reference point RP. Please refer to FIG. 6B. Select a first coordinate value and a second coordinate value on the XY plane. The first coordinate value is X=a, Y=b, and the second coordinate value is X=−b, Y=a. The connection line between the first coordinate value and the reference point RP and the connection line between the second coordinate value and the reference point RP are perpendicular to each other on the XY plane. Please refer to FIG. 6C. When X=a and Y=b, the distance between free form surface FS and reference plane RS in the z-axis direction is SagA. Please refer to FIG. 6D. And when X=−b, Y=a, the distance between free form surface FS and reference plane RS in the z-axis direction is SagB. SagB represents the vertical distance between the point at X=−b and Y=a and the reference plane RS. The free form surface FS of the embodiment of the present disclosure has the following characteristic: SagA is not equal to SagB. In addition, it should be noted that, for convenience of explanation, the curves shown in FIG. 6C and FIG. 6D are only schematics, and the present disclosure is not limited thereto.

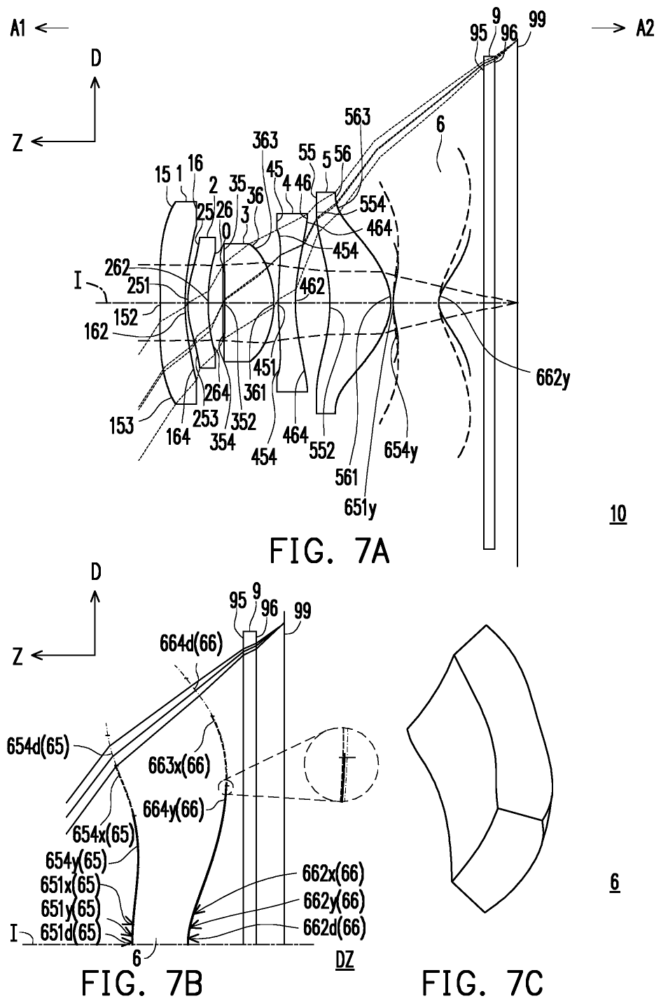

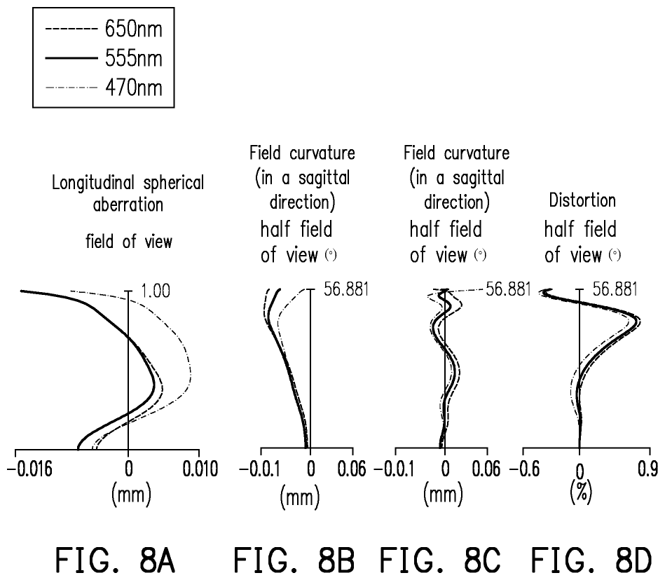

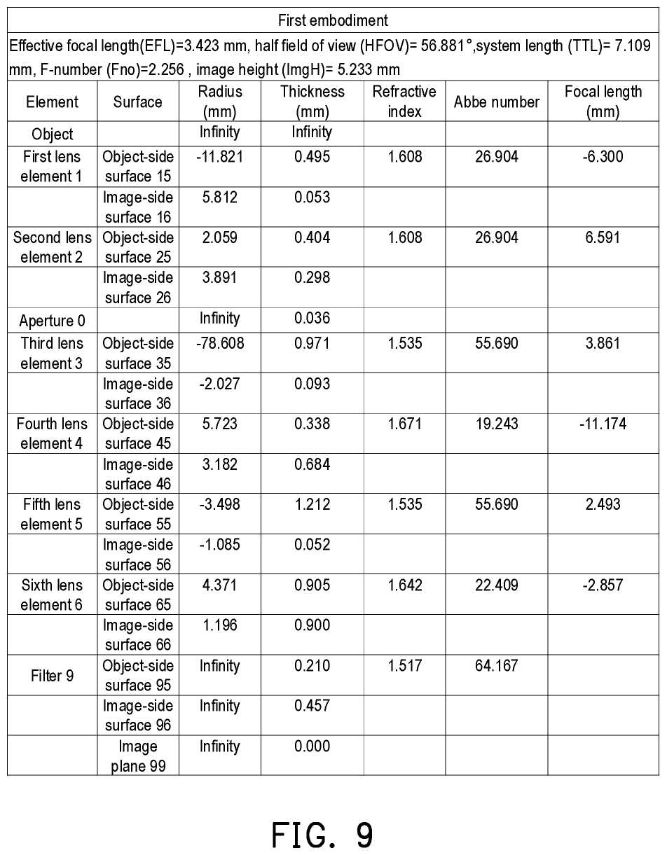

FIG. 7A is a schematic diagram of an optical imaging lens according to a first embodiment of the disclosure. FIG. 7A illustrates the surface structure of the optical imaging lens crossed by the third reference plane. The first reference plane is parallel to the XZ plane, the second reference plane is parallel to the YZ plane, and the third reference plane is parallel to the DZ plane, wherein the DZ plane is defined by the Z-axis and the diagonal direction D (not shown) of the image plane 99 (the diagonal direction D rotating from the XZ plane by 34.23 degrees about the optical axis). FIG. 7B is an enlarged radial cross-sectional view of the sixth lens element of FIG. 7A crossed by different planes. FIG. 7C is a schematic diagram of the appearance of the sixth lens element of FIG. 7A. FIG. 8A to FIG. 8D are diagrams of longitudinal spherical aberrations and astigmatic aberrations of the optical imaging lens according to the first embodiment. Referring to FIG. 7A, an optical imaging lens 10 in the first embodiment of the disclosure sequentially includes a first lens element 1, a second lens element 2, an aperture 0, a third lens element 3, a fourth lens element 4, a fifth lens element 5, a sixth lens element 6, and a filter 9 from an object side A1 to an image side A2 along an optical axis I of the optical imaging lens 10. After entering the optical imaging lens 10, rays emitted from a to-be-photographed object pass through the first lens element 1, the second lens element 2, the aperture 0, the third lens element 3, the fourth lens element 4, the fifth lens element 5, the sixth lens element 6, and the filter 9, and form an image on an image plane 99. The filter 9 is disposed between an image-side surface 66 of the sixth lens element 6 and the image plane 99. It should be noted that, the object side is a side facing the to-be-photographed object, and the image side is a side facing the image plane 99. In the present embodiment, the filter 9 is an infrared ray (IR) cut filter.

In the present embodiment, the first lens element 1, the second lens element 2, the third lens element 3, the fourth lens element 4, the fifth lens element 5, the sixth lens element 6, and the filter 9 of the optical imaging lens 10 include object-side surfaces 15, 25, 35, 45, 55, 65 and 95 facing the object side and allowing imaging rays to pass through and image-side surfaces 16, 26, 36, 46, 56, 66 and 96 facing the image side and allowing the imaging rays to pass through, respectively. In the present embodiment, the aperture 0 is disposed between the second lens element 2 and the third lens element 3. Since the curves which are formed by the any one of reference plane parallel to the optical axis I intersecting with the first lens elements 1 to the fifth lens elements are the same; therefore, the following paragraphs use the curves respectively intersects by the third reference plane to illustrate the first lens elements 1 to the fifth elements 5.

The first lens element 1 is arranged to be a lens element in a first order from the object side A1 to the image side A2. The first lens element 1 has negative refracting power. The first lens element 1 is made from a plastic material. An optical axis region 152 of the object-side surface 15 of the first lens element 1 is concave, and a periphery region 153 of the object-side surface 15 of the first lens element 1 is convex. An optical axis region 162 of the image-side surface 16 of the first lens element 1 is concave, and a periphery region 164 of the image-side surface 16 of the first lens element 1 is concave. In the present embodiment, both the object-side surface 15 and the image-side surface 16 of the first lens element 1 are aspheric surfaces, but the disclosure is not limited thereto.

The second lens element 2 is arranged to be a lens element in a second order from the object side A1 to the image side A2. The second lens element 2 has positive refracting power. The second lens element 2 is made from a plastic material. An optical axis region 251 of the object-side surface 25 of the second lens element 2 is convex, and a periphery region 253 of the object-side surface 25 of the second lens element 2 is convex. An optical axis region 262 of the image-side surface 26 of the second lens element 2 is concave, and a periphery region 264 of the image-side surface 26 of the second lens element 2 is concave. In the present embodiment, both the object-side surface 25 and the image-side surface 26 of the second lens element 2 are aspheric surfaces, but the disclosure is not limited thereto.

The third lens element 3 is arranged to be a lens element in a third order from the object side A1 to the image side A2. The third lens element 3 has positive refracting power. The third lens element 3 is made from a plastic material. An optical axis region 352 of the object-side surface 35 of the third lens element 3 is concave, and a periphery region 354 of the object-side surface 35 of the third lens element 3 is concave. An optical axis region 361 of the image-side surface 36 of the third lens element 3 is convex, and a periphery region 363 of the image-side surface 36 of the third lens element 3 is convex. In the present embodiment, both the object-side surface 35 and the image-side surface 36 of the third lens element 3 are aspheric surfaces, but the disclosure is not limited thereto.

The fourth lens element 4 is arranged to be a lens element in a fourth order from the object side A1 to the image side A2. The fourth lens element 4 has negative refracting power. An optical axis region 451 of the object-side surface 45 of the fourth lens element 4 is convex, and a periphery region 454 of the object-side surface 45 of the fourth lens element 4 is concave. An optical axis region 462 of the image-side surface 46 of the fourth lens element 4 is concave, and a periphery region 464 of the image-side surface 46 of the fourth lens element 4 is concave. In the present embodiment, both the object-side surface 45 and the image-side surface 46 of the fourth lens element 4 are aspheric surfaces, but the disclosure is not limited thereto.

The fifth lens element 5 is arranged to be a lens element in a fifth order from the object side A1 to the image side A2. The fifth lens element 5 has positive refracting power. An optical axis region 552 of the object-side surface 55 of the fifth lens element 5 is concave, and a periphery region 554 of the object-side surface 55 of the fifth lens element 5 is concave. An optical axis region 561 of the image-side surface 56 of the fifth lens element 5 is convex, and a periphery region 563 of the image-side surface 56 of the fifth lens element 5 is convex. In the present embodiment, both the object-side surface 55 and the image-side surface 56 of the fifth lens element 5 are aspheric surfaces, but the disclosure is not limited thereto.

The sixth lens element 6 is arranged to be a lens element in a last order from the object side to the image side. The sixth lens element 6 has negative refracting power. The sixth lens element 6 is made from a plastic material. The sixth lens element 6 is a free-form lens element, and the object-side surface 65 and the image-side surface 66 of the sixth lens element 6 are both free form surfaces. At least one of the twelve surfaces of the six lens elements of the present embodiment is free form surface. Referring to FIG. 7A, the projections of the intersection curves of the object-side surface 65 and the image-side surface 66 crossed by the first reference plane on the third reference plane are shown in dotted lines. The projections of the intersection curves of the object-side surface 65 and the image-side surface 66 crossed by the second reference plane on the third reference plane are shown in solid lines. Due to the limitation of optical software, the three-dimensional cross-sectional view only shows the surface shape crossed by the first reference plane and the second reference plane. Besides, the periphery region of the free form surface of the lens element cannot be completely presented when the projections of the intersection curves crossed by the first reference plane and the second reference plane on the third reference plane are presented at the same time. Please refer to FIG. 7B, the different intersection curves of the object-side surface 65 and the image-side surface 66 of the sixth lens element 6 crossed by the first reference plane, the second reference plane and the third reference plane, respectively, and these curves are rotated to the third reference plane with respect to the optical axis I. In the third reference plane, the curves corresponding to the first reference plane are shown in a dotted line, the curves corresponding to the second reference plane are shown in a solid line, and the curves corresponding to the third reference plane are shown in a dot-and-dash line. The description herein may also be applied to the following embodiments and will not be repeated again.

Referring to FIG. 7B, in the intersection curves of the object-side surface 65 and the image-side surface 66 of the sixth lens element 6 crossed by the first reference plane, an optical axis region 651x of the object-side surface 65 of the sixth lens element 6 is convex, and a periphery region 654x of the object-side surface 65 of the sixth lens element 6 is concave. An optical axis region 662x of the image-side surface 66 of the sixth lens element 6 is concave, and a periphery region 663x of the image-side surface 66 of the sixth lens element 6 is convex.

In the intersection curves of the object-side surface 65 and the image-side surface 66 of the sixth lens element 6 crossed by the second reference plane, an optical axis region 651y of the object-side surface 65 of the sixth lens element 6 is convex, and a periphery region 654y of the object-side surface 65 of the sixth lens element 6 is concave. An optical axis region 662y of the image-side surface 66 of the sixth lens element 6 is concave, and a periphery region 664y of the image-side surface 66 of the sixth lens element 6 is concave.

In the intersection curves of the object-side surface 65 and the image-side surface 66 of the sixth lens element 6 crossed by the third reference plane, an optical axis region 651d of the object-side surface 65 of the sixth lens element 6 is convex, and a periphery region 654d of the object-side surface 65 of the sixth lens element 6 is concave. An optical axis region 662d of the image-side surface 66 of the sixth lens element 6 is concave, and a periphery region 664d of the image-side surface 66 of the sixth lens element 6 is convex. It can be seen from the FIGS. 7A and 7B, the curves on the different reference planes do not coincide with each other. FIG. 7C specifically shows the overall appearance of the sixth lens element 6.

In the present embodiment, only the above six lens elements of the optical imaging lens 10 have refracting power.

Other detailed optical data of the first embodiment is shown in FIG. 9. The optical imaging lens 10 in the first embodiment has an effective focal length (EFL) of 3.423 millimeters (mm), an HFOV of 56.881°, a F-number (Fno) of 2.256, a total track length (TTL) of 7.109 mm, and an image height of 5.233 mm. The TTL is a distance from the object-side surface 15 of the first lens element 1 to the image plane 99 along the optical axis I.

In addition, in the present embodiment, all the object-side surfaces 15, 25, 35, 45, and 55 and the image-side surfaces 16, 26, 36, 46, and 56 of the first lens element 1, the second lens element 2, the third lens element 3, the fourth lens element 4, and the fifth lens element 5 are aspheric surfaces, and are general even aspheric surfaces. The aspheric surfaces are defined by the following formula:

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{2 i} \times {Y}^{2 i} \qquad ( 1 )$$

where:

R is a curvature radius at a position, near the optical axis I, of a surface of a lens element;

Z is a depth of an aspheric surface (a perpendicular distance between a point on the aspheric surface and having a distance Y to the optical axis I and a plane, tangent to the aspheric surface, of a vertex on the optical axis I);

Y is distance between a point on an aspheric surface curve and the optical axis I;

K is a conic constant; and

A_{2I} is a (2i)^{th}-order aspheric surface coefficient.

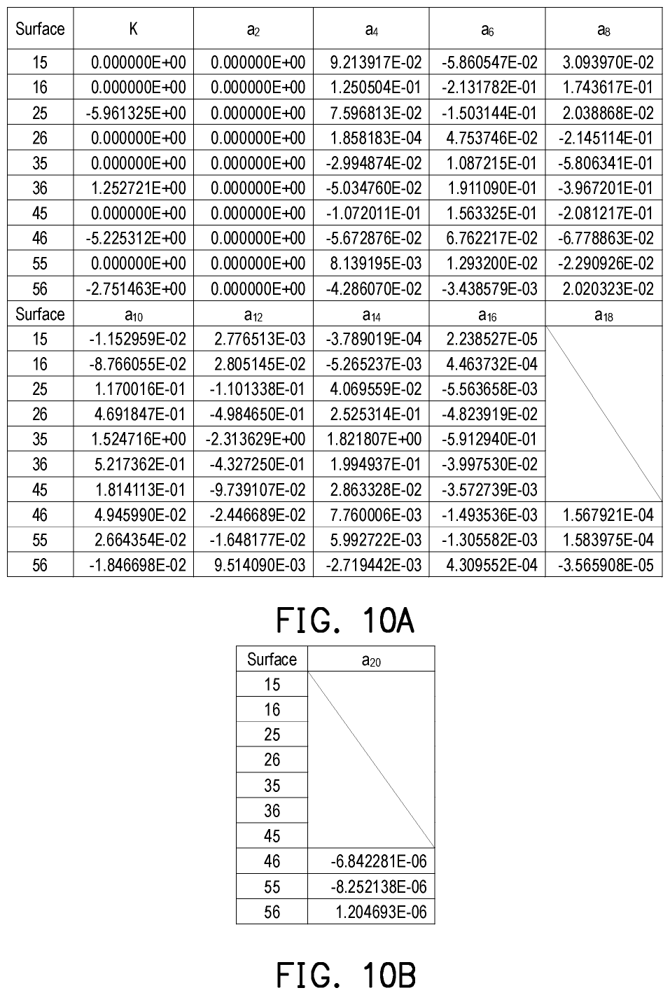

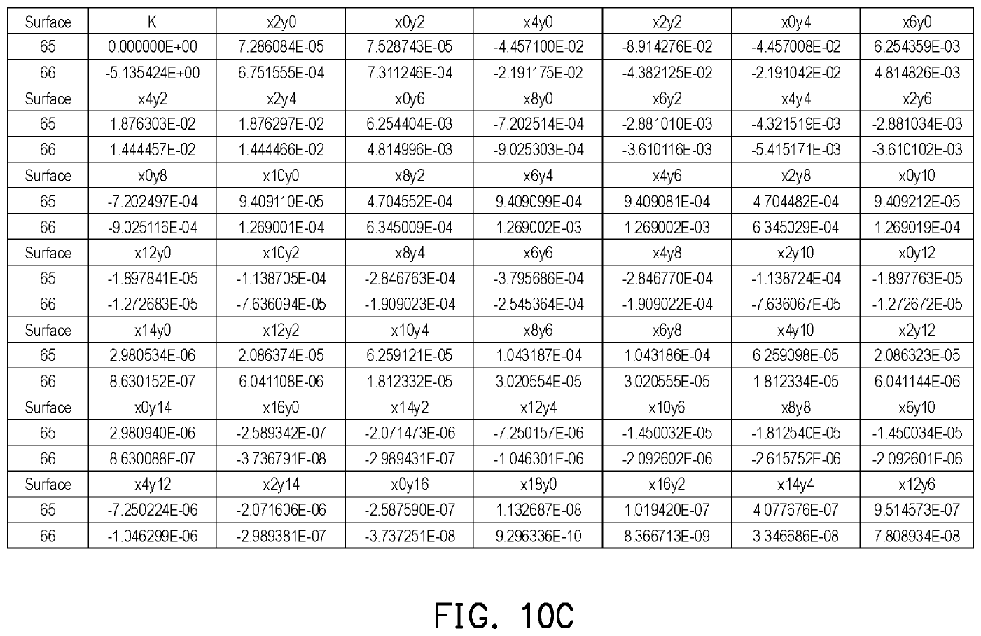

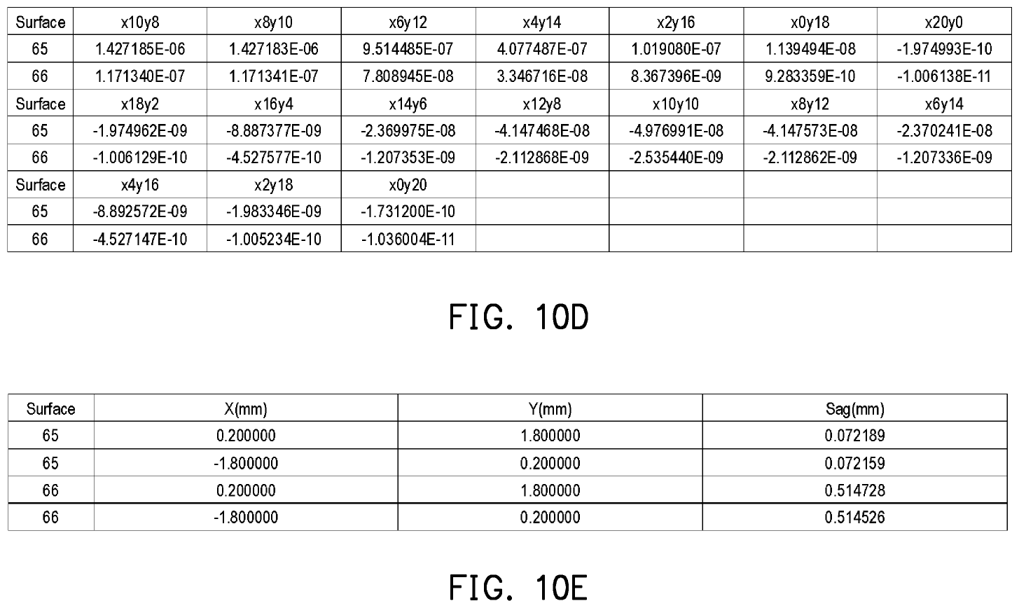

Aspheric surface coefficients of the object-side surface 15 of the first lens element 1 to the image-side surface 56 of the fifth lens element 5 in Formula (1) are shown in FIG. 10A and FIG. 10B. In FIG. 10A and FIG. 10B, a field number 15 corresponds to aspheric surface coefficients of the object-side surface 15 of the first lens element 1, and other fields may be deduced by analogy.

In addition, in the present embodiment, the two surfaces of the object-side surface 65 and the image-side surface 66 of the sixth lens element 6 are both free form surface. The free form surfaces are defined by the following formula (2)˜(4):

$$Z = \frac{C ( {X}^{2} + {Y}^{2} )}{1 + \sqrt{1 - ( 1 + K ) {C}^{2} ( {X}^{2} + {Y}^{2} )}} + {\sum }_{j = 2}^{66} {C}_{j} {X}^{m} {Y}^{n} \qquad ( 2 )$$

$$j = \frac{\{ {( m + n )}^{2} + m + 3 n \}}{2} + 1 \qquad ( 3 )$$

$$C = \frac{1}{R} \qquad ( 4 )$$

where:

R is a curvature radius at a position, near the optical axis I, of a surface of a lens element;

Z is a depth of a free form surface (a perpendicular distance between a point on the free form surface and a tangent plane at a vertex of the free form surface on the optical axis I);

X is distance between a point on a free form surface and a Y-axis passing through the optical axis I;

Y is distance between a point on a free form surface and an X-axis passing through the optical axis I;

K is a conic constant;

Cⱼ are coefficients of each term of the X^{m}Yⁿ;

in addition, m and n are positive integers or zero.

Coefficients of each term of the X^{m}Yⁿ of the object-side surface 65 and the image-side surface 66 of the sixth lens element 6 in Formula (2) are shown in FIG. 10C and FIG. 10D. In FIG. 10C and FIG. 10D, a field number 65 corresponds to coefficients Cⱼ of each term of the X^{m}Yⁿ of the object-side surface 65 of the sixth lens element 6, and other fields may be deduced by analogy. In addition, in the present embodiment, coefficients Cⱼ of the X^{m}Yⁿ terms missing in FIG. 10C and FIG. 10D are zero. FIG. 10E shows the corresponding Sag values of the sixth lens element of the first embodiment of the disclosure at the two selected coordinate values on the XY plane. Where the first coordinate value is, for example, X=0.200, Y=1.800 (a,b), and the second coordinate value is, for example, X=−1.800, Y=0.200 (−b,a). The corresponding Sag values of the object-side surface 65 at the first and second coordinate values are 0.072189 and 0.072159, which are different from each other, and other fields may be deduced by analogy.

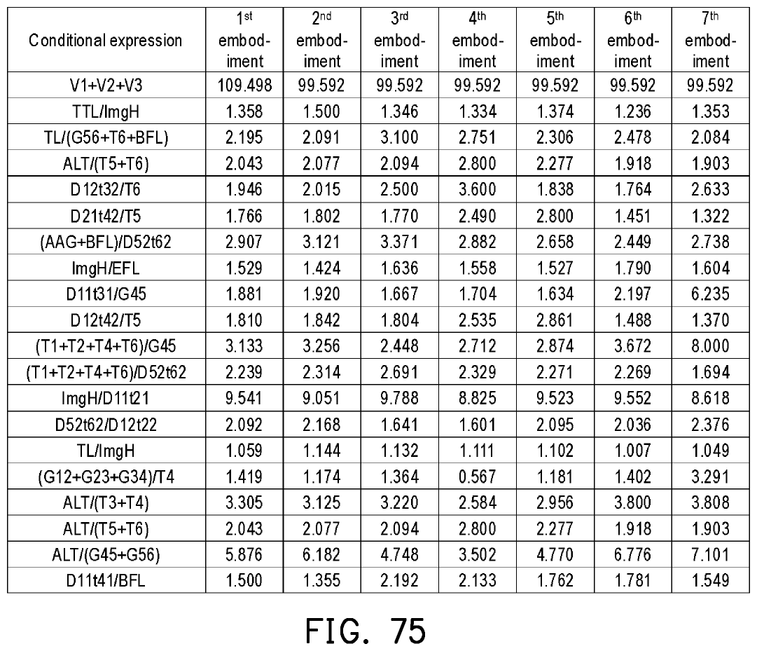

In addition, the relationships between important parameters of the optical imaging lens 10 in the first embodiment is shown in FIG. 75.

Where,

EFL is an effective focal length of the optical imaging lens 10;

HFOV is a half field of view of the optical imaging lens 10;

Fno is a F-number of the optical imaging lens 10;

ImgH is an image height of the optical imaging lens 10;

T1 is a thickness of the first lens element 1 along the optical axis I;

T2 is a thickness of the second lens element 2 along the optical axis I;

T3 is a thickness of the third lens element 3 along the optical axis I;

T4 is a thickness of the fourth lens element 4 along the optical axis I;

T5 is a thickness of the fifth lens element 5 along the optical axis I;

T6 is a thickness of the sixth lens element 6 along the optical axis I;

G12 is a distance from the image-side surface 16 of the first lens element 1 to the object-side surface 25 of the second lens element 2 along the optical axis I;

G23 is a distance from the image-side surface 26 of the second lens element 2 to the object-side surface 35 of the third lens element 3 along the optical axis I;

G34 is a distance from the image-side surface 36 of the third lens element 3 to the object-side surface 45 of the fourth lens element 4 along the optical axis I;

G45 is a distance from the image-side surface 46 of the fourth lens element 4 to the object-side surface 55 of the fifth lens element 5 along the optical axis I;

G56 is a distance from the image-side surface 56 of the fifth lens element 5 to the object-side surface 65 of the sixth lens element 6 along the optical axis I;

G6F is a distance from the image-side surface 66 of the sixth lens element 6 to the object-side surface 95 of the filter 9 along the optical axis I;

TF is a thickness of the filter 9 along the optical axis I;

GFP is a distance from the image-side surface 96 of the filter 9 to the image plane 99 along the optical axis I;

TTL is a distance from the object-side surface 15 of the first lens element 1 to the image plane 99 along the optical axis I;

BFL is a distance from the image-side surface 66 of the sixth lens element 6 to the image plane 99 along the optical axis I;

AAG is a sum of the distance from the image-side surface 16 of the first lens element 1 to the object-side surface 25 of the second lens element 2 along the optical axis I, the distance from the image-side surface 26 of the second lens element 2 to the object-side surface 35 of the third lens element 3 along the optical axis I, the distance from the image-side surface 36 of the third lens element 3 to the object-side surface 45 of the fourth lens element 4 along the optical axis I, the distance from the image-side surface 46 of the fourth lens element 4 to the object-side surface 55 of the fifth lens element 5 along the optical axis I, and the distance from the image-side surface 56 of the fifth lens element 5 to the object-side surface 65 of the sixth lens element 6 along the optical axis I, namely. a sum of the five distances G12, G23, G34, G45 and G56;

ALT is a sum of the lens element thicknesses of the first lens element 1, the second lens element 2, the third lens element 3, the fourth lens element 4, the fifth lens element 5 and the sixth lens element 6 along the optical axis I, namely, a sum of T1, T2, T3, T4, T5, and T6;

TL is a distance from the object-side surface 15 of the first lens element 1 to the image-side surface 66 of the sixth lens element 6 along the optical axis I;

D11t21 is a distance from the object-side surface 15 of the first lens element 1 to the object-side surface 16 of the second lens element 2 along the optical axis I, namely, a sum of T1 and G12;

D12t22 is a distance from the image-side surface 16 of the first lens element 1 to the image-side surface 26 of the second lens element 2 along the optical axis I, namely, a sum of G12 and T2;

D52t62 is a distance from the image-side surface 56 of the fifth lens element 5 to the image-side surface 66 of the sixth lens element 6 along the optical axis I, namely, a sum of G56 and T6;

D12t32 is a distance from the image-side surface 16 of the first lens element 1 to the image-side surface 36 of the third lens element 3 along the optical axis I, namely, a sum of G12, T2, G23 and T6; D21t42 is a distance from the object-side surface 25 of the second lens element 2 to the image-side surface 46 of the fourth lens element 4 along the optical axis I, namely, a sum of T2, G23, T3, G34 and T4;

D11t31 is a distance from the object-side surface 15 of the first lens element 1 to the object-side surface 35 of the third lens element 3 along the optical axis I, namely, a sum of T1, G12, T2 and G23;

D12t42 is a distance from the image-side surface 16 of the first lens element 1 to the image-side surface 46 of the fourth lens element 4 along the optical axis I, namely, a sum of G12, T2, G23, T3, G34 and T4;

D11t41 is a distance from the object-side surface 15 of the first lens element 1 to the object-side surface 45 of the fourth lens element 4 along the optical axis I, namely, a sum of T1, G12, T2, G23, T3 and G34;

In addition, it is defined:

f1 is a focal length of the first lens element 1;

f2 is a focal length of the second lens element 2;

f3 is a focal length of the third lens element 3;

f4 is a focal length of the fourth lens element 4;

f5 is a focal length of the fifth lens element 5;

f6 is a focal length of the sixth lens element 6;

n1 is a refractive index of the first lens element 1;

n2 is a refractive index of the second lens element 2;

n3 is a refractive index of the third lens element 3;

n4 is a refractive index of the fourth lens element 4;

n5 is a refractive index of the fifth lens element 5;

n6 is a refractive index of the sixth lens element 6;

V1 is an Abbe number (also referred to as dispersion coefficient) of the first lens element 1;

V2 is an Abbe number of the second lens element 2;

V3 is an Abbe number of the third lens element 3;

V4 is an Abbe number of the fourth lens element 4;

V5 is an Abbe number of the fifth lens element 5; and

V6 is an Abbe number of the sixth lens element 6.

Further referring to FIG. 8A to FIG. 8D, FIG. 8A illustrates longitudinal spherical aberrations according to the first embodiment, FIG. 8B and FIG. 8C respectively illustrate field curvature aberrations in a sagittal direction and field curvature aberrations in a tangential direction on the image plane 99 in cases of wavelengths 470 nm, 555 nm, and 650 nm according to the first embodiment, and FIG. 8D illustrates distortion aberrations on the image plane 99 in cases of wavelengths 470 nm, 555 nm, and 650 nm according to the first embodiment. The longitudinal spherical aberrations of the first embodiment are shown in FIG. 8A, and curves of all the wavelengths are quite close to each other and approach the middle. It indicates that off-axis rays of all the wavelengths at different heights are focused near an imaging point. From deflection amplitude of the curves of all the wavelengths, it can be seen that imaging point deviations of the off-axis rays at different heights are controlled within a range of ±0.016 mm. Therefore, a spherical aberration of a same wavelength is definitely reduced in the first embodiment. In addition, the three representative wavelengths are also quite close to each other. It indicates that imaging positions of rays of different wavelengths are quite focused. Therefore, chromatic and astigmatic aberrations are also definitely reduced.

In the two field curvature aberration diagrams of FIG. 8B and FIG. 8C, focal length variations of the three representative wavelengths in an entire field of view fall within a range of ±0.06 mm. It indicates that astigmatic aberrations can be effectively eliminated by the optical system in the first embodiment. The distortion aberration diagram of FIG. 8D shows that the distortion aberrations of the first embodiment are retained within a range of ±0.9%. It indicates that the distortion aberrations of the first embodiment satisfy an imaging quality requirement of the optical system. To be specific, different from an existing optical lens, the first embodiment can still provide desired imaging quality when the TTL is reduced to approximately 7.109 mm. Therefore, the first embodiment can have a shorter length and achieve desired imaging quality while maintaining desired optical properties.

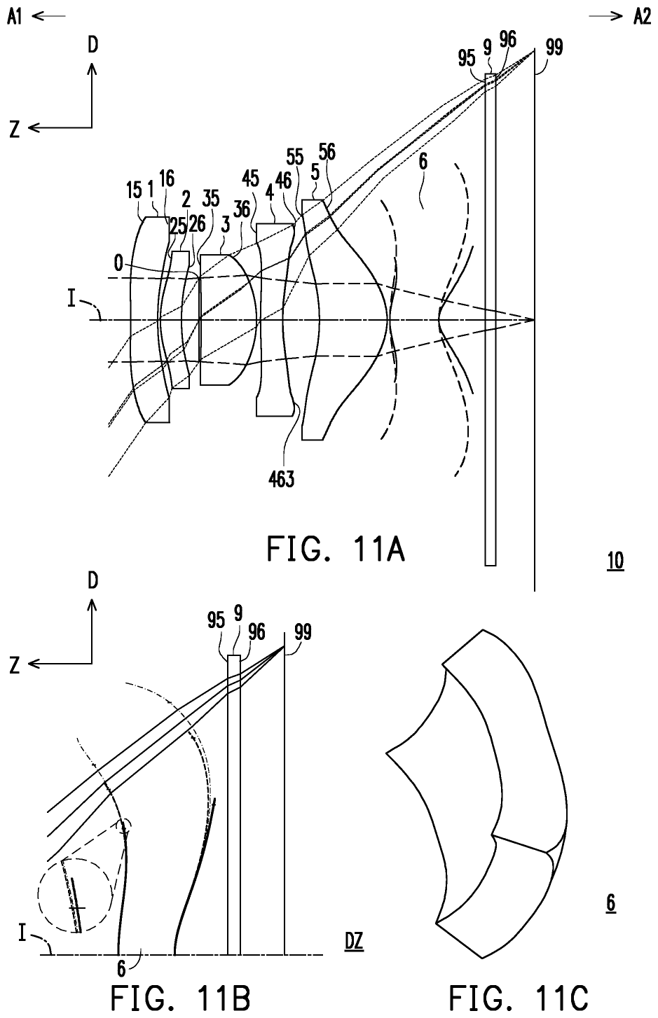

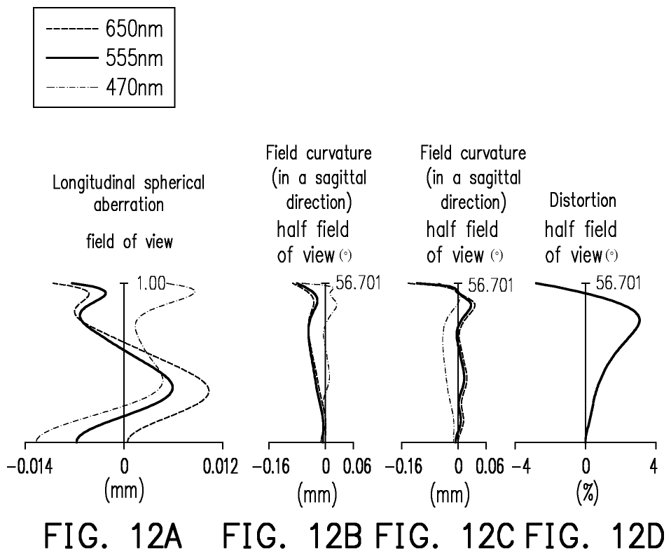

FIG. 11A is a schematic diagram of an optical imaging lens according to a second embodiment of the disclosure. FIG. 11B is an enlarged radial cross-sectional view of the sixth lens element of FIG. 11A crossed by different planes. FIG. 11C is a schematic diagram of the appearance of the sixth lens element of FIG. 11A. FIG. 12A to FIG. 12D are diagrams of longitudinal spherical aberrations and astigmatic aberrations of the optical imaging lens according to the second embodiment. Referring to FIG. 11A first, the second embodiment of the optical imaging lens 10 of the disclosure is basically similar to the first embodiment, which differs as follows: optical data, aspheric surface coefficients, and parameters between the lens elements 1, 2, 3, 4, 5, and 6 are different to some extent. In addition, in the present embodiment, a periphery region 463 of the image-side surface 46 of the fourth lens element 4 is convex. Herein, it should be noted that, for clearly presenting the diagram, same reference numbers of optical axis regions and periphery regions in the two embodiments are omitted in FIG. 11A and FIG. 11B.

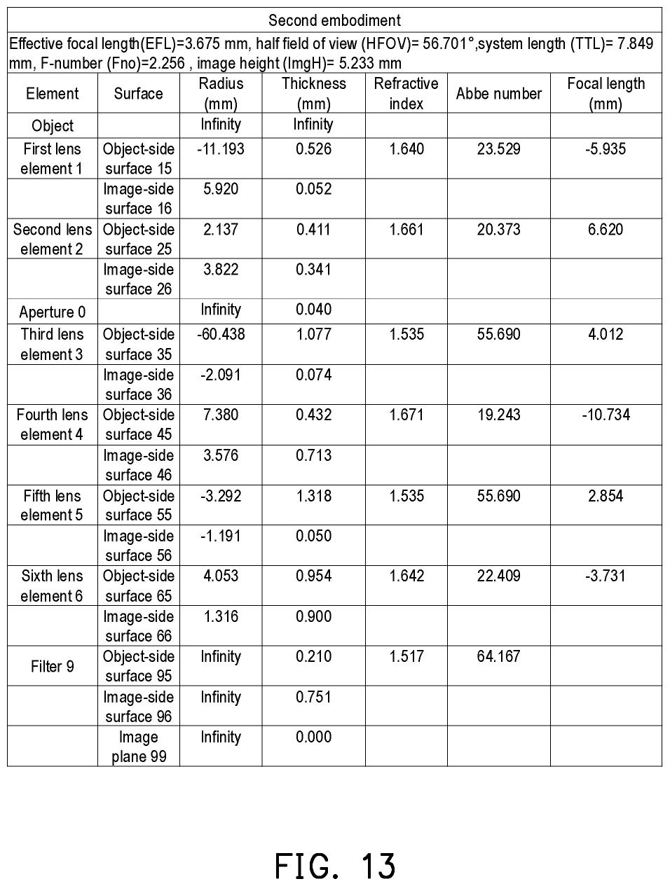

Detailed optical data of the optical imaging lens 10 in the second embodiment is shown in FIG. 13, and the optical imaging lens 10 in the second embodiment has an EFL of 3.675 mm, an HFOV of 56.701°, a Fno of 2.256, a TTL of 7.849 mm, and an image height of 5.233 mm.

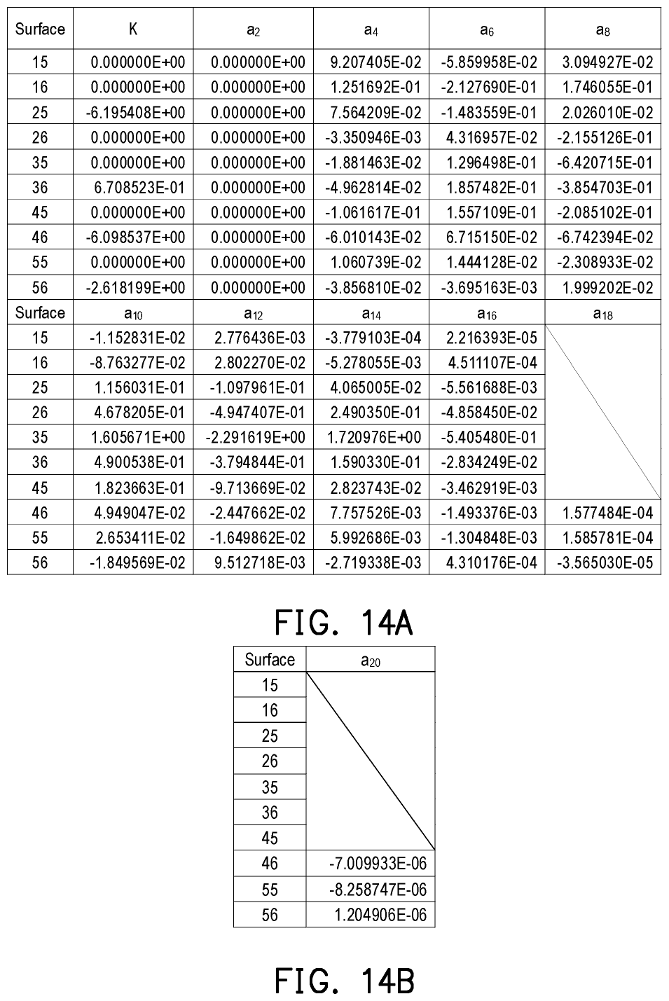

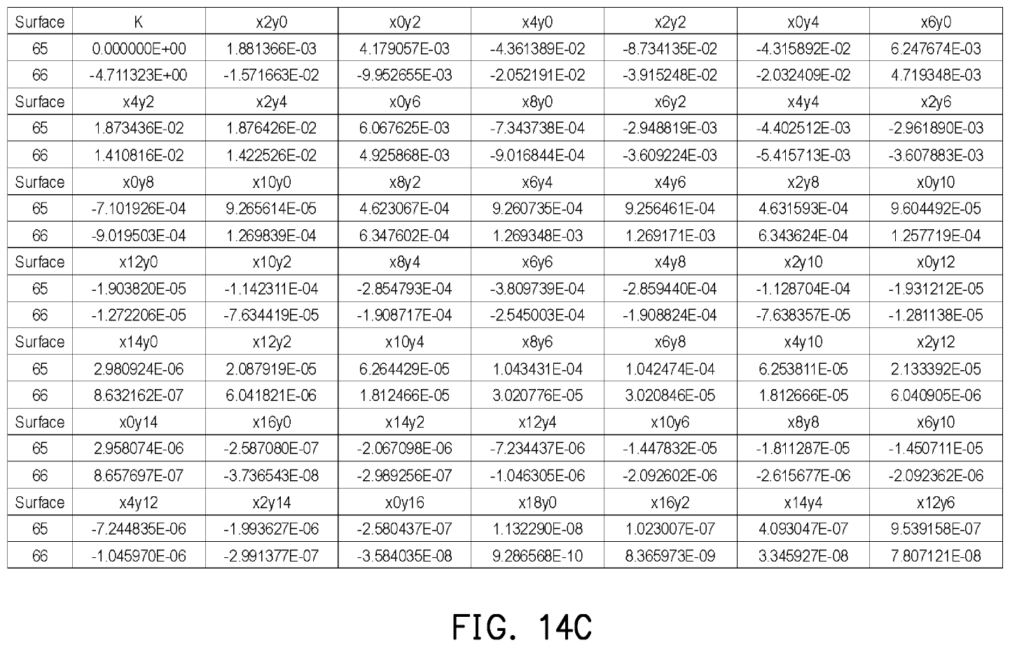

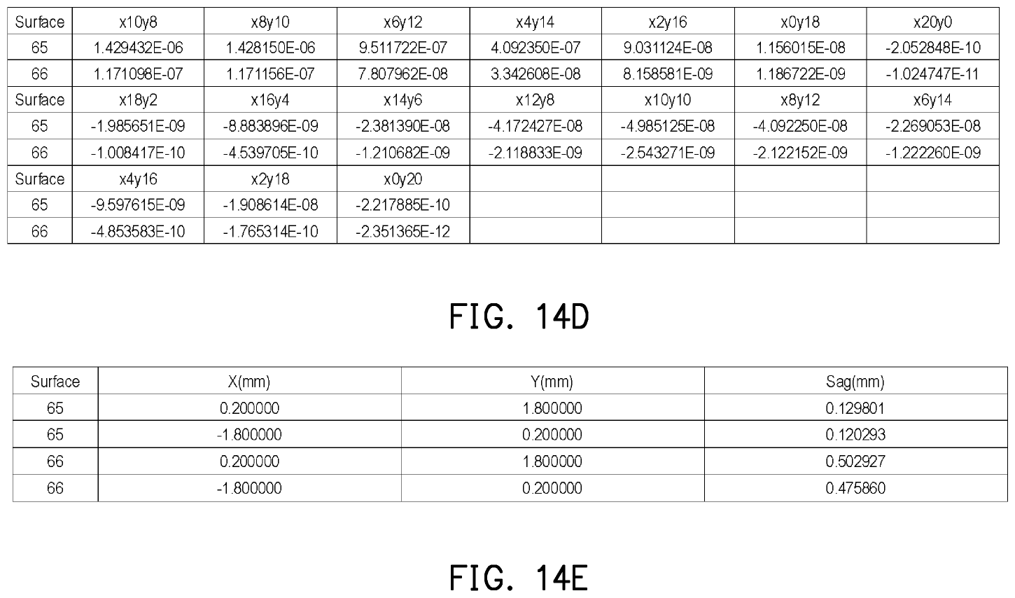

Aspheric surface coefficients of the object-side surface 15 of the first lens element 1 to the image-side surface 56 of the fifth lens element 5 in the second embodiment in Formula (1) are shown in FIG. 14A and FIG. 14B. Coefficients of each term of the X^{m}Yⁿ of the object-side surface 65 and the image-side surface 66 of the sixth lens element 6 in the second embodiment in Formula (2) are shown in FIG. 10C and FIG. 10D. FIG. 14E shows the corresponding Sag values of the sixth lens element of the second embodiment of the disclosure at the two selected coordinate values on the XY plane.

In addition, the relationships between important parameters of the optical imaging lens 10 in the second embodiment is shown in FIG. 75.

Longitudinal spherical aberrations of the second embodiment are shown in FIG. 12A, and imaging point deviations of off-axis rays at different heights are controlled within a range of ±0.014 mm. In two field curvature aberration diagrams of FIG. 12B and FIG. 12C, focal length variations of three representative wavelengths in an entire field of view fall within a range of ±0.16 mm. A distortion aberration diagram of FIG. 12D shows that distortion aberrations of the second embodiment are retained within a range of ±3.5%.

Based on the above, it can be seen that the longitudinal spherical aberration in the second embodiment is smaller than the longitudinal spherical aberration in the first embodiment.

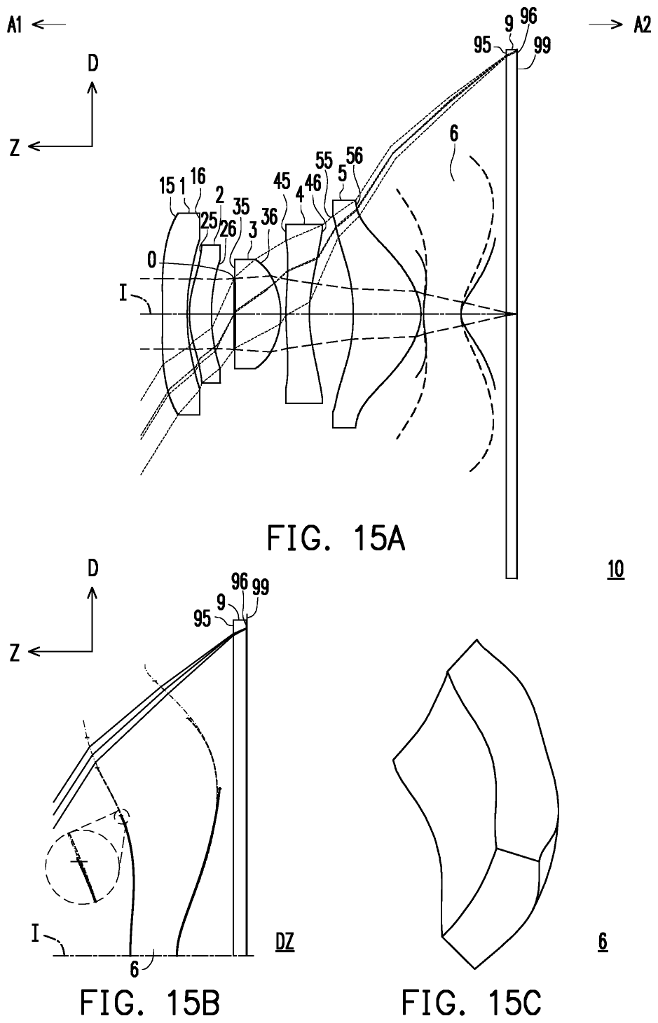

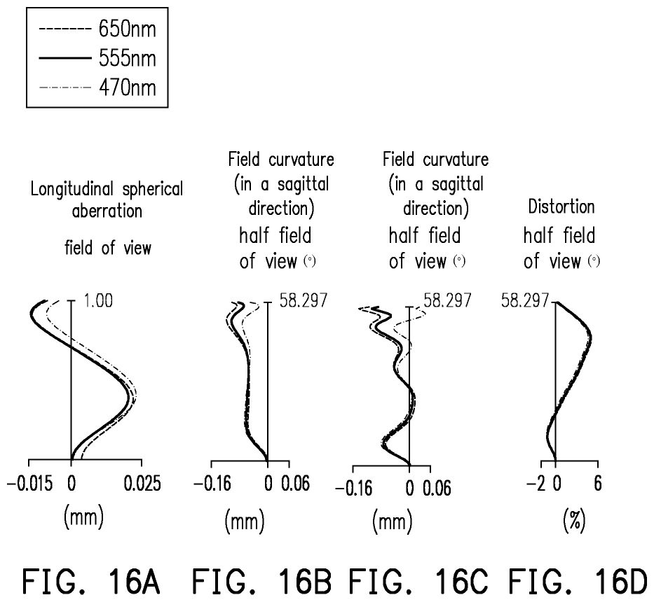

FIG. 15A is a schematic diagram of an optical imaging lens according to a third embodiment of the disclosure. FIG. 15B is an enlarged radial cross-sectional view of the sixth lens element of FIG. 15A crossed by different planes. FIG. 15C is a schematic diagram of the appearance of the sixth lens element of FIG. 15A. FIG. 16A to FIG. 16D are diagrams of longitudinal spherical aberrations and astigmatic aberrations of the optical imaging lens according to the third embodiment. Referring to FIG. 15A first, the third embodiment of the optical imaging lens 10 of the disclosure is basically similar to the first embodiment, which differs as follows: optical data, aspheric surface coefficients, and parameters between the lens elements 1, 2, 3, 4, 5, and 6 are different to some extent. Herein, it should be noted that, for clearly presenting the diagram, reference numbers of optical axis regions and periphery regions with surface structures similar to that of in the first embodiment are omitted in FIG. 15A and FIG. 15B.

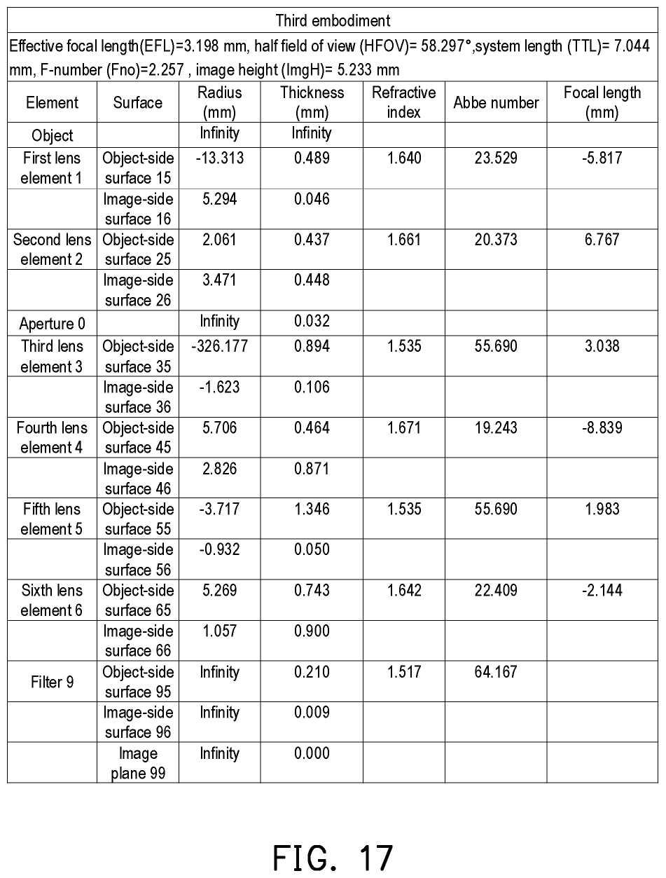

Detailed optical data of the optical imaging lens 10 in the third embodiment is shown in FIG. 17, and the optical imaging lens 10 in the third embodiment has an EFL of 3.198 mm, an HFOV of 58.297°, a Fno of 2.257, a TTL of 7.044 mm, and an image height of 5.233 mm.

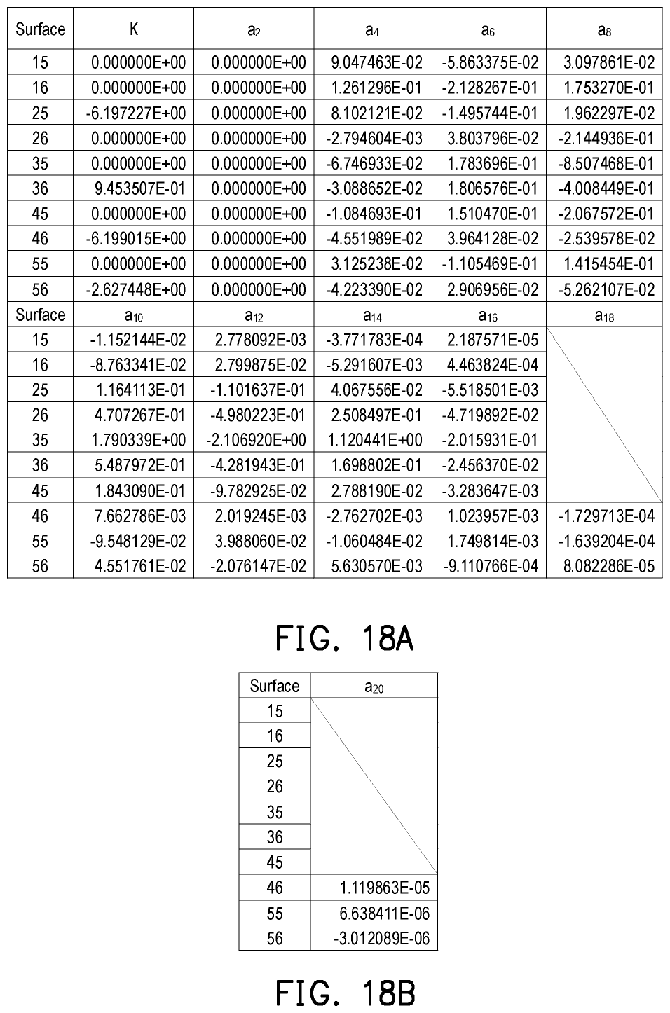

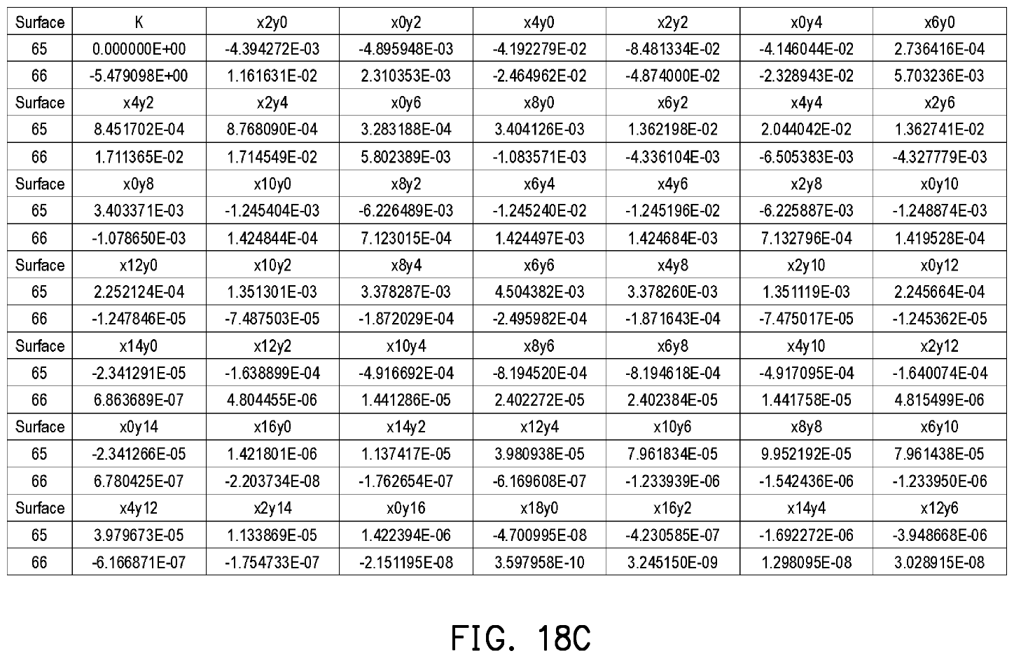

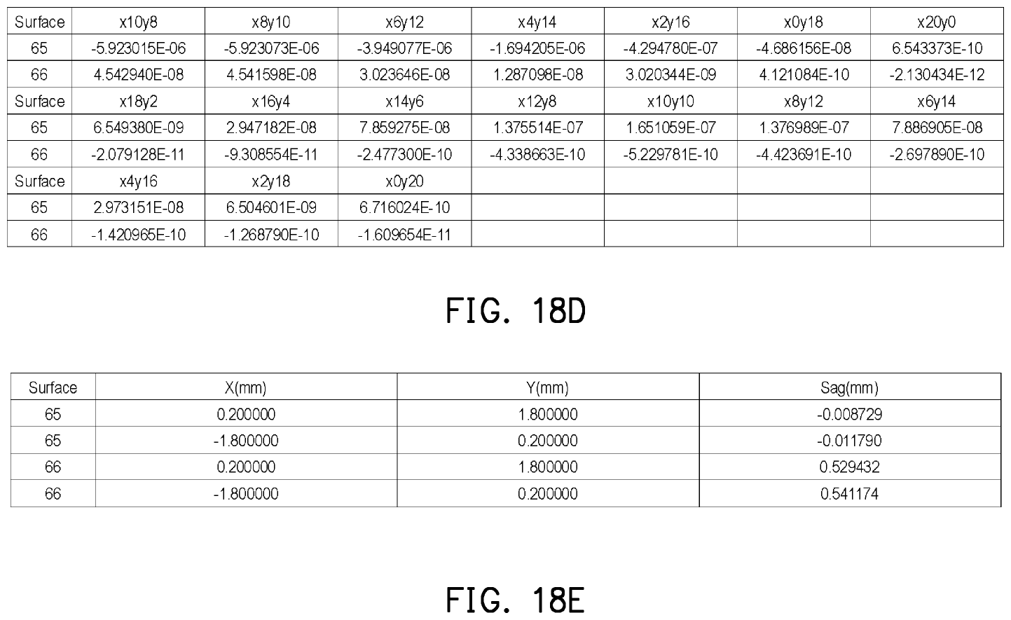

Aspheric surface coefficients of the object-side surface 15 of the first lens element 1 to the image-side surface 56 of the fifth lens element 5 in the third embodiment in Formula (1) are shown in FIG. 18A and FIG. 18B. Coefficients of each term of the X^{m}Yⁿ of the object-side surface 65 and the image-side surface 66 of the sixth lens element 6 in the third embodiment in Formula (2) are shown in FIG. 18C and FIG. 18D. FIG. 18E shows the corresponding Sag values of the sixth lens element of the third embodiment of the disclosure at the two selected coordinate values on the XY plane.

In addition, the relationships between important parameters of the optical imaging lens 10 in the third embodiment is shown in FIG. 75.

Longitudinal spherical aberrations of the third embodiment are shown in FIG. 16A, and imaging point deviations of off-axis rays at different heights are controlled within a range of ±0.025 mm. In two field curvature aberration diagrams of FIG. 16B and FIG. 16C, focal length variations of three representative wavelengths in an entire field of view fall within a range of ±0.016 mm. A distortion aberration diagram of FIG. 16D shows that distortion aberrations of the third embodiment are retained within a range of ±6%.

Based on the above, it can be seen that the TTL in the third embodiment is smaller than the TTL in the first embodiment, and the HFOV in the third embodiment is smaller than the HFOV in the first embodiment.

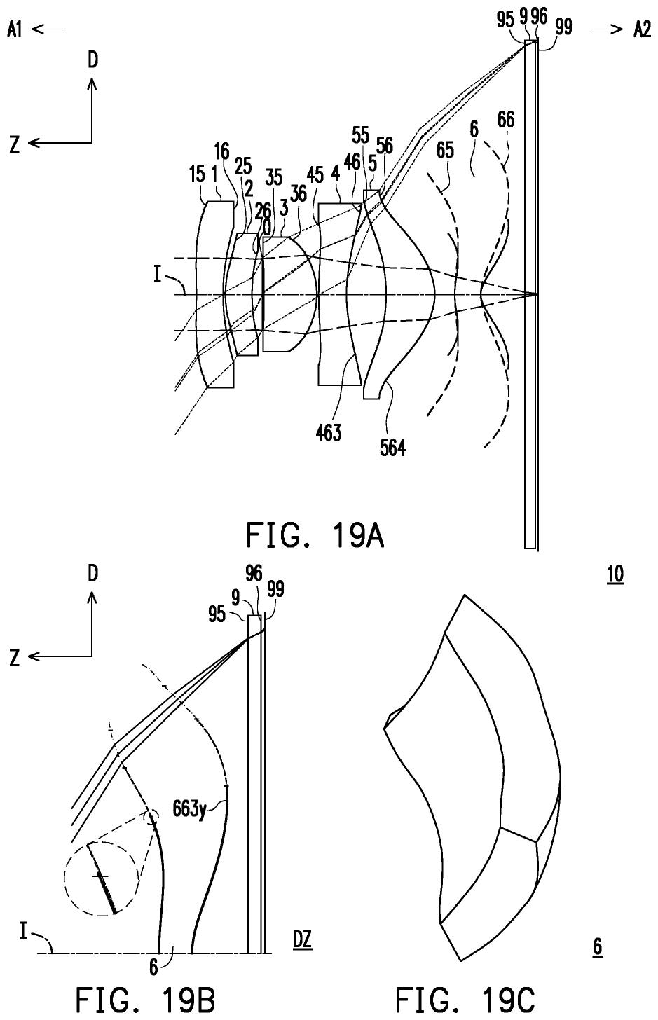

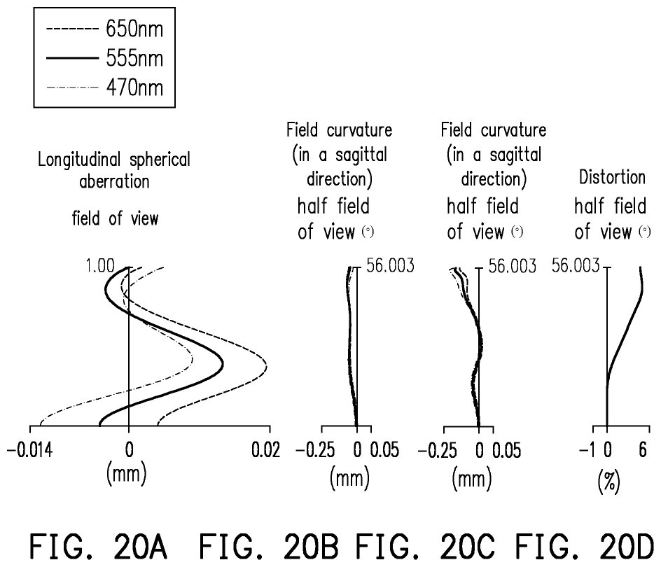

FIG. 19A is a schematic diagram of an optical imaging lens according to a fourth embodiment of the disclosure. FIG. 19B is an enlarged radial cross-sectional view of the sixth lens element of FIG. 19A crossed by different planes. FIG. 19C is a schematic diagram of the appearance of the sixth lens element of FIG. 19A. FIG. 20A to FIG. 20D are diagrams of longitudinal spherical aberrations and astigmatic aberrations of the optical imaging lens according to the fourth embodiment. Referring to FIG. 19A first, the fourth embodiment of the optical imaging lens 10 of the disclosure is basically similar to the first embodiment, which differs as follows: optical data, aspheric surface coefficients, and parameters between the lens elements 1, 2, 3, 4, 5, and 6 are different to some extent. In addition, in the intersection curves of the image-side surface 66 crossed by the second reference plane, an optical axis region 663y of the image-side surface 66 of the sixth lens element 6 is convex. Herein, it should be noted that, for clearly presenting the diagram, reference numbers of optical axis regions and periphery regions with surface structures similar to that of in the first embodiment are omitted in FIG. 19A and FIG. 19B.

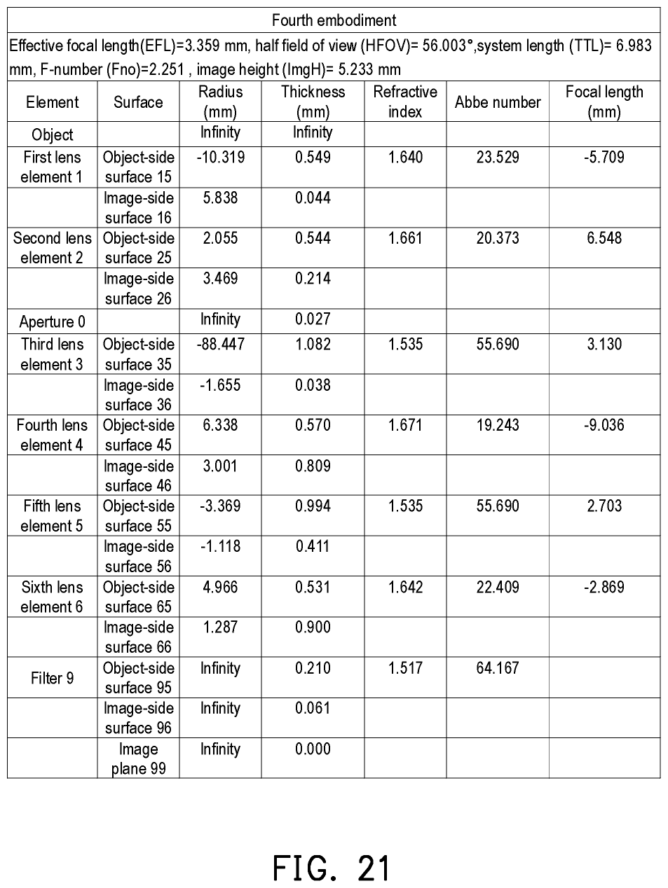

Detailed optical data of the optical imaging lens 10 in the fourth embodiment is shown in FIG. 21, and the optical imaging lens 10 in the fourth embodiment has an EFL of 3.359 mm, an HFOV of 56.003°, a Fno of 2.251, a TTL of 6.983 mm, and an image height of 5.233 mm.

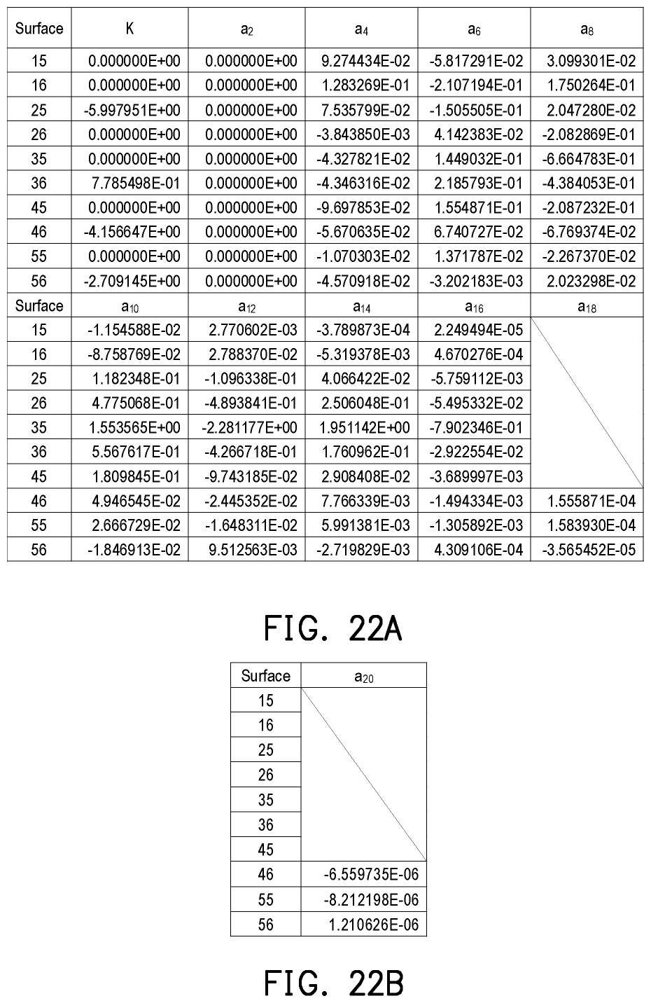

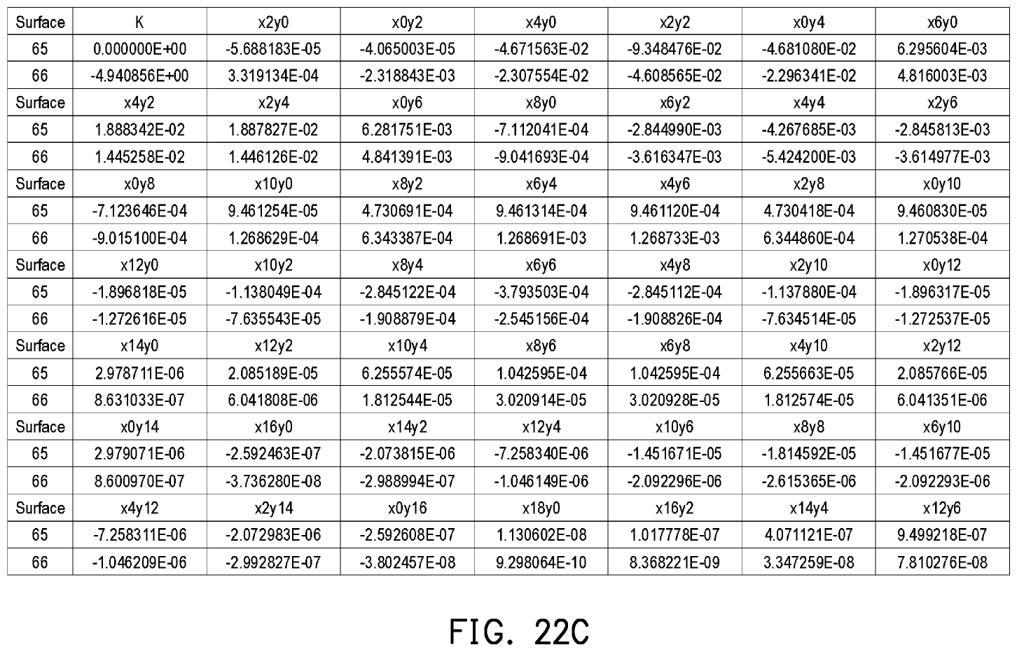

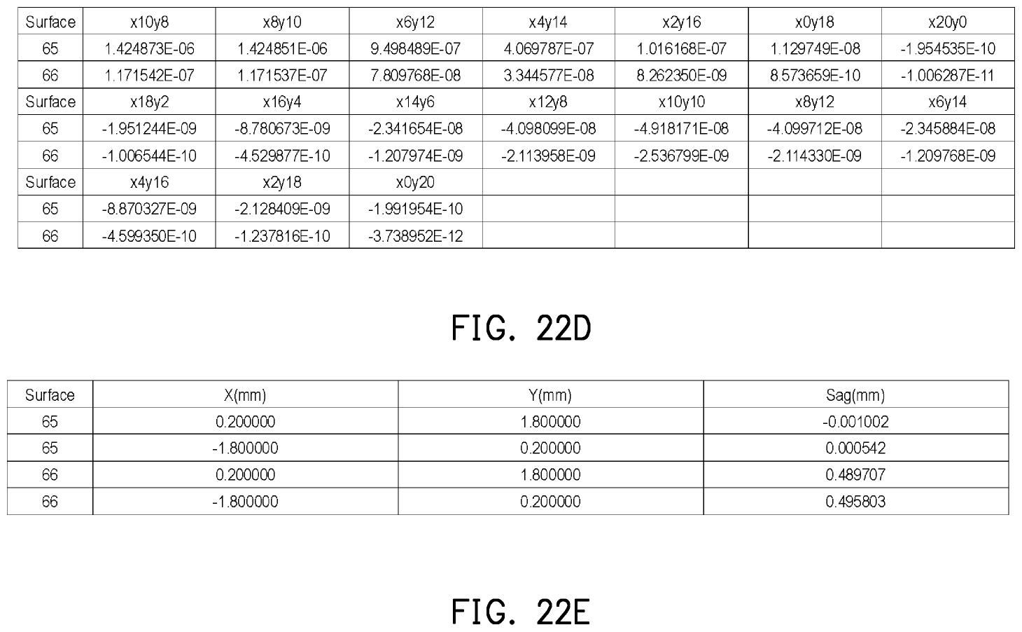

Aspheric surface coefficients of the object-side surface 15 of the first lens element 1 to the image-side surface 56 of the fifth lens element 5 in the fourth embodiment in Formula (1) are shown in FIG. 22A and FIG. 22B. Coefficients of each term of the X^{m}Yⁿ of the object-side surface 65 and the image-side surface 66 of the sixth lens element 6 in the fourth embodiment in Formula (2) are shown in FIG. 22C and FIG. 22D. FIG. 22E shows the corresponding Sag values of the sixth lens element of the fourth embodiment of the disclosure at the two selected coordinate values on the XY plane.

In addition, the relationships between important parameters of the optical imaging lens 10 in the fourth embodiment is shown in FIG. 75.

Longitudinal spherical aberrations of the fourth embodiment are shown in FIG. 20A, and imaging point deviations of off-axis rays at different heights are controlled within a range of ±0.02 mm. In two field curvature aberration diagrams of FIG. 20B and FIG. 20C, focal length variations of three representative wavelengths in an entire field of view fall within a range of ±0.25 mm. A distortion aberration diagram of FIG. 20D shows that distortion aberrations of the fourth embodiment are retained within a range of ±6%.

Based on the above, it can be seen that the TTL in the fourth embodiment is smaller than the TTL in the first embodiment, and the Fno in the fourth embodiment is smaller than the Fno in the first embodiment.

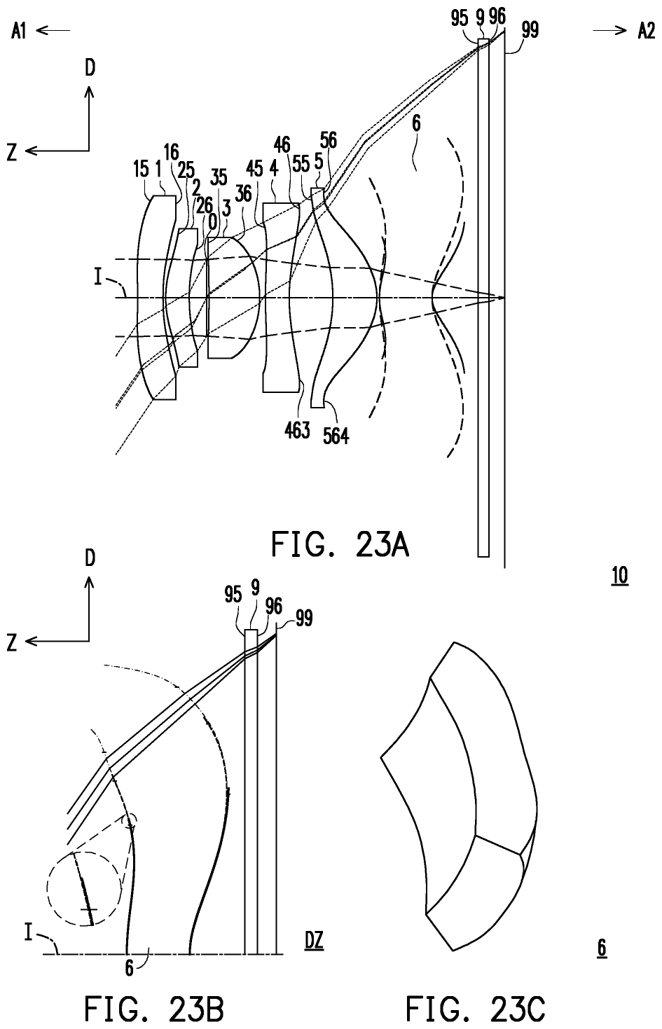

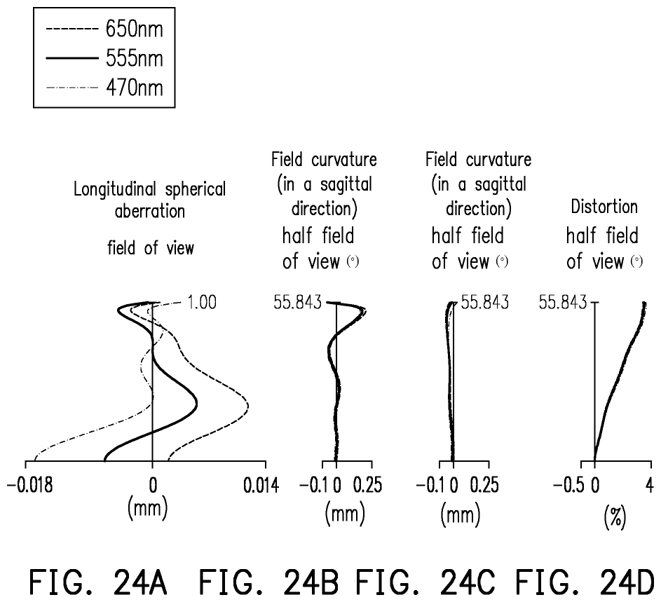

FIG. 23A is a schematic diagram of an optical imaging lens according to a fifth embodiment of the disclosure. FIG. 23B is an enlarged radial cross-sectional view of the sixth lens element of FIG. 23A crossed by different planes. FIG. 23C is a schematic diagram of the appearance of the sixth lens element of FIG. 23A. FIG. 24A to FIG. 24D are diagrams of longitudinal spherical aberrations and astigmatic aberrations of the optical imaging lens according to the fifth embodiment. Referring to FIG. 23A to FIG. 23C, the fifth embodiment of the optical imaging lens 10 of the disclosure is basically similar to the first embodiment, which differs as follows: optical data, aspheric surface coefficients, and parameters between the lens elements 1, 2, 3, 4, 5, and 6 are different to some extent. In addition, in the present embodiment, a periphery region 463 of the image-side surface 46 of the fourth lens element 4 is convex, and a periphery region 564 of the image-side surface 56 of the fifth lens element 5 is concave. Herein, it should be noted that, for clearly presenting the diagram, reference numbers of optical axis regions and periphery regions with surface structures similar to that of in the first embodiment are omitted in FIG. 23A and FIG. 23B.

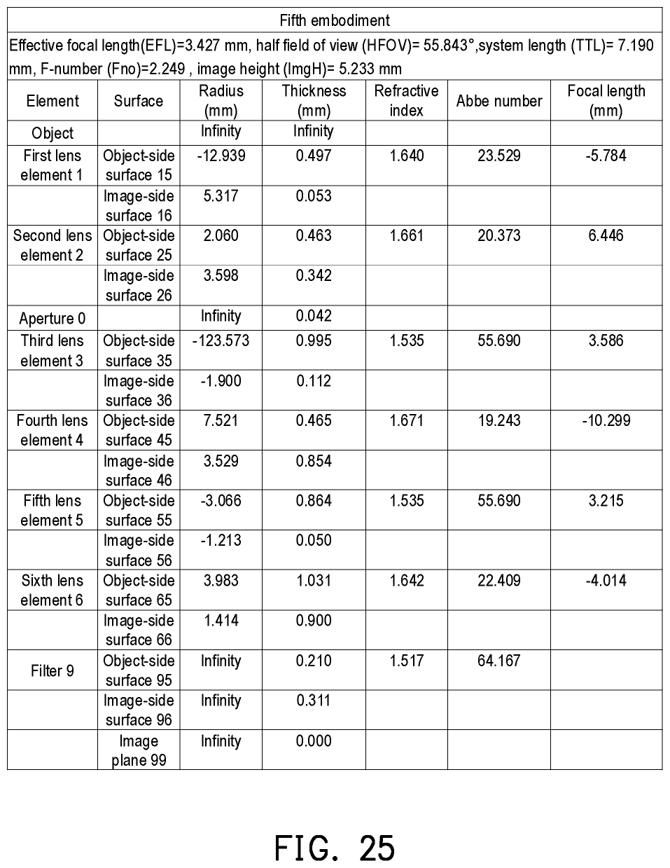

Detailed optical data of the optical imaging lens 10 in the fifth embodiment is shown in FIG. 25, and the optical imaging lens 10 in the fifth embodiment has an EFL of 3.427 mm, an HFOV of 55.843°, a Fno of 2.249, a TTL of 7.190 mm, and an image height of 5.233 mm.

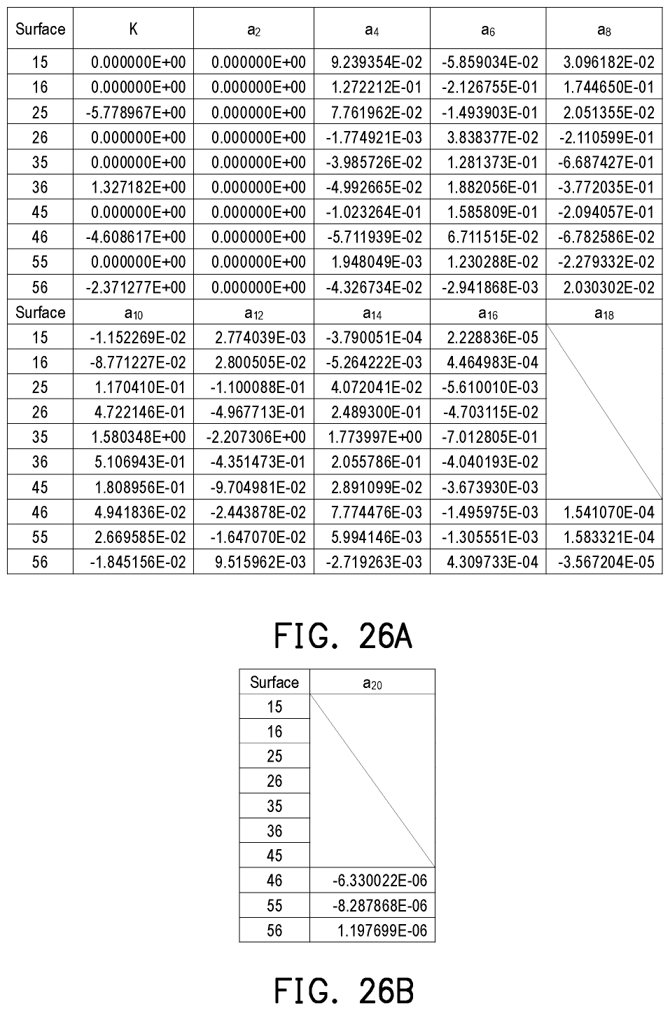

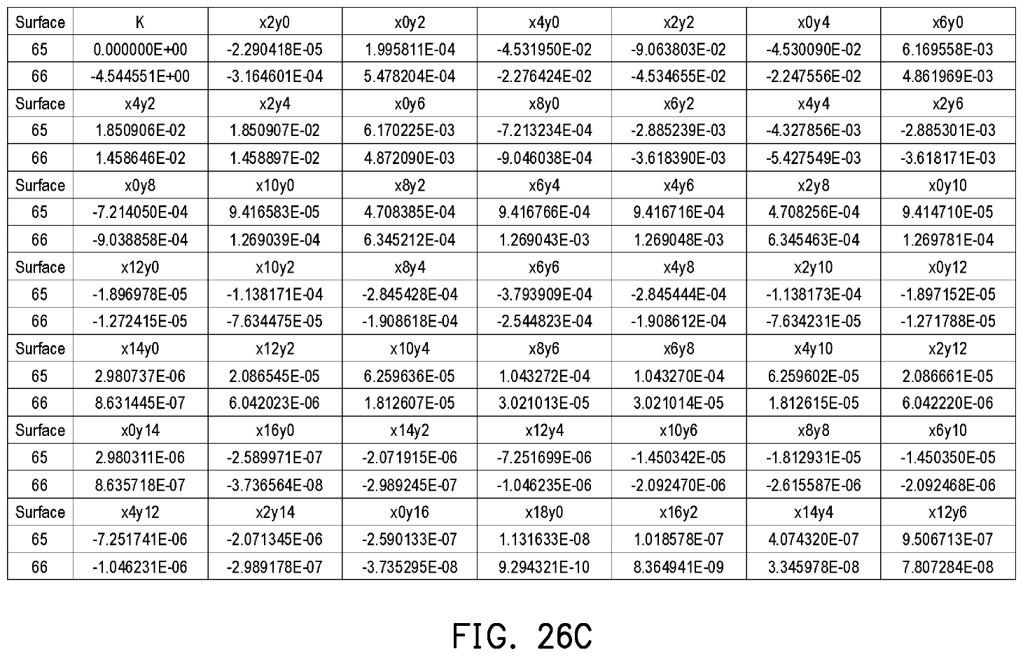

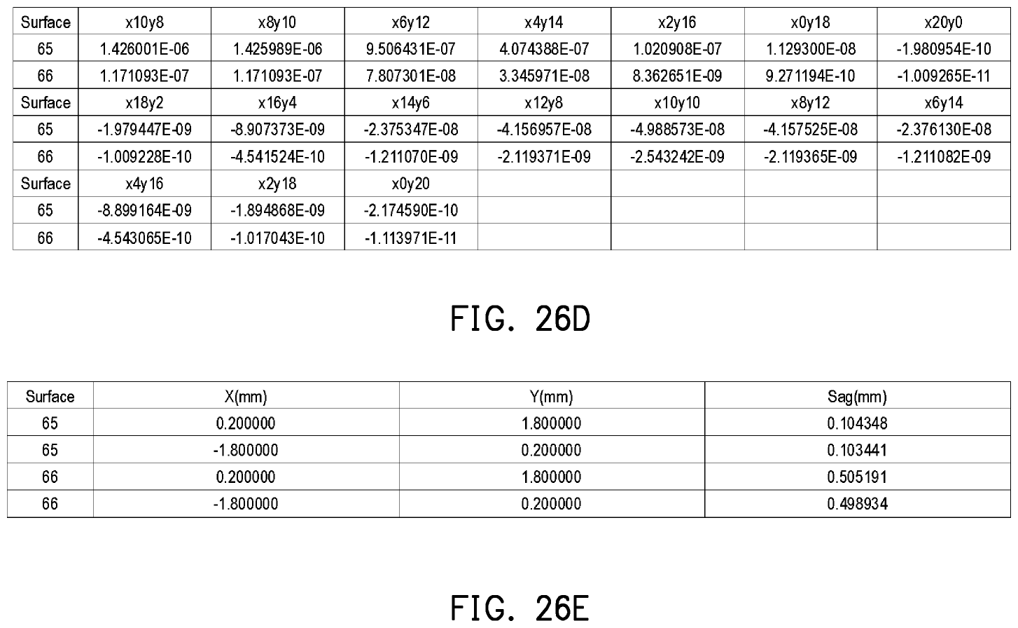

Aspheric surface coefficients of the object-side surface 15 of the first lens element 1 to the image-side surface 56 of the fifth lens element 5 and the object-side surface 75 and image-side surface 76 of the seventh lens element 7 in the fifth embodiment in Formula (1) are shown in FIG. 26A and FIG. 26B. Coefficients of each term of the X^{m}Yⁿ of the object-side surface 65 and the image-side surface 66 of the sixth lens element 6 in the fifth embodiment in Formula (2) are shown in FIG. 26C and FIG. 26D. FIG. 26E shows the corresponding Sag values of the sixth lens element of the fifth embodiment of the disclosure at the two selected coordinate values on the XY plane.

In addition, the relationships between important parameters of the optical imaging lens 10 in the fifth embodiment is shown in FIG. 75.

Longitudinal spherical aberrations of the fifth embodiment are shown in FIG. 24A, and imaging point deviations of off-axis rays at different heights are controlled within a range of ±0.018 mm. In two field curvature aberration diagrams of FIG. 24B and FIG. 24C, focal length variations of three representative wavelengths in an entire field of view fall within a range of ±0.25 mm. A distortion aberration diagram of FIG. 24D shows that distortion aberrations of the fifth embodiment are retained within a range of ±4%.

Based on the above, it can be seen that the Fno in the fifth embodiment is smaller than the Fno in the first embodiment.

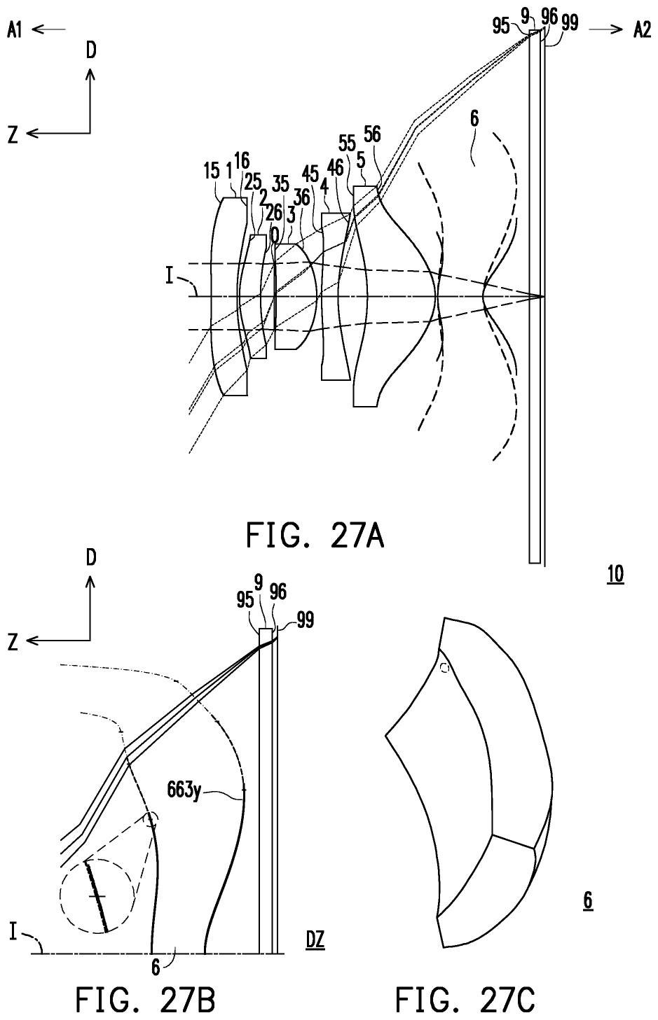

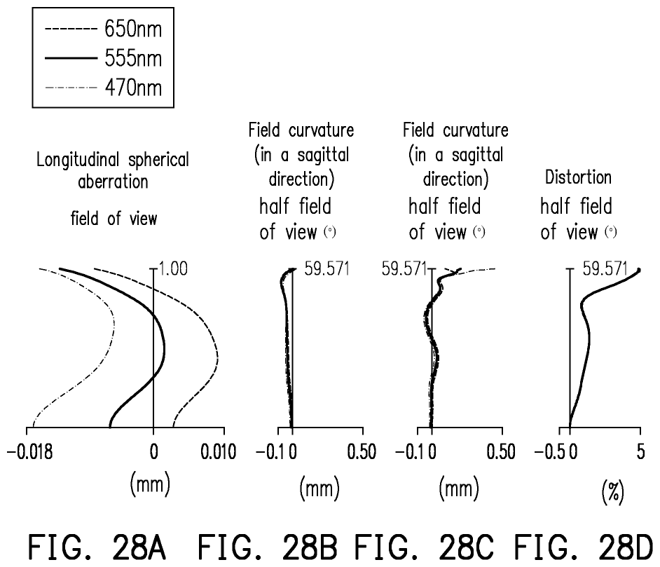

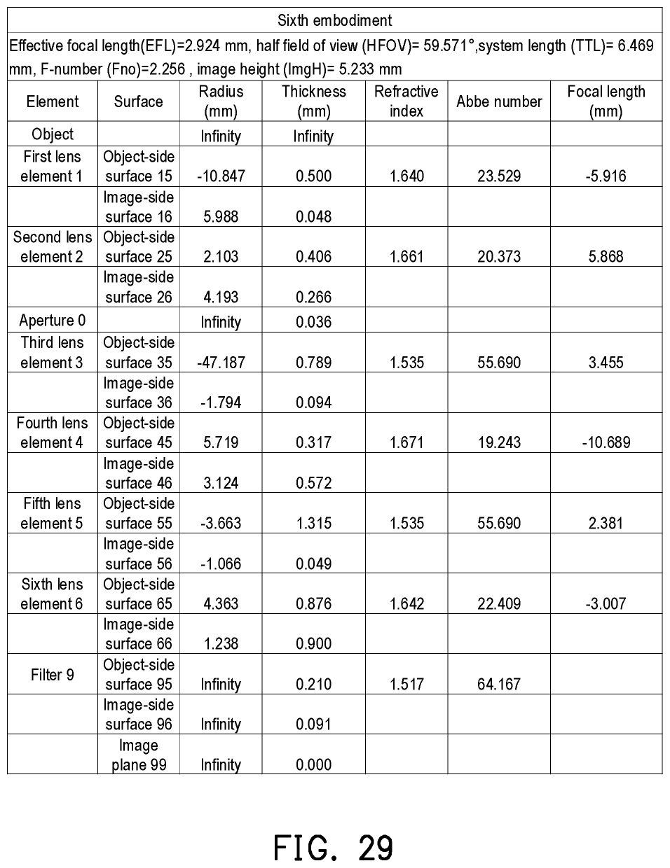

FIG. 27A is a schematic diagram of an optical imaging lens according to a sixth embodiment of the disclosure. FIG. 27B is an enlarged radial cross-sectional view of the sixth lens element of FIG. 27A crossed by different planes. FIG. 27C is a schematic diagram of the appearance of the sixth lens element of FIG. 27A. FIG. 28A to FIG. 28D are diagrams of longitudinal spherical aberrations and astigmatic aberrations of the optical imaging lens according to the sixth embodiment. Referring to FIG. 27A to FIG. 27C, the sixth embodiment of the optical imaging lens 10 of the disclosure is basically similar to the first embodiment, which differs as follows: optical data, aspheric surface coefficients, and parameters between the lens elements 1, 2, 3, 4, 5 and 6 are different to some extent. In addition, in the intersection curves of the image-side surface 66 crossed by the second reference plane, a periphery region 663y of the image-side surface 66 of the sixth lens element 6 is convex. Herein, it should be noted that, for clearly presenting the diagram, reference numbers of optical axis regions and periphery regions with surface structures similar to that of in the first embodiment are omitted in FIG. 27A and FIG. 27B.

Detailed optical data of the optical imaging lens 10 in the sixth embodiment is shown in FIG. 29, and the optical imaging lens 10 in the sixth embodiment has an EFL of 2.924 mm, an HFOV of 59.571°, a Fno of 2.256, a TTL of 6.469 mm, and an image height of 5.233 mm.

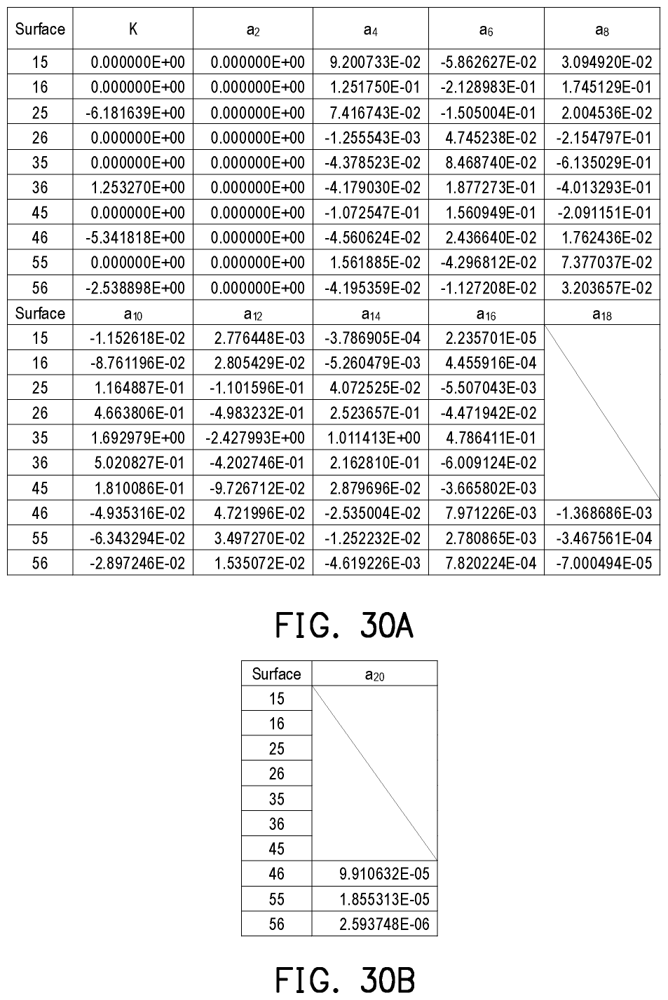

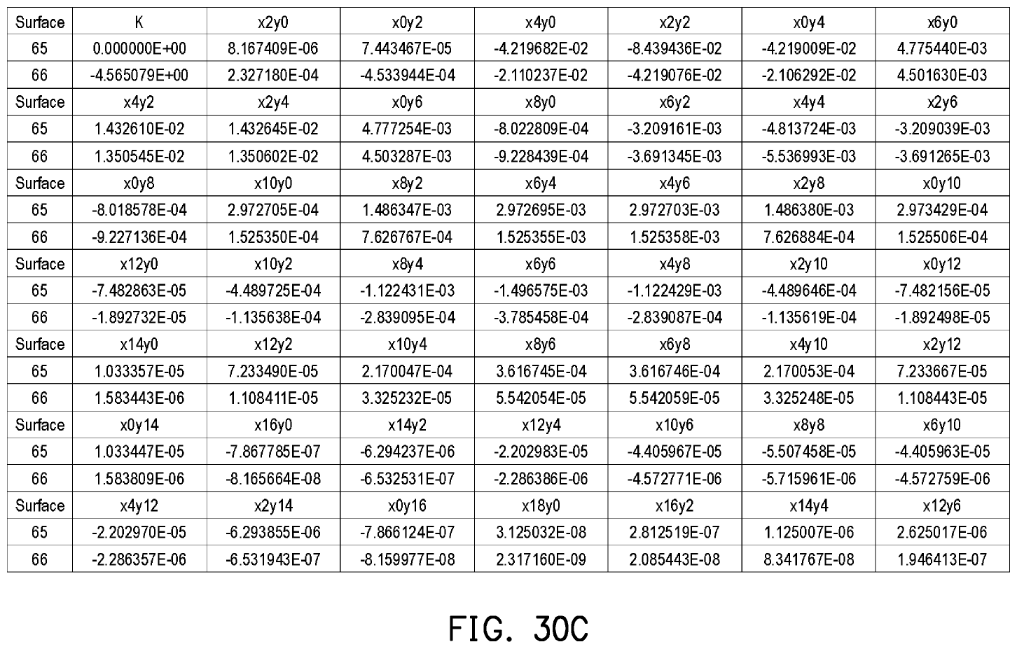

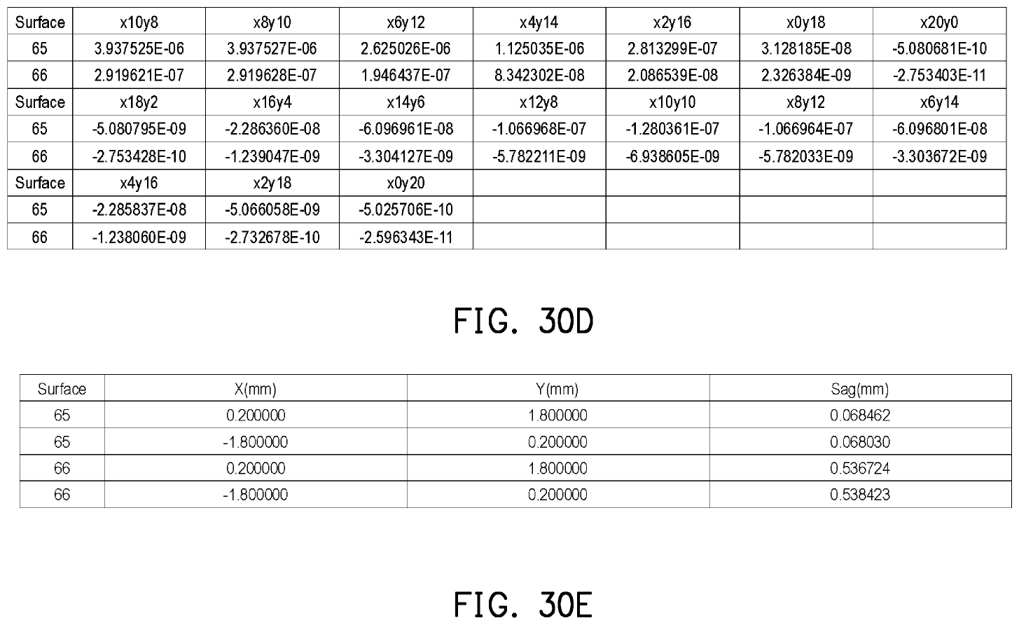

Aspheric surface coefficients of the object-side surface 15 of the first lens element 1 to the image-side surface 56 of the fifth lens element 5 and the object-side surface 75 and image-side surface 76 of the seventh lens element 7 in the sixth embodiment in Formula (1) are shown in FIG. 30A and FIG. 30B. Coefficients of each term of the X^{m}Yⁿ of the object-side surface 65 and the image-side surface 66 of the sixth lens element 6 in the sixth embodiment in Formula (2) are shown in FIG. 30C and FIG. 30D. FIG. 30E shows the corresponding Sag values of the sixth lens element of the sixth embodiment of the disclosure at the two selected coordinate values on the XY plane.

In addition, the relationships between important parameters of the optical imaging lens 10 in the sixth embodiment is shown in FIG. 75.

Longitudinal spherical aberrations of the sixth embodiment are shown in FIG. 28A, and imaging point deviations of off-axis rays at different heights are controlled within a range of ±0.018 mm. In two field curvature aberration diagrams of FIG. 28B and FIG. 28C, focal length variations of three representative wavelengths in an entire field of view fall within a range of ±0.5 mm. A distortion aberration diagram of FIG. 28D shows that distortion aberrations of the sixth embodiment are retained within a range of ±5%.

Based on the above, it can be seen that the TTL in the sixth embodiment is smaller than the TTL in the first embodiment, and the HFOV in the sixth embodiment is smaller than the HFOV in the first embodiment.

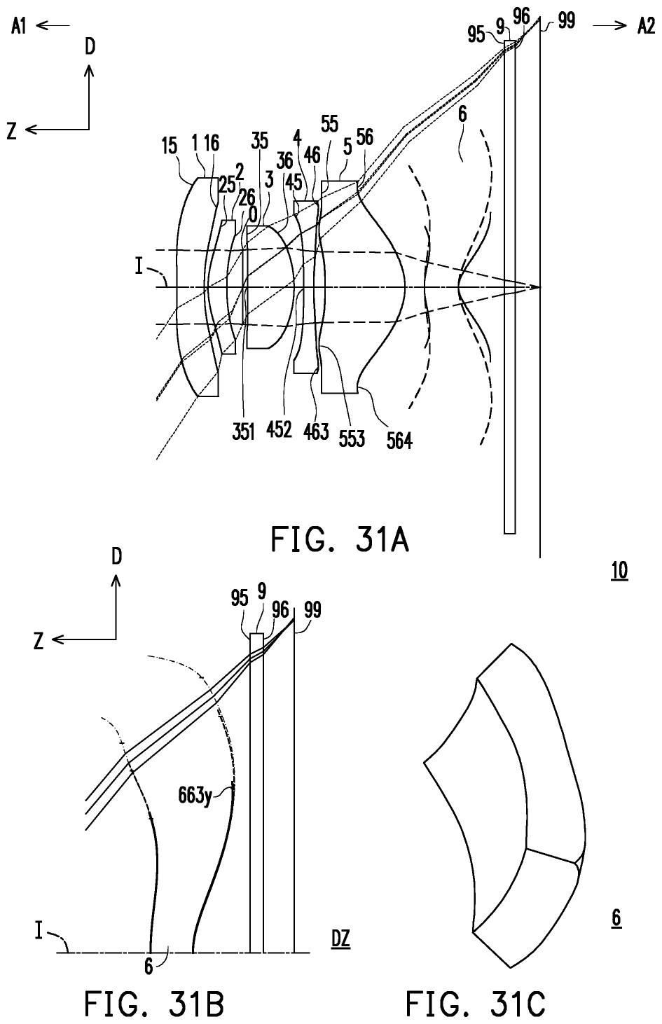

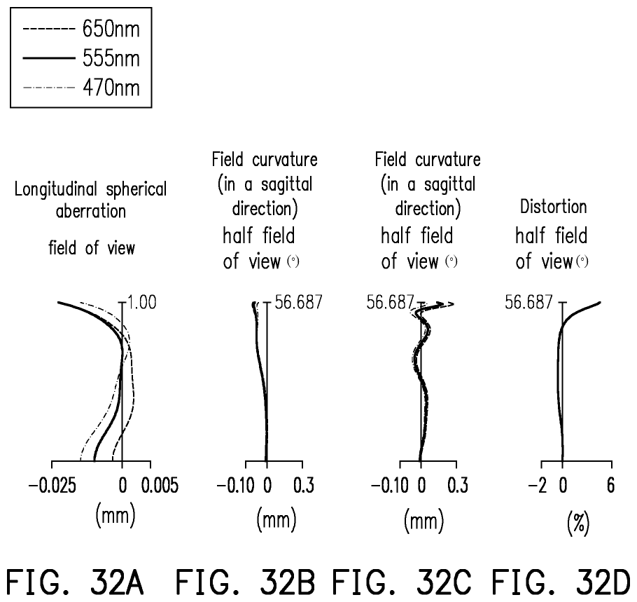

FIG. 31A is a schematic diagram of an optical imaging lens according to a seventh embodiment of the disclosure. FIG. 31B is an enlarged radial cross-sectional view of the sixth lens element of FIG. 31A crossed by different planes. FIG. 31C is a schematic diagram of the appearance of the sixth lens element of FIG. 31A. FIG. 32A to FIG. 32D are diagrams of longitudinal spherical aberrations and astigmatic aberrations of the optical imaging lens according to the seventh embodiment. Referring to FIG. 31A to FIG. 31C, first, the seventh embodiment of the optical imaging lens 10 of the disclosure is basically similar to the first embodiment, which differs as follows: optical data, aspheric surface coefficients, and parameters between the lens elements 1, 2, 3, 4, 5 and 6 are different to some extent. In addition, in the present embodiment, the optical axis region 351 of the object-side surface 35 of the third lens element 3 is convex, the optical axis region 452 of the object-side surface 45 of the fourth lens element 4 is concave, the periphery region 463 of the image-side surface 46 of the fourth lens element 4 is convex, the periphery region 553 of the object-side surface 55 of the fifth lens element 5 is convex, the periphery region 564 of the image-side surface 56 of the fifth lens element 5 is concave. In the intersection curves of the image-side surface 66 of the sixth lens element 6 crossed by the second reference plane, a periphery region 663y of the image-side surface 66 of the sixth lens element 6 is convex. Herein, it should be noted that, for clearly presenting the diagram, reference numbers of optical axis regions and periphery regions with surface structures similar to that of in the first embodiment are omitted in FIG. 31A and FIG. 31B.

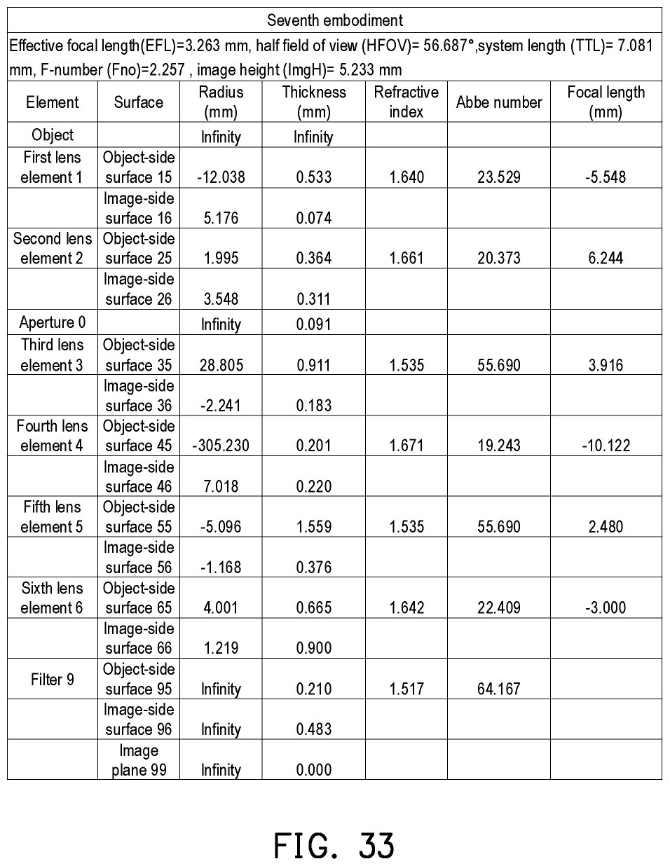

Detailed optical data of the optical imaging lens 10 in the seventh embodiment is shown in FIG. 33, and the optical imaging lens 10 in the seventh embodiment has an EFL of 3.263 mm, an HFOV of 56.687°, a Fno of 2.257, a TTL of 7.081 mm, and an image height of 5.233 mm.

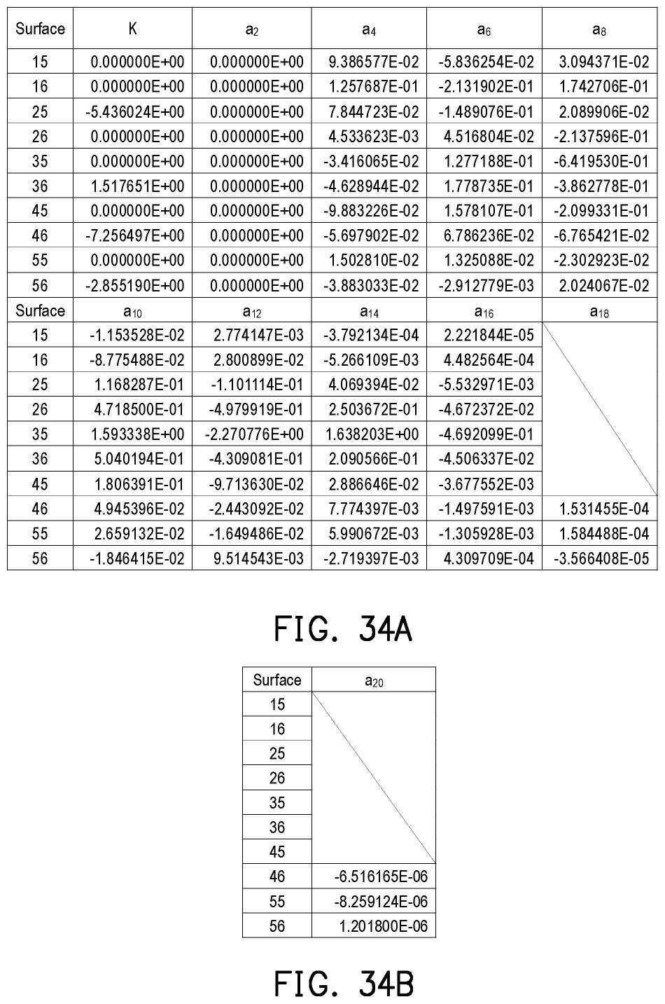

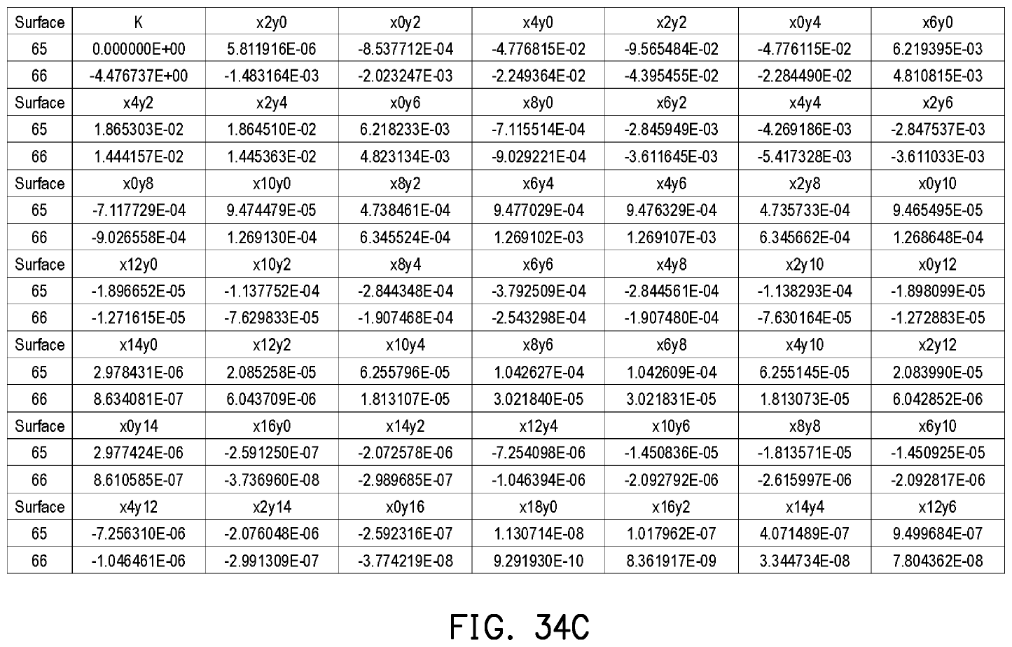

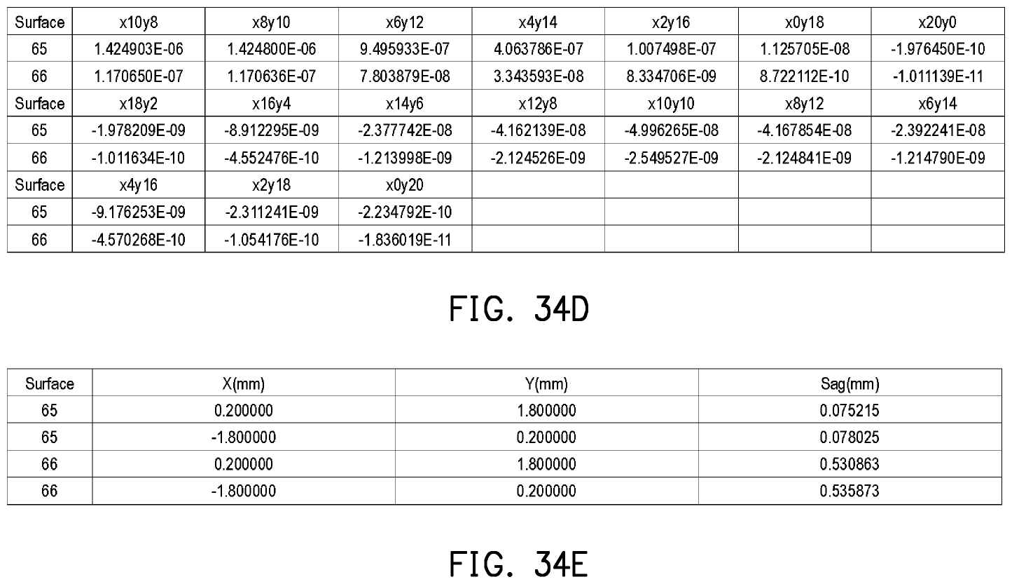

Aspheric surface coefficients of the object-side surface 15 of the first lens element 1 to the image-side surface 56 of the fifth lens element 5 and the object-side surface 75 and image-side surface 76 of the seventh lens element 7 in the seventh embodiment in Formula (1) are shown in FIG. 34A and FIG. 34B. Coefficients of each term of the X^{m}Yⁿ of the object-side surface 65 and the image-side surface 66 of the sixth lens element 6 in the seventh embodiment in Formula (2) are shown in FIG. 34C and FIG. 34D. FIG. 34E shows the corresponding Sag values of the sixth lens element of the seventh embodiment of the disclosure at the two selected coordinate values on the XY plane.

In addition, the relationships between important parameters of the optical imaging lens 10 in the seventh embodiment is shown in FIG. 75.

Longitudinal spherical aberrations of the seventh embodiment are shown in FIG. 32A, and imaging point deviations of off-axis rays at different heights are controlled within a range of ±0.025 mm. In two field curvature aberration diagrams of FIG. 32B and FIG. 32C, focal length variations of three representative wavelengths in an entire field of view fall within a range of ±0.3 mm. A distortion aberration diagram of FIG. 32D shows that distortion aberrations of the seventh embodiment are retained within a range of ±6%.

Based on the above, it can be seen that the TTL in the seventh embodiment is smaller than the TTL in the first embodiment.

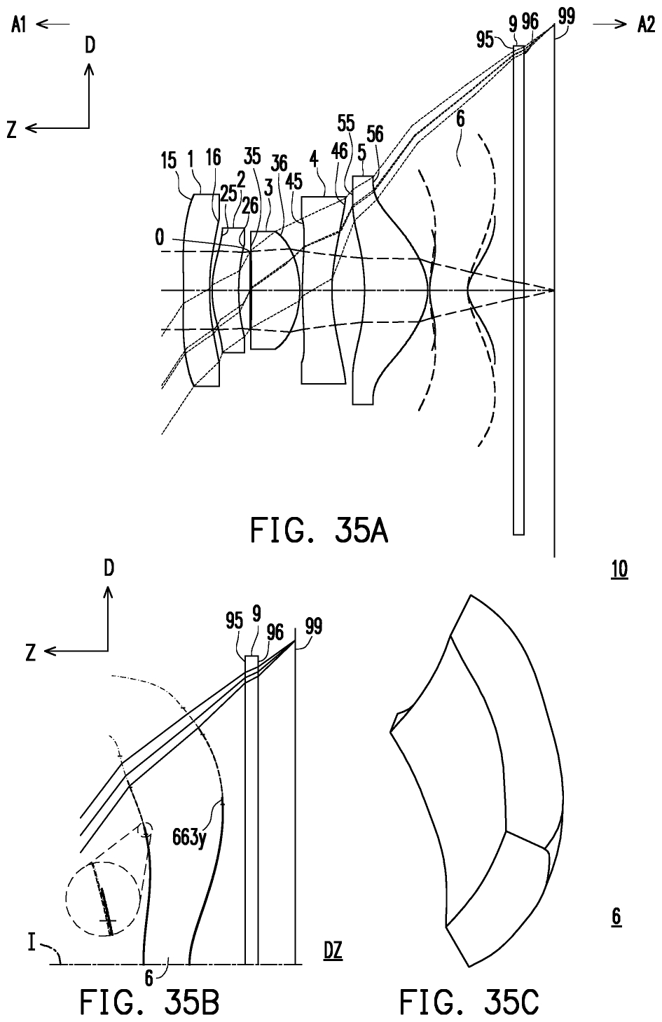

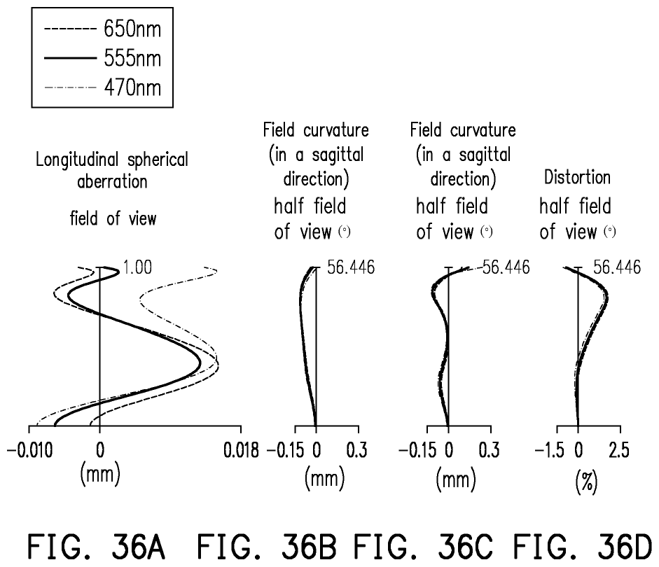

FIG. 35A is a schematic diagram of an optical imaging lens according to an eighth embodiment of the disclosure. FIG. 35B is an enlarged radial cross-sectional view of the sixth lens element of FIG. 35A crossed by different planes. FIG. 35C is a schematic diagram of the appearance of the sixth lens element of FIG. 35A. FIG. 36A to FIG. 36D are diagrams of longitudinal spherical aberrations and astigmatic aberrations of the optical imaging lens according to the eighth embodiment. Referring to FIG. 35A to FIG. 35C, first, the eighth embodiment of the optical imaging lens 10 of the disclosure is basically similar to the first embodiment. Referring to FIG. 35A to FIG. 35C, first, the eighth embodiment of the optical imaging lens 10 of the disclosure is basically similar to the first embodiment, which differs as follows: optical data, aspheric surface coefficients, and parameters between the lens elements 1, 2, 3, 4, 5 and 6 are different to some extent. In addition, in the present embodiment, in the intersection curves of the image-side surface 66 of the sixth lens element 6 crossed by the second reference plane, a periphery region 663y of the image-side surface 66 of the sixth lens element 6 is convex. Herein, it should be noted that, for clearly presenting the diagram, reference numbers of optical axis regions and periphery regions with surface structures similar to that of in the first embodiment are omitted in FIG. 35A and FIG. 35B.

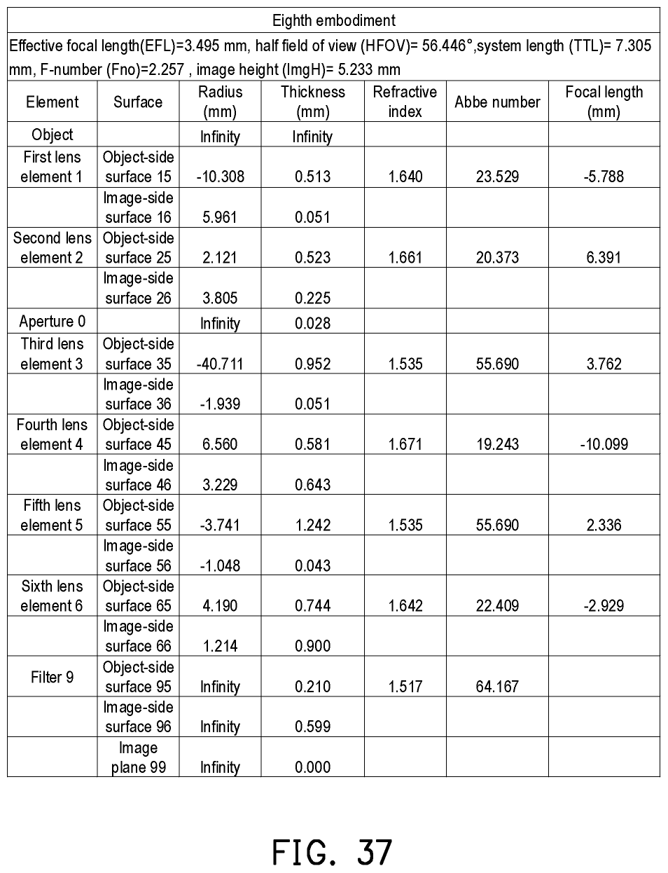

Detailed optical data of the optical imaging lens 10 in the eighth embodiment is shown in FIG. 37, and the optical imaging lens 10 in the eighth embodiment has an EFL of 3.495 mm, an HFOV of 56.446°, a Fno of 2.257, a TTL of 7.305 mm, and an image height of 5.233 mm.

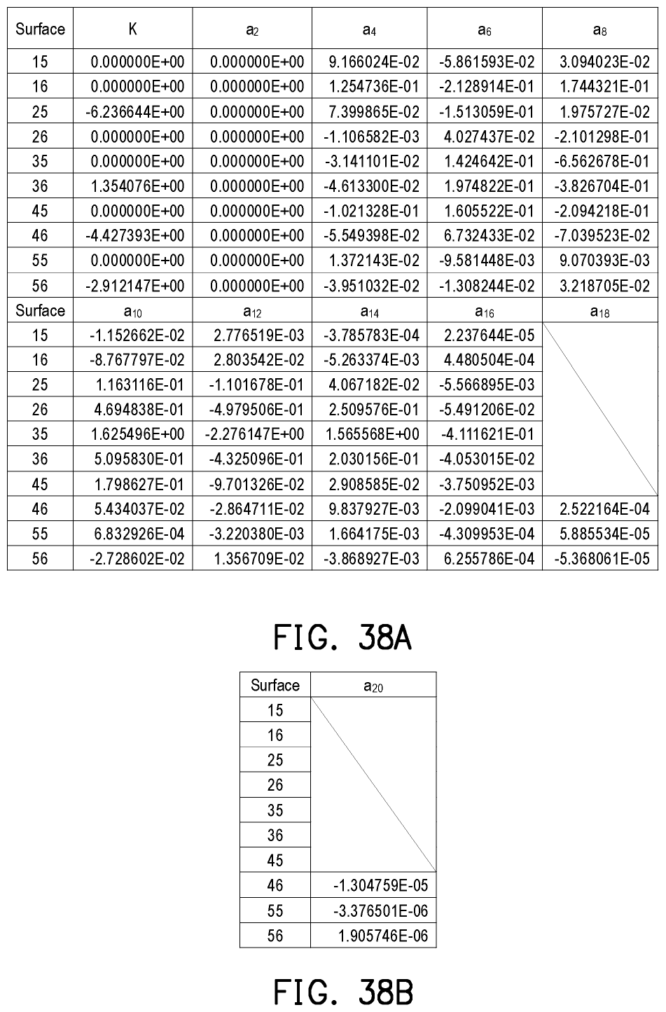

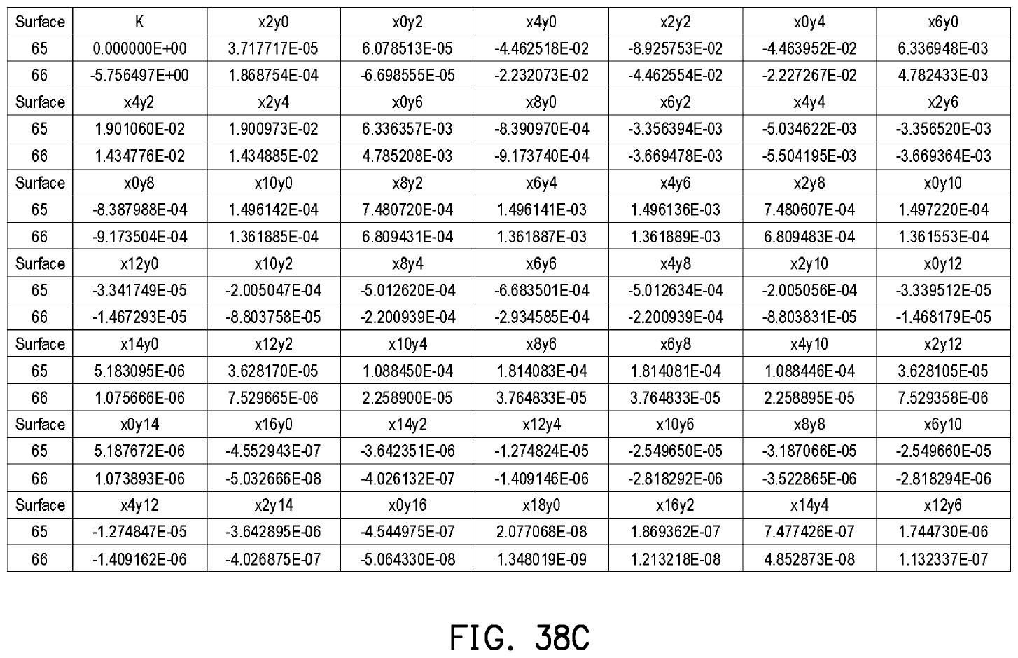

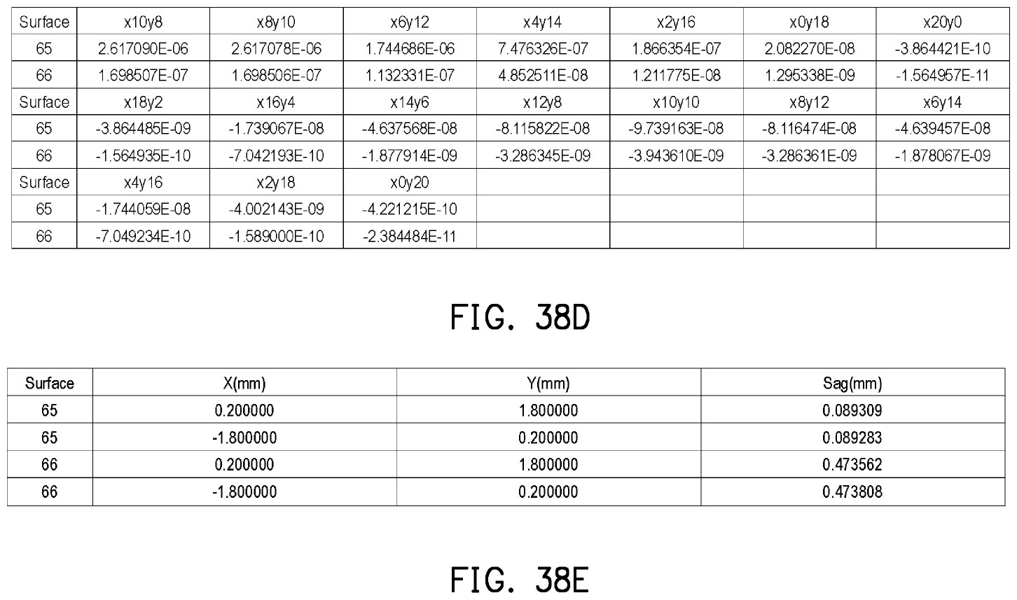

Aspheric surface coefficients of the object-side surface 15 of the first lens element 1 to the image-side surface 46 of the fourth lens element 4 and the object-side surface 75 of the seventh lens element 7 to the image-side surface 66 of the sixth lens element 6 in the eighth embodiment in Formula (1) are shown in FIG. 38A and FIG. 38B. Coefficients of each term of the X^{m}Yⁿ of the object-side surface 55 and the image-side surface 56 of the fifth lens element 5 in the eighth embodiment in Formula (2) are shown in FIG. 38C and FIG. 38D. FIG. 38E shows the corresponding Sag values of the fifth lens element of the eighth embodiment of the disclosure at the two selected coordinate values on the XY plane.

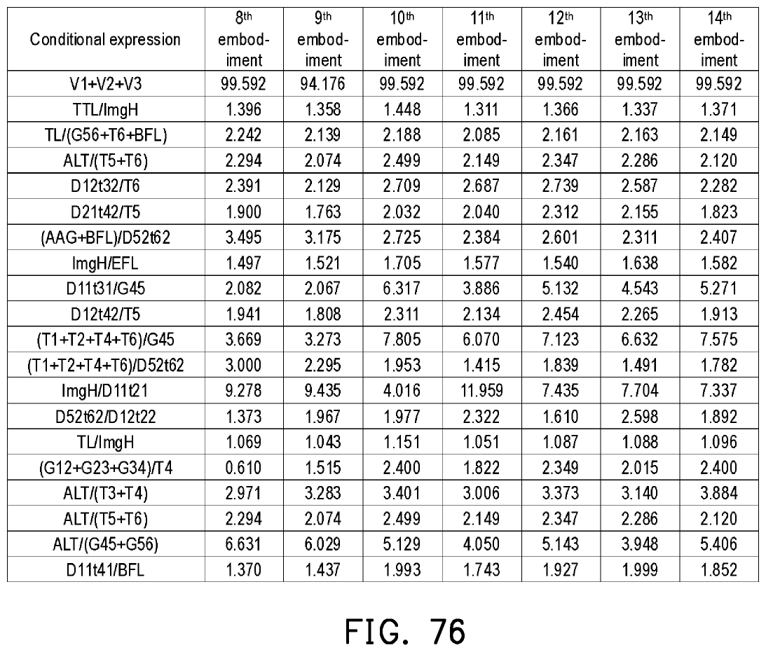

In addition, the relationships between important parameters of the optical imaging lens 10 in the eighth embodiment is shown in FIG. 76.

Longitudinal spherical aberrations of the eighth embodiment are shown in FIG. 36A, and imaging point deviations of off-axis rays at different heights are controlled within a range of ±0.018 mm. In two field curvature aberration diagrams of FIG. 36B and FIG. 36C, focal length variations of three representative wavelengths in an entire field of view fall within a range of ±0.3 mm. A distortion aberration diagram of FIG. 36D shows that distortion aberrations of the eighth embodiment are retained within a range of ±2.5%.

Based on the above, it can be seen that the optical imaging lens in the eighth embodiment is easier to be manufactured than the optical imaging lens in the first embodiment.

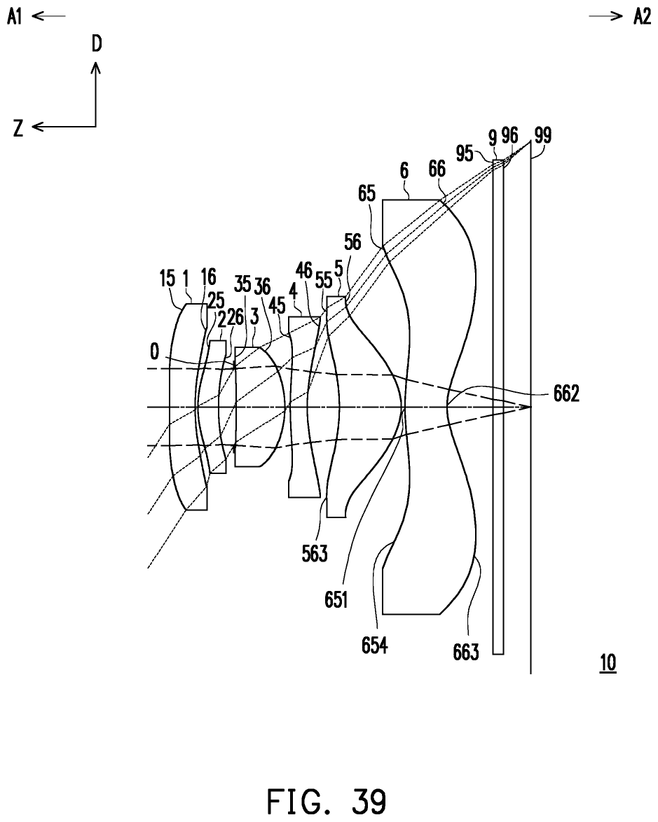

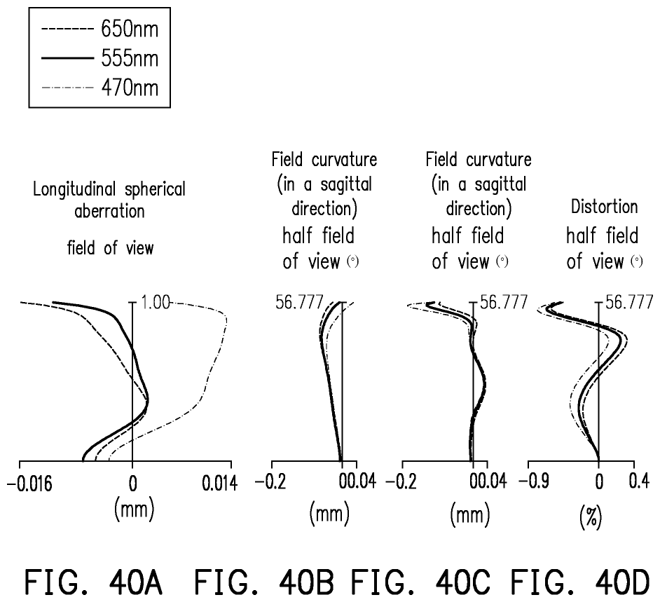

FIG. 39 is a schematic diagram of an optical imaging lens according to a ninth embodiment of the disclosure. FIG. 40A to FIG. 40D are diagrams of longitudinal spherical aberrations and astigmatic aberrations of the optical imaging lens according to the ninth embodiment. Referring to FIG. 39, first, the seventh embodiment of the optical imaging lens 10 of the disclosure is basically similar to the first embodiment, which differs as follows: optical data, aspheric surface coefficients, and parameters between the lens elements 1, 2, 3, 4, 5 and 6 are different to some extent. In addition, in the present embodiment, the periphery region 553 of the object-side surface 55 of the fifth lens element 5 is convex. Furthermore, the sixth lens is aspheric lens, that's to say, the object-side surface 65 and the image-side surface of the sixth lens element are aspheric surfaces. An optical axis region 651 of the object-side surface 65 of the sixth lens element 6 is convex, and a periphery region 654 of the object-side surface 65 of the sixth lens element 6 is concave. An optical axis region 662 of the image-side surface 66 of the sixth lens element 6 is concave, and a periphery region 663 of the image-side surface 66 of the sixth lens element 6 is convex. That's to say, in the ninth embodiment, all of the lens elements in the optical imaging lens 10 are aspheric lenses. Herein, it should be noted that, for clearly presenting the diagram, reference numbers of optical axis regions and periphery regions with surface structures similar to that of in the first embodiment are omitted in FIG. 39.

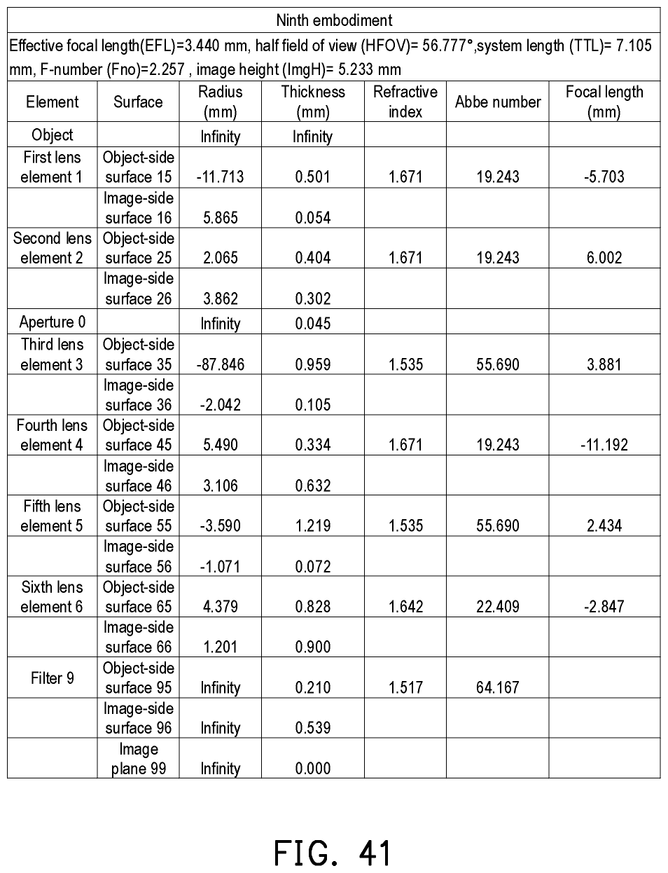

Detailed optical data of the optical imaging lens 10 in the ninth embodiment is shown in FIG. 41, and the optical imaging lens 10 in the ninth embodiment has an EFL of 3.440 mm, an HFOV of 56.777°, a Fno of 2.257, a TTL of 7.105 mm, and an image height of 5.233 mm.

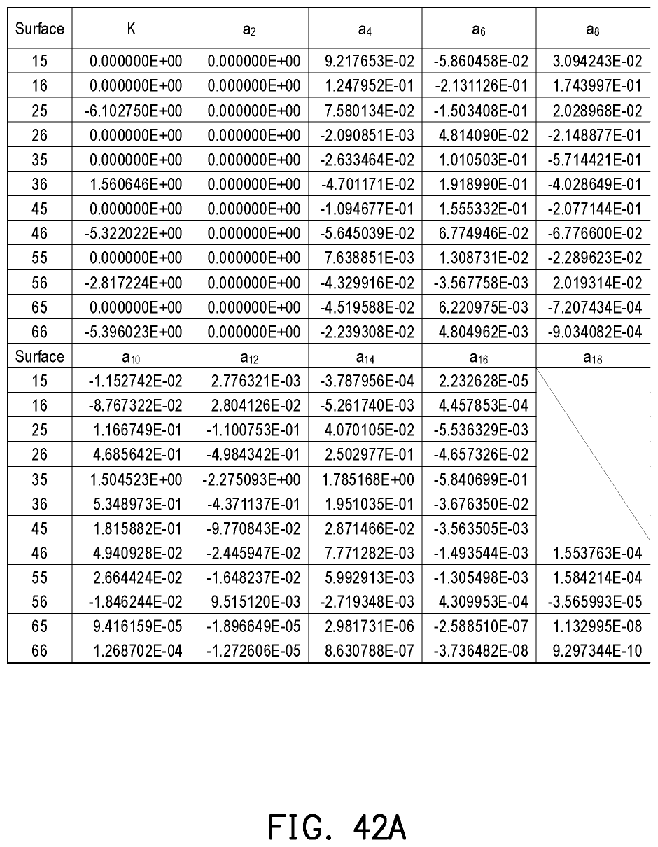

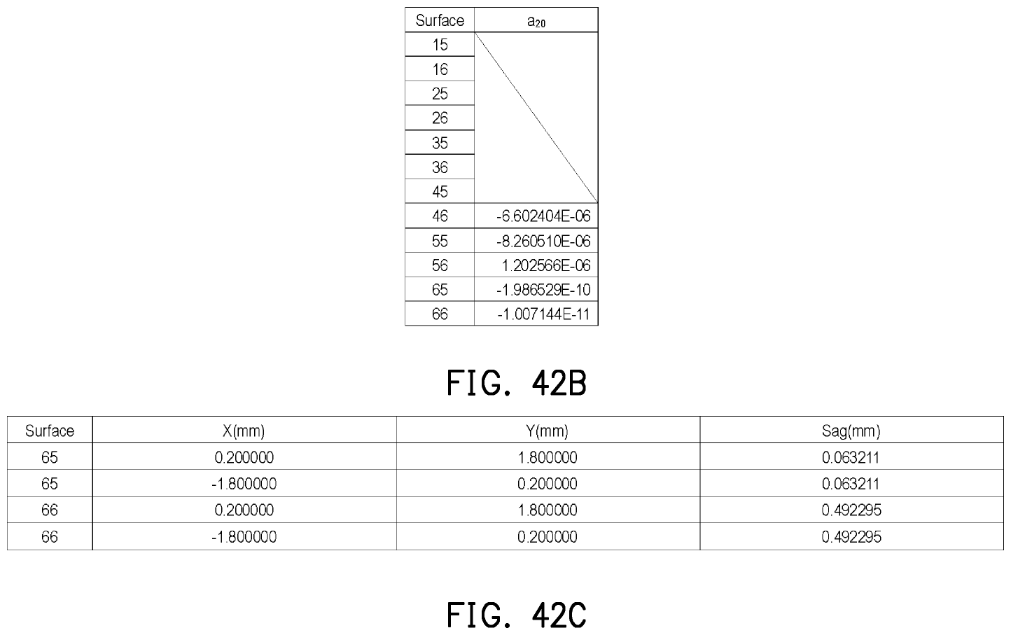

Aspheric surface coefficients of the object-side surface 15 of the first lens element 1 to the image-side surface 66 of the sixth lens element 6 in the ninth embodiment in Formula (1) are shown in FIG. 42A and FIG. 42B. FIG. 42C shows the corresponding Sag values of the sixth lens element of the ninth embodiment of the disclosure at the two selected coordinate values on the XY plane.

In addition, the relationships between important parameters of the optical imaging lens 10 in the ninth embodiment is shown in FIG. 76.

Longitudinal spherical aberrations of the ninth embodiment are shown in FIG. 40A, and imaging point deviations of off-axis rays at different heights are controlled within a range of ±0.016 mm. In two field curvature aberration diagrams of FIG. 40B and FIG. 40C, focal length variations of three representative wavelengths in an entire field of view fall within a range of ±0.2 mm. A distortion aberration diagram of FIG. 40D shows that distortion aberrations of the ninth embodiment are retained within a range of ±0.9%.

Based on the above, it can be seen that the TTL in the ninth embodiment is smaller than the TTL in the first embodiment.

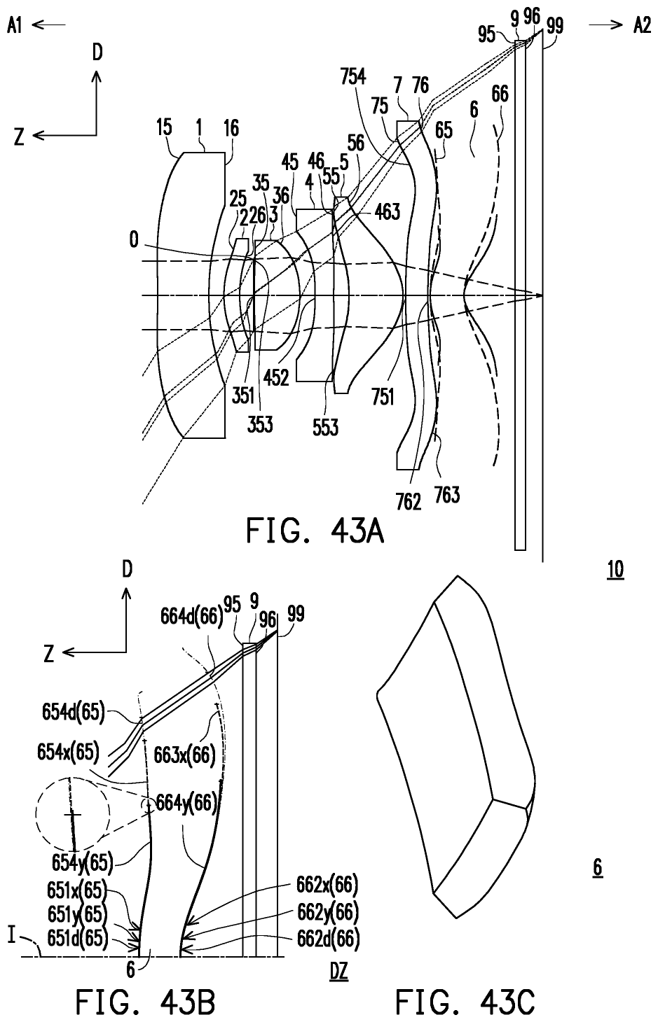

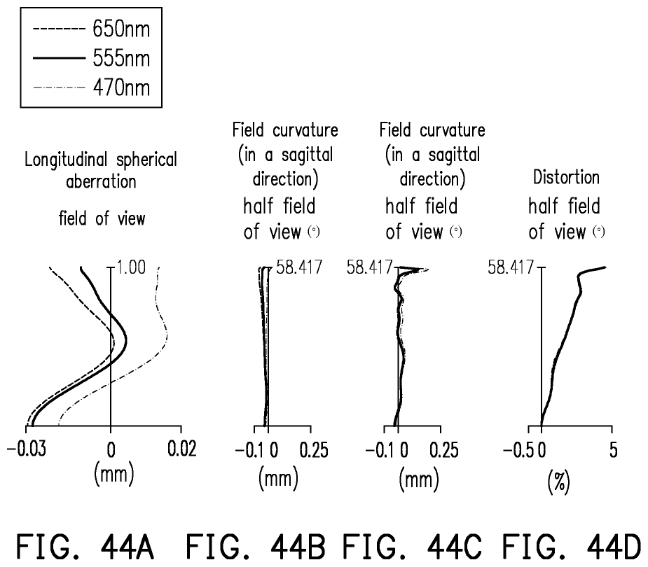

FIG. 43A is a schematic diagram of an optical imaging lens according to a tenth embodiment of the disclosure. FIG. 43B is an enlarged radial cross-sectional view of the sixth lens element of FIG. 43A crossed by different planes. FIG. 43C is a schematic diagram of the appearance of the sixth lens element of FIG. 43A. FIG. 44A to FIG. 44D are diagrams of longitudinal spherical aberrations and astigmatic aberrations of the optical imaging lens according to the tenth embodiment. Referring to FIG. 43A first, an optical imaging lens 10 in the tenth embodiment of the disclosure sequentially includes a first lens element 1, a second lens element 2, an aperture 0, a third lens element 3, a fourth lens element 4, a fifth lens element 5, a seventh lens element 7, a sixth lens element 6, and a filter 9 from an object side A1 to an image side A2 along an optical axis I of the optical imaging lens 10. After entering the optical imaging lens 10, rays emitted from a to-be-photographed object pass through the first lens element 1, the second lens element 2, the aperture 0, the third lens element 3, the fourth lens element 4, the fifth lens element 5, the seventh lens element 7, the sixth lens element 6, and the filter 9, and form an image on an image plane 99. The filter 9 is disposed between an image-side surface 66 of the sixth lens element 6 and the image plane 99. It should be noted that, the object side is a side facing the to-be-photographed object, and the image side is a side facing the image plane 99. In the present embodiment, the filter 9 is an IR cut filter.

In the present embodiment, the seventh lens element 7 of the optical imaging lens 10 includes an object-side surfaces 75 facing the object side and allowing imaging rays to pass through and an image-side surfaces 76 facing the image side and allowing the imaging rays to pass through.

The difference in the surface structures of the lens element between the tenth embodiment and the first embodiment will be described in detail in the following paragraphs. For brevity, the reference numbers omitted are as that of shown in the first embodiment.

The third lens element 3 has positive refracting power. The third lens element 3 is made from a plastic material. An optical axis region 351 of the object-side surface 35 of the third lens element 3 is convex, and a periphery region 353 of the object-side surface 35 of the third lens element 3 is convex.

The fourth lens element 4 has negative refracting power. The fourth lens element 4 is made from a plastic material. An optical axis region 452 of the object-side surface 45 of the fourth lens element 4 is concave. A periphery region 463 of the image-side surface 46 of the fourth lens element 4 is convex.

The fifth lens element 5 has positive refracting power. The fifth lens element 5 is made from a plastic material. A periphery region 553 of the object-side surface 55 of the fifth lens element 5 is convex.

The seventh lens element 7 has positive refracting power. The seventh lens element 7 is made from a plastic material. An optical axis region 751 of the object-side surface 75 of the seventh lens element 7 is convex, and a periphery region 754 of the object-side surface 75 of the seventh lens element 7 is concave. An optical axis region 762 of the image-side surface 76 of the seventh lens element 7 is concave, and a periphery region 763 of the image-side surface 76 of the seventh lens element 7 is convex. In the present embodiment, both the object-side surface 75 and the image-side surface 76 of the seventh lens element 7 are aspheric surfaces, but the disclosure is not limited thereto.

In the present embodiment, only the above seven lens elements of the optical imaging lens 10 have refracting power.

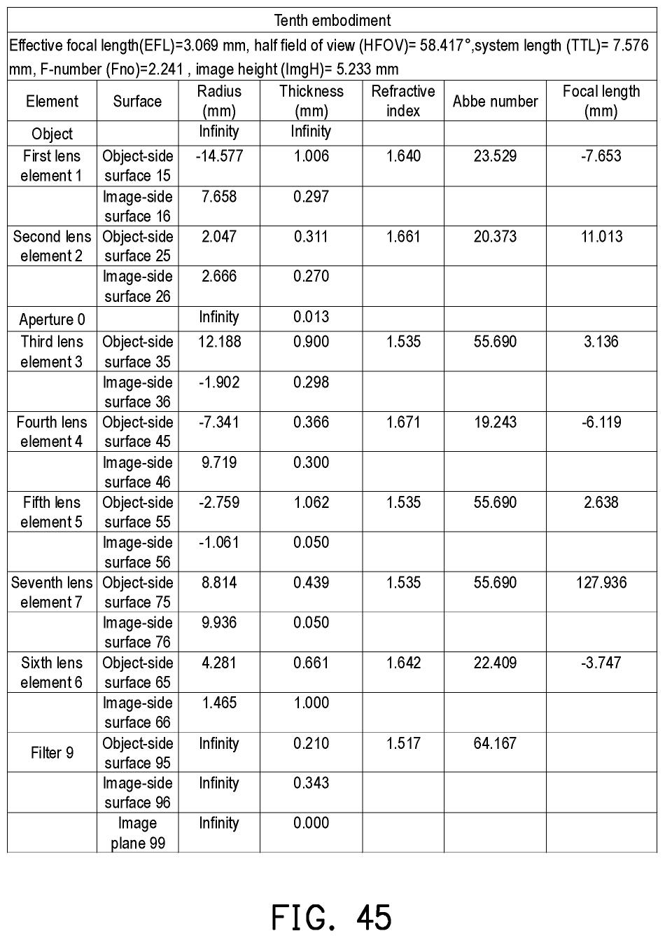

Detailed optical data of the optical imaging lens 10 in the tenth embodiment is shown in FIG. 45, and the optical imaging lens 10 in the tenth embodiment has an EFL of 3.069 mm, an HFOV of 58.417°, a Fno of 2.241, a TTL of 7.576 mm, and an image height of 5.233 mm.

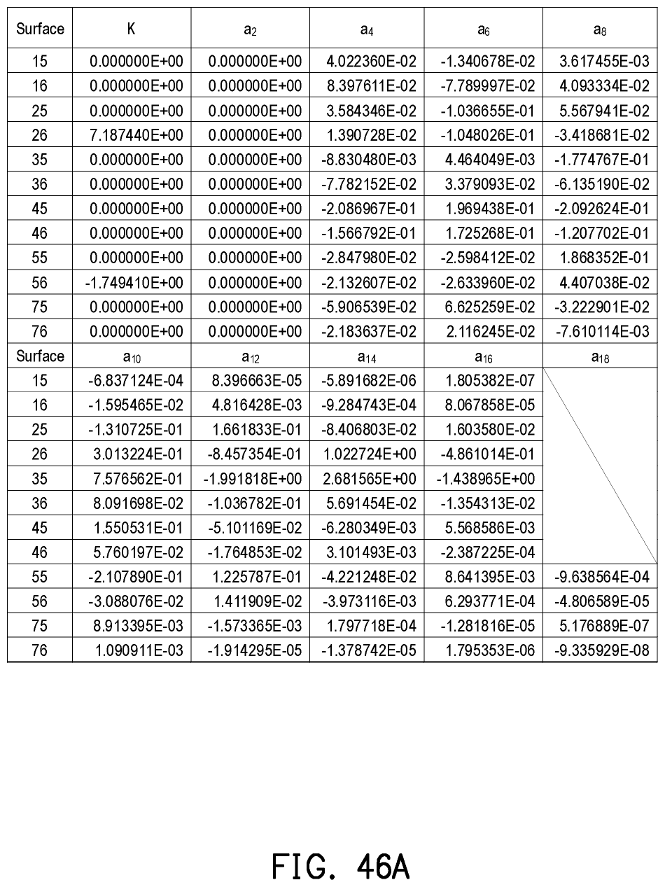

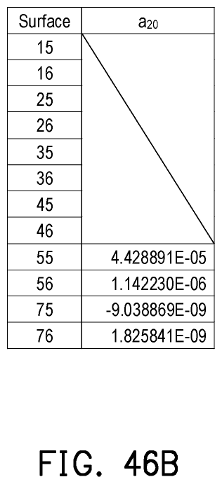

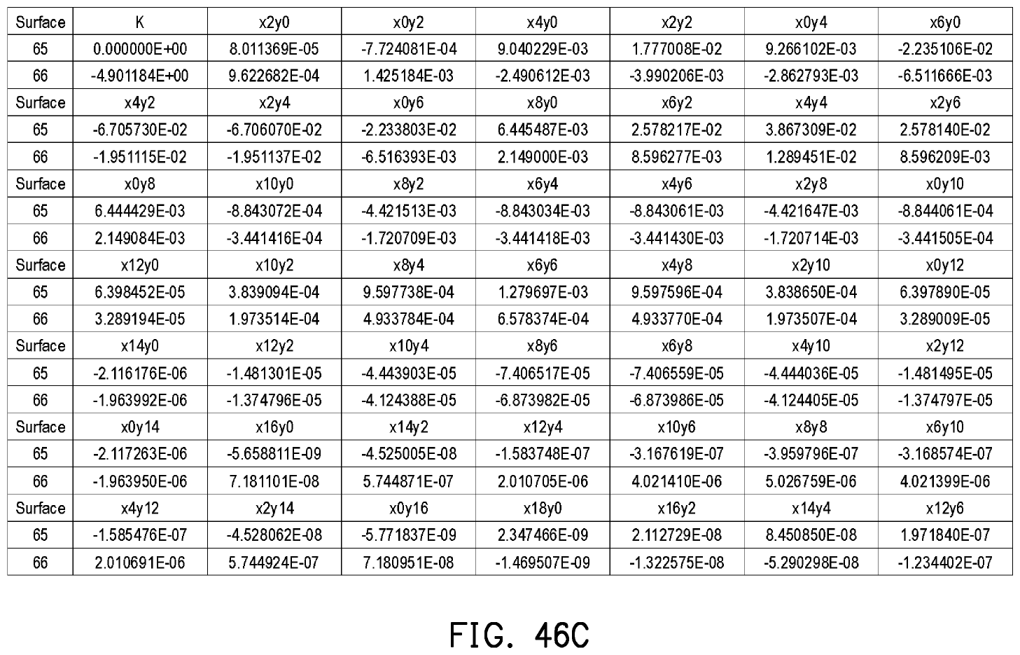

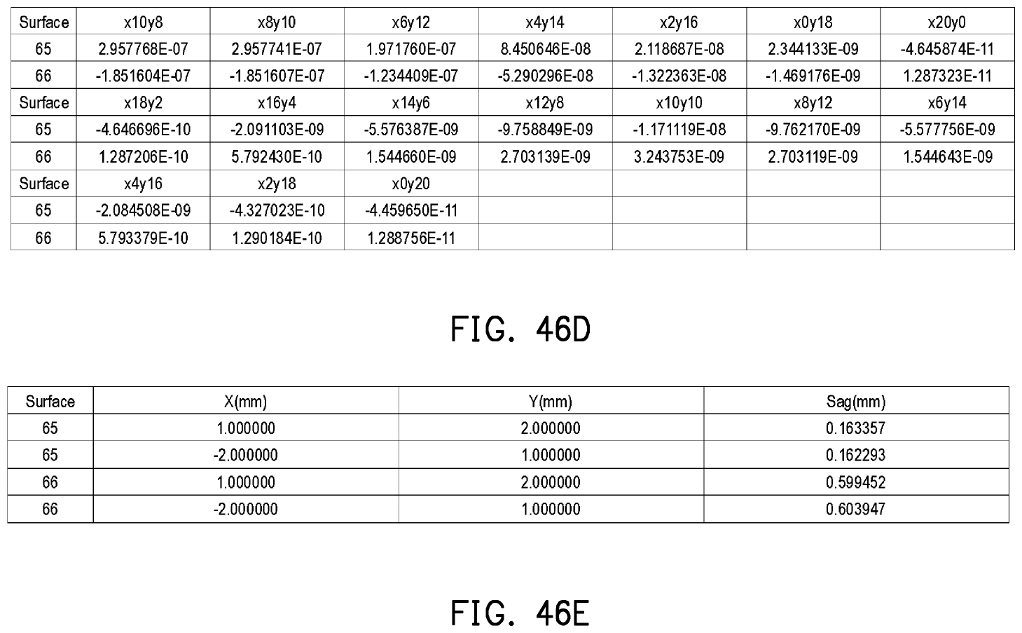

Aspheric surface coefficients of the object-side surface 15 of the first lens element 1 to the image-side surface 56 of the fifth lens element 5 in Formula (1) are shown in FIG. 46A and FIG. 46B.

Coefficients of each term of the X^{m}Yⁿ of the object-side surface 65 and the image-side surface 66 of the sixth lens element 6 in the tenth embodiment in Formula (2) are shown in FIG. 46C and FIG. 46D. FIG. 46E shows the corresponding Sag values of the sixth lens element of the tenth embodiment of the disclosure at the two selected coordinate values on the XY plane.

In addition, the relationships between important parameters of the optical imaging lens 10 in the tenth embodiment is shown in FIG. 76.

Wherein, it is defined:

T7 is a thickness of the seventh lens element 7 along the optical axis I;

G57 is a distance from the image-side surface 56 of the fifth lens element 5 to the object-side surface 75 of the seventh lens element 7 along the optical axis I;

G76 is a distance from the image-side surface 76 of the seventh lens element 7 to the object-side surface 65 of the sixth lens element 6 along the optical axis I;

In addition, it is defined:

f7 is a focal length of the seventh lens element 7;

n7 is a refractive index of the seventh lens element 7; and

V7 is an Abbe number of the seventh lens element 7.

Further referring to FIG. 44A to FIG. 44D, FIG. 44A illustrates longitudinal spherical aberrations according to the tenth embodiment, FIG. 44B and FIG. 44C respectively illustrate field curvature aberrations in a sagittal direction and field curvature aberrations in a tangential direction on the image plane 99 in cases of wavelengths 470 nm, 555 nm, and 650 nm according to the tenth embodiment, and FIG. 44D illustrates distortion aberrations on the image plane 99 in cases of wavelengths 470 nm, 555 nm, and 650 nm according to the tenth embodiment. The longitudinal spherical aberrations of the tenth embodiment are shown in FIG. 44A, and curves of all the wavelengths are quite close to each other and approach the middle. It indicates that off-axis rays of all the wavelengths at different heights are focused near an imaging point. From deflection amplitude of the curves of all the wavelengths, it can be seen that imaging point deviations of the off-axis rays at different heights are controlled within a range of ±0.03 mm. Therefore, a spherical aberration of a same wavelength is definitely reduced in the tenth embodiment. In addition, the three representative wavelengths are also quite close to each other. It indicates that imaging positions of rays of different wavelengths are quite focused. Therefore, chromatic and astigmatic aberrations are also definitely reduced.

In the two field curvature aberration diagrams of FIG. 44B and FIG. 44C, focal length variations of the three representative wavelengths in an entire field of view fall within a range of ±0.25 mm. It indicates that astigmatic aberrations can be effectively eliminated by the optical system in the tenth embodiment. The distortion aberration diagram of FIG. 44D shows that the distortion aberrations of the tenth embodiment are retained within a range of ±5%. It indicates that the distortion aberrations of the tenth embodiment satisfy an imaging quality requirement of the optical system. To be specific, different from an existing optical lens, the first embodiment can still provide desired imaging quality when the TTL is reduced to approximately 7.576 mm. Therefore, the tenth embodiment can have a shorter length and achieve desired imaging quality while maintaining desired optical properties.

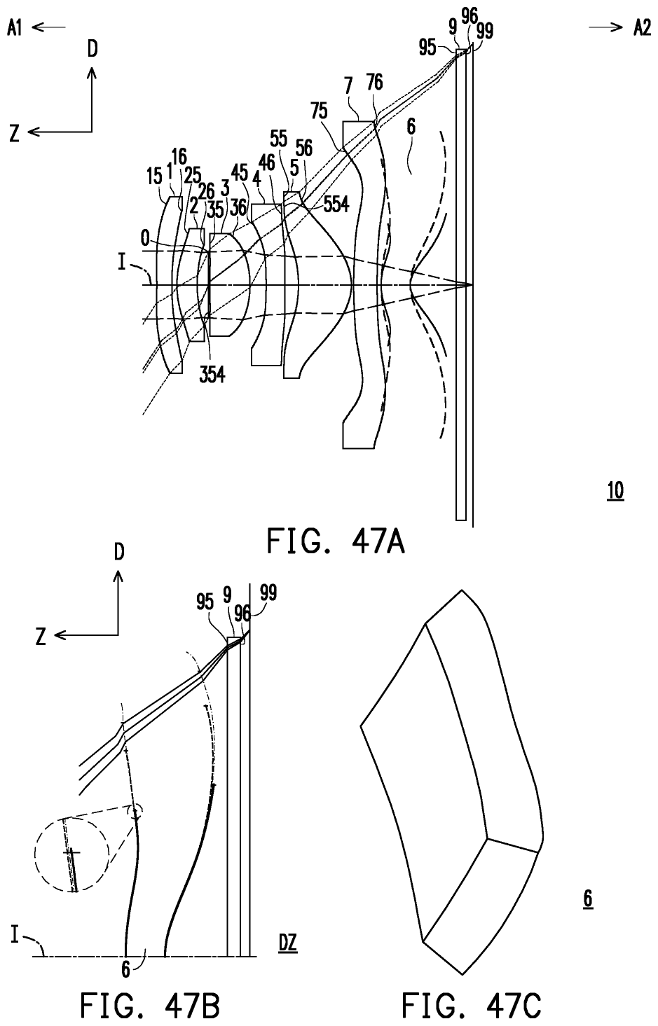

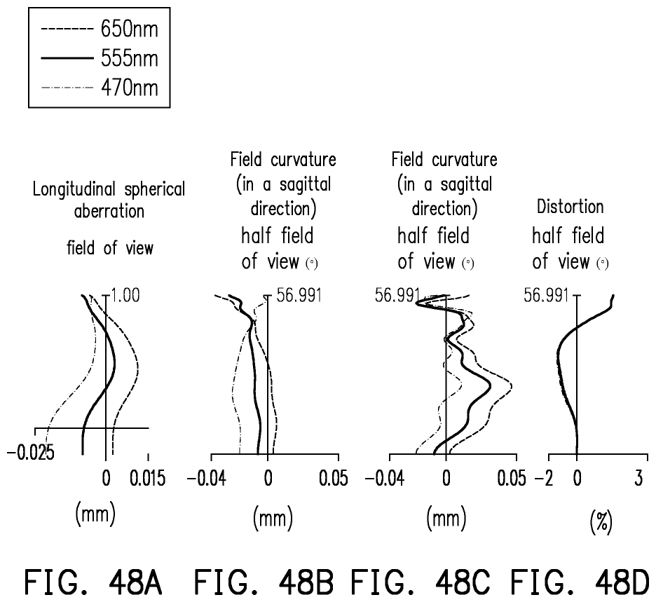

FIG. 47A is a schematic diagram of an optical imaging lens according to an eleventh embodiment of the disclosure. FIG. 47B is an enlarged radial cross-sectional view of the sixth lens element of FIG. 47A crossed by different planes. FIG. 47C is a schematic diagram of the appearance of the sixth lens element of FIG. 47A. FIG. 48A to FIG. 48D are diagrams of longitudinal spherical aberrations and astigmatic aberrations of the optical imaging lens according to the eleventh embodiment. Referring to FIG. 47A to FIG. 47C, first, the second embodiment of the optical imaging lens 10 of the disclosure is basically similar to the first embodiment, which differs as follows: optical data, aspheric surface coefficients, and parameters between the lens elements 1, 2, 3, 4, 5, 6 and 7 are different to some extent. In addition, in the present embodiment, a periphery region 354 of the object-side surface 35 of the third lens element 3 is concave. A periphery region 554 of the object-side surface 55 of the fifth lens element 5 is concave. Herein, it should be noted that, for clearly presenting the diagram, reference numbers of optical axis regions and periphery regions with surface structures similar to that of in the tenth embodiment are omitted in FIG. 47A and FIG. 47B.

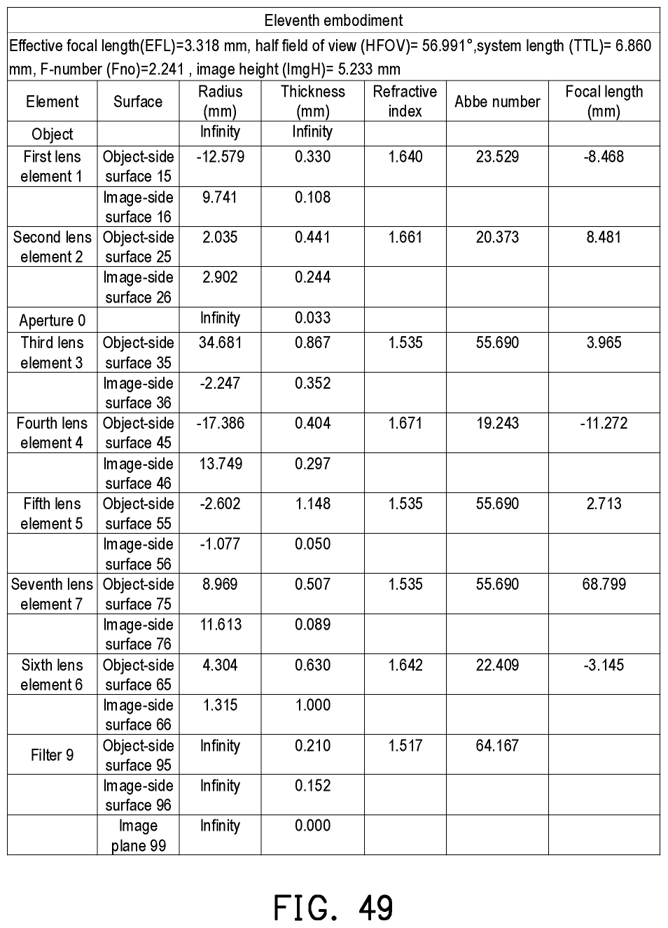

Detailed optical data of the optical imaging lens 10 in the eleventh embodiment is shown in FIG. 49, and the optical imaging lens 10 in the third embodiment has an EFL of 3.318 mm, an HFOV of 56.991°, a Fno of 2.241, a TTL of 6.860 mm, and an image height of 5.233 mm.

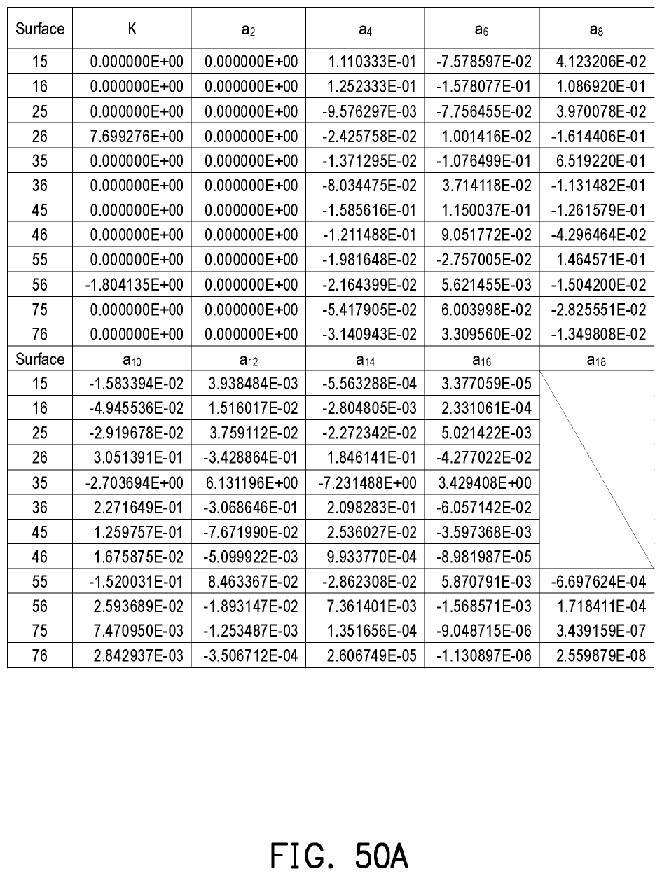

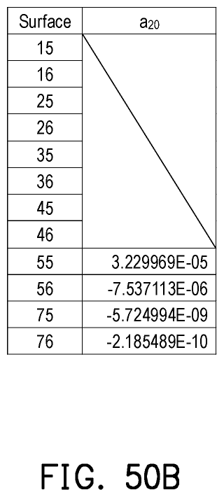

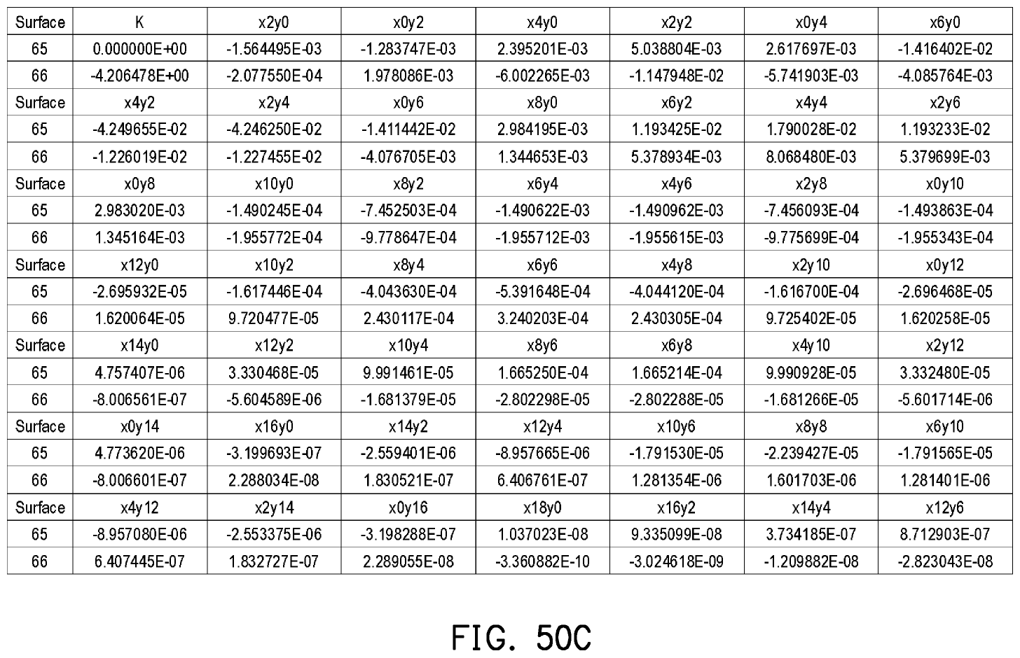

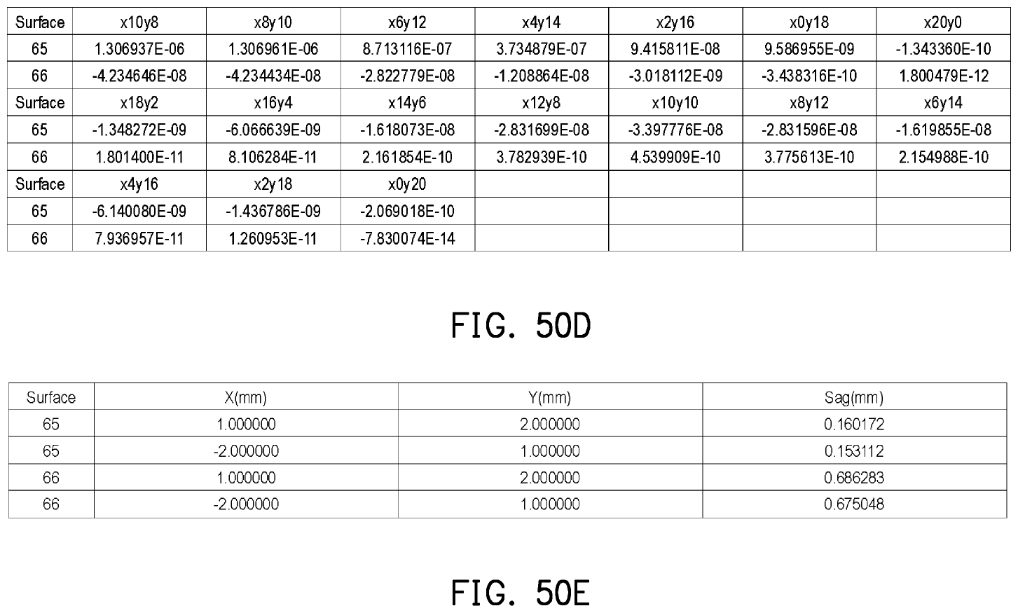

Aspheric surface coefficients of the object-side surface 15 of the first lens element 1 to the image-side surface 76 of the seventh lens element 7 in the eleventh embodiment in Formula (1) are shown in FIG. 50A and FIG. 50B. Coefficients of each term of the X^{m}Yⁿ of the object-side surface 65 and the image-side surface 66 of the sixth lens element 6 in the eleventh embodiment in Formula (2) are shown in FIG. 50C and FIG. 50D. FIG. 50E shows the corresponding Sag values of the sixth lens element of the tenth embodiment of the disclosure at the two selected coordinate values on the XY plane.

In addition, the relationships between important parameters of the optical imaging lens 10 in the eleventh embodiment is shown in FIG. 76.

Longitudinal spherical aberrations of the eleventh embodiment are shown in FIG. 48A, and imaging point deviations of off-axis rays at different heights are controlled within a range of ±0.025 mm. In two field curvature aberration diagrams of FIG. 48B and FIG. 48C, focal length variations of three representative wavelengths in an entire field of view fall within a range of ±0.05 mm. A distortion aberration diagram of FIG. 48D shows that distortion aberrations of the tenth embodiment are retained within a range of ±3%.

Based on the above, it can be seen that the TTL in the eleventh embodiment is smaller than the TTL in the tenth embodiment, and the distortion aberration in the eleventh embodiment is smaller than the distortion aberration in the tenth embodiment.

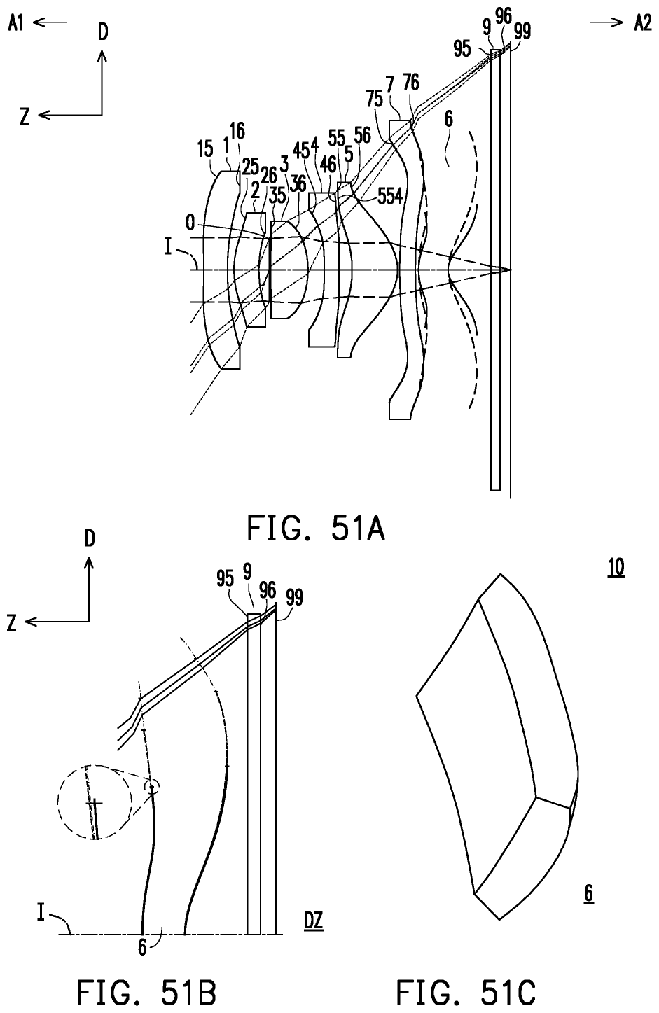

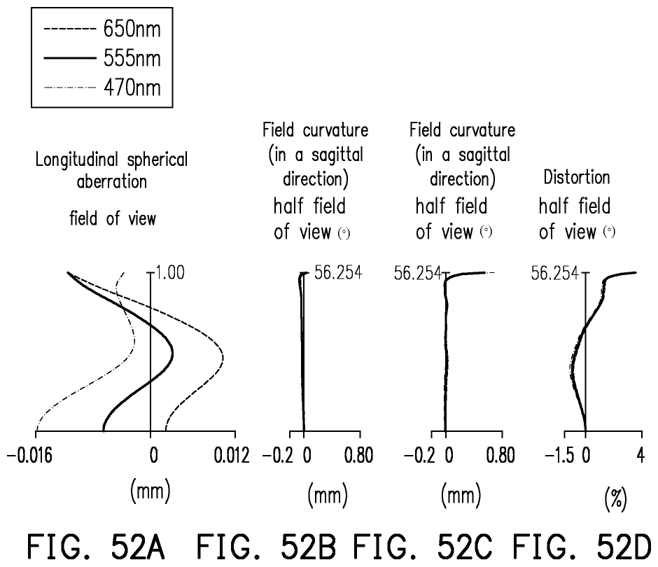

FIG. 51A is a schematic diagram of an optical imaging lens according to a twelfth embodiment of the disclosure. FIG. 51B is an enlarged radial cross-sectional view of the sixth lens element of FIG. 51A crossed by different planes. FIG. 51C is a schematic diagram of the appearance of the sixth lens element of FIG. 51A. FIG. 52A to FIG. 52D are diagrams of longitudinal spherical aberrations and astigmatic aberrations of the optical imaging lens according to the twelfth embodiment. Referring to FIG. 51A to FIG. 51C, first, the twelfth embodiment of the optical imaging lens 10 of the disclosure is basically similar to the tenth embodiment, which differs as follows: optical data, aspheric surface coefficients, and parameters between the lens elements 1, 2, 3, 4, 5, 6 and 7 are different to some extent. In addition, in the present embodiment, a periphery region 554 of the object-side surface 55 of the fifth lens element 5 is concave. Herein, it should be noted that, for clearly presenting the diagram, reference numbers of optical axis regions and periphery regions with surface structures similar to that of in the tenth embodiment are omitted in FIG. 51A and FIG. 51B.

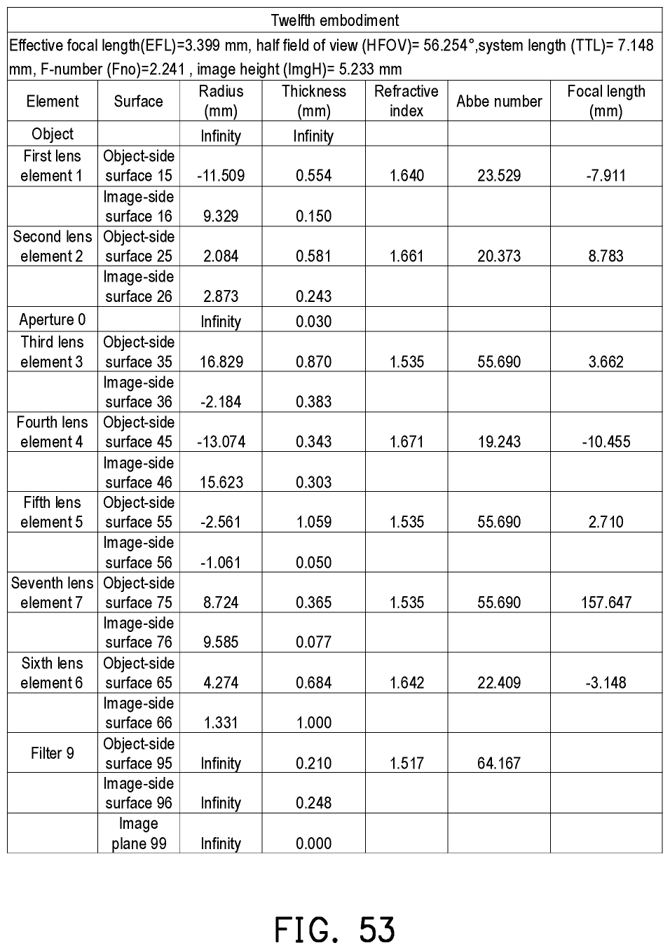

Detailed optical data of the optical imaging lens 10 in the twelfth embodiment is shown in FIG. 53, and the optical imaging lens 10 in the seventeenth embodiment has an EFL of 3.399 mm, an HFOV of 56.254°, a Fno of 2.241, a TTL 7.148 mm, and an image height of 5.233 mm.

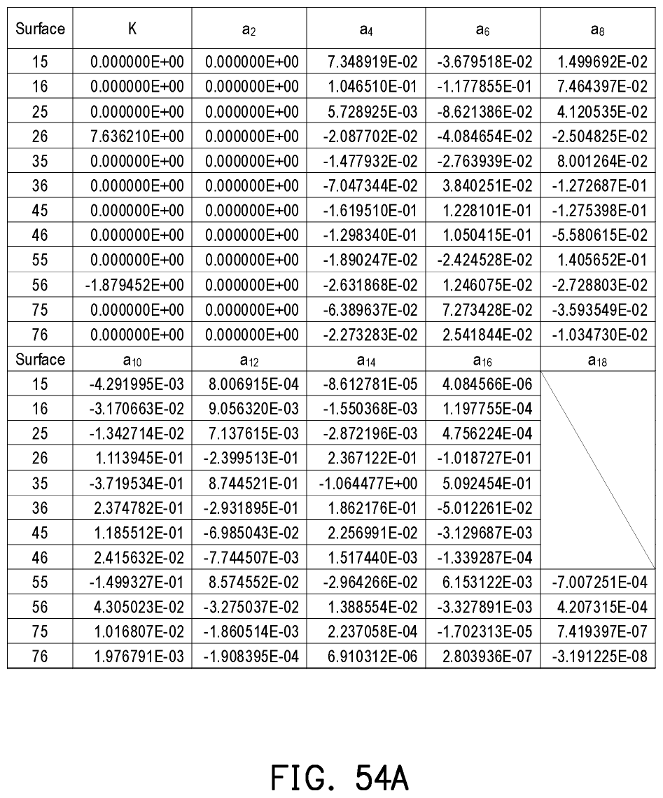

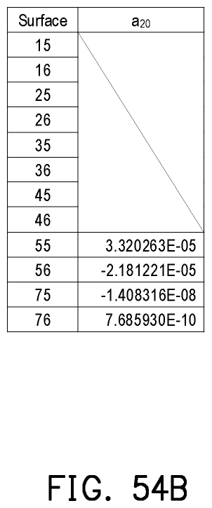

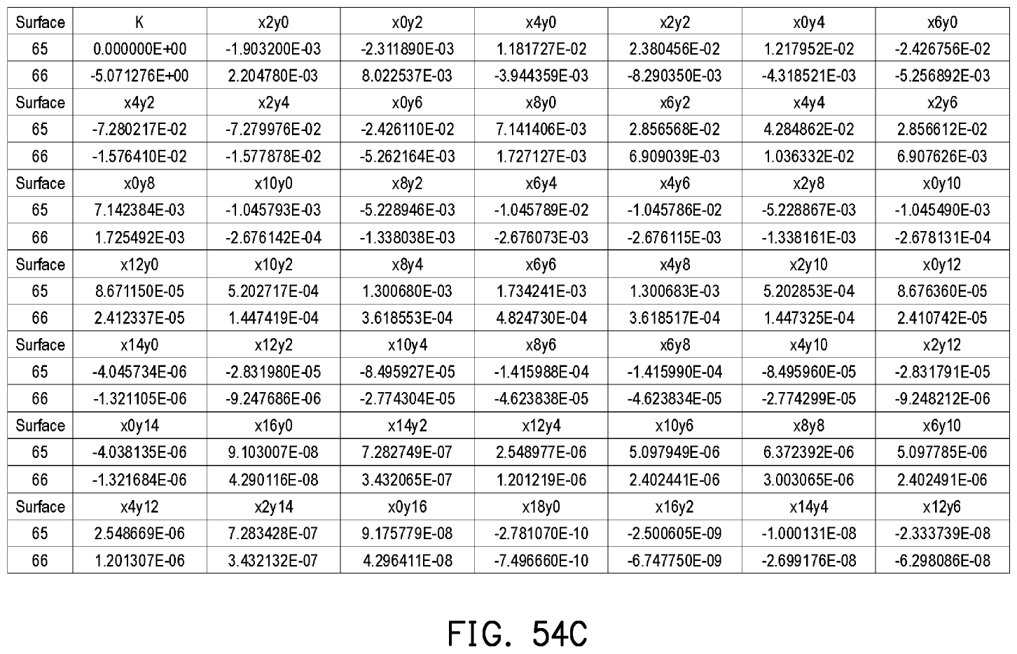

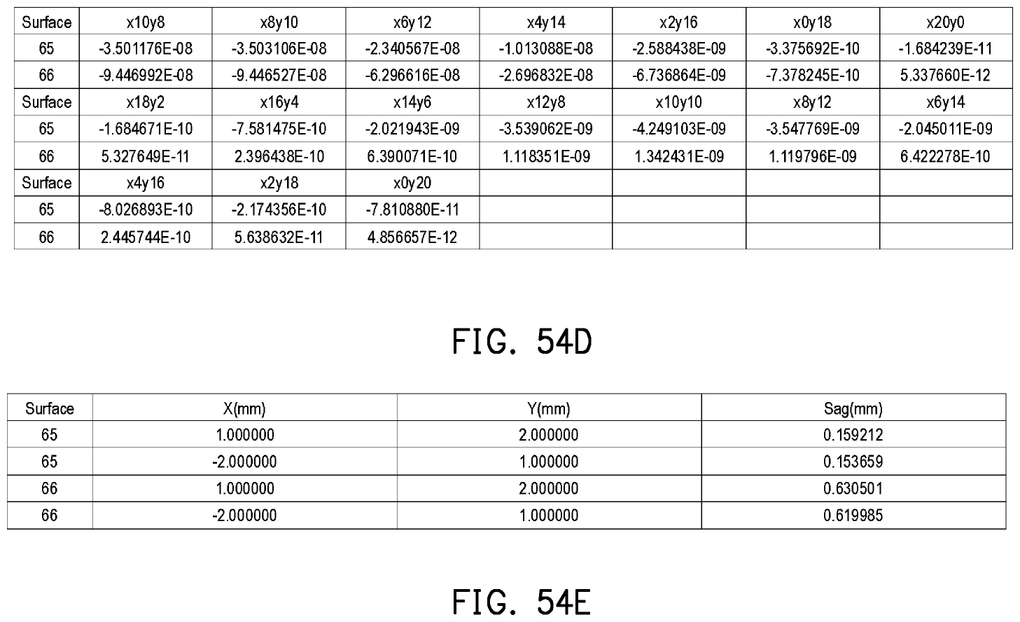

Aspheric surface coefficients of the object-side surface 15 of the first lens element 1 to the image-side surface 56 of the fifth lens element 5 and the object-side surface 75 of the seventh lens element 7 to the image-side surface 86 of the eighth lens element 8 in the twelfth embodiment in Formula (1) are shown in FIG. 54A and FIG. 54B. Coefficients of each term of the X^{m}Yⁿ of the object-side surface 65 and the image-side surface 66 of the sixth lens element 6 in the tenth embodiment in Formula (2) are shown in FIG. 54C and FIG. 54D. FIG. 54E shows the corresponding Sag values of the sixth lens element of the twelfth embodiment of the disclosure at the two selected coordinate values on the XY plane.

In addition, the relationships between important parameters of the optical imaging lens 10 in the twelfth embodiment is shown in FIG. 76.

Longitudinal spherical aberrations of the twelfth embodiment are shown in FIG. 52A, and imaging point deviations of off-axis rays at different heights are controlled within a range of ±0.016 mm. In two field curvature aberration diagrams of FIG. 52B and FIG. 52C, focal length variations of three representative wavelengths in an entire field of view fall within a range of ±0.08 mm. A distortion aberration diagram of FIG. 52D shows that distortion aberrations of the twelfth embodiment are retained within a range of ±4%.

Based on the above, it can be seen that the TTL in the twelfth embodiment is smaller than the TTL in the tenth embodiment, the longitudinal spherical aberration in the twelfth embodiment is smaller than the longitudinal spherical aberration in the tenth embodiment, and the distortion aberration in the twelfth embodiment is smaller than the distortion aberration in the tenth embodiment.

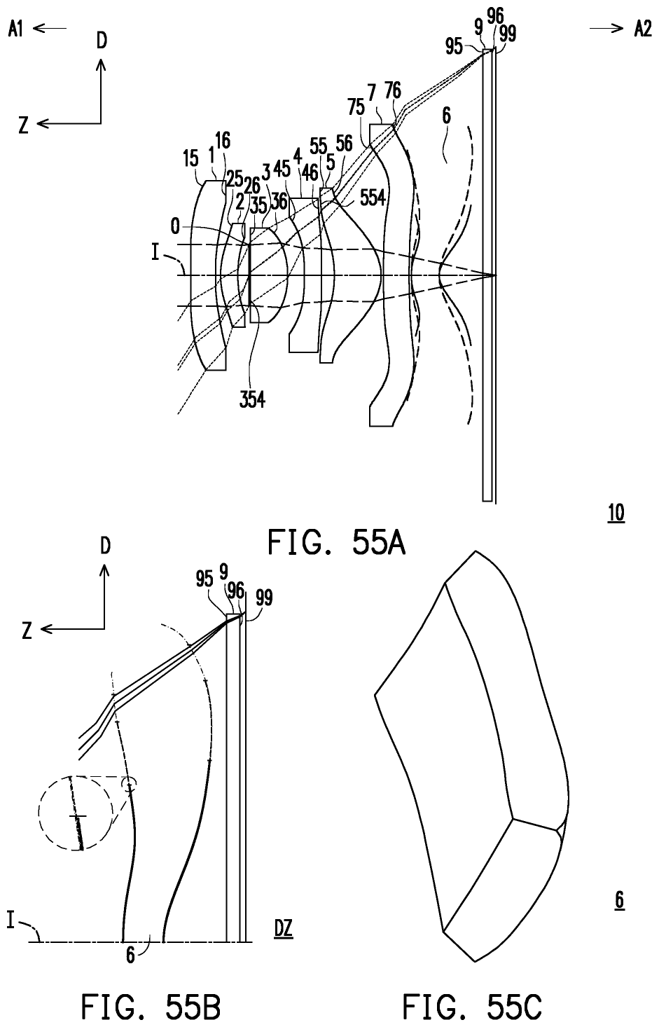

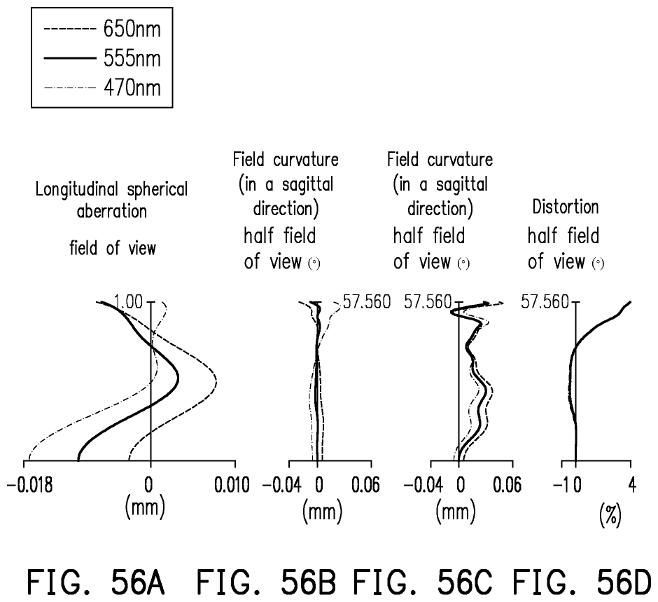

FIG. 55A is a schematic diagram of an optical imaging lens according to a thirteenth embodiment of the disclosure. FIG. 55B is an enlarged radial cross-sectional view of the sixth lens element of FIG. 55A crossed by different planes. FIG. 55C is a schematic diagram of the appearance of the sixth lens element of FIG. 55A. FIG. 56A to FIG. 56D are diagrams of longitudinal spherical aberrations and astigmatic aberrations of the optical imaging lens according to the thirteenth embodiment. Referring to FIG. 55A to FIG. 55C, first, the thirteenth embodiment of the optical imaging lens 10 of the disclosure is basically similar to the tenth embodiment, which differs as follows: optical data, aspheric surface coefficients, and parameters between the lens elements 1, 2, 3, 4, 5, 6 and 7 are different to some extent. In addition, in the present embodiment, a periphery region 354 of the object-side surface 35 of the third lens element 3 is concave. A periphery region 554 of the object-side surface 55 of the fifth lens element 5 is concave. Herein, it should be noted that, for clearly presenting the diagram, reference numbers of optical axis regions and periphery regions with surface structures similar to that of in the tenth embodiment are omitted in FIG. 55A and FIG. 55B.

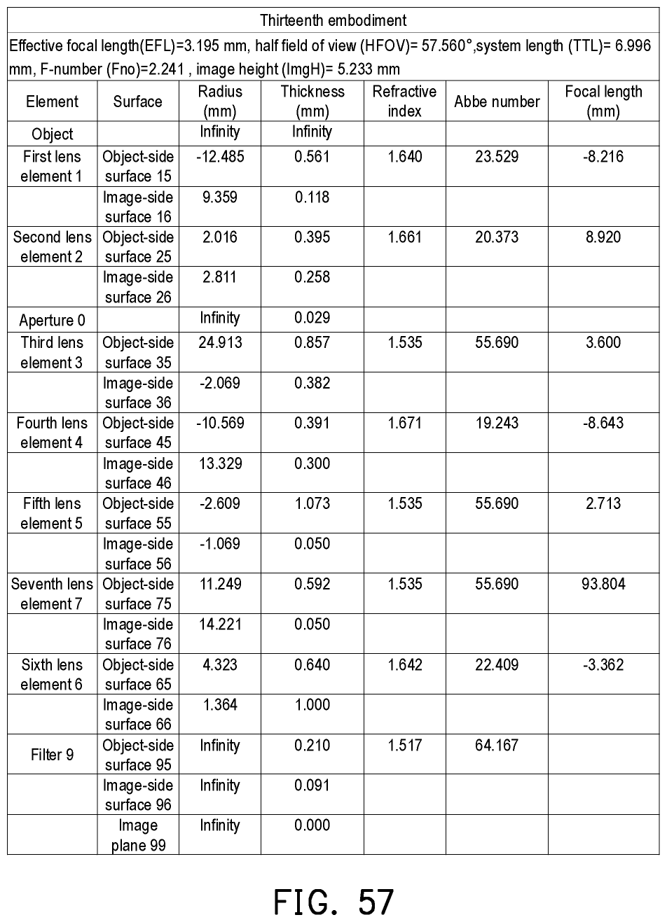

Detailed optical data of the optical imaging lens 10 in the thirteenth embodiment is shown in FIG. 57, and the optical imaging lens 10 in the seventeenth embodiment has an EFL of 3.195 mm, an HFOV of 57.560°, a Fno of 2.241, a TTL of 6.996 mm, and an image height of 5.233 mm.

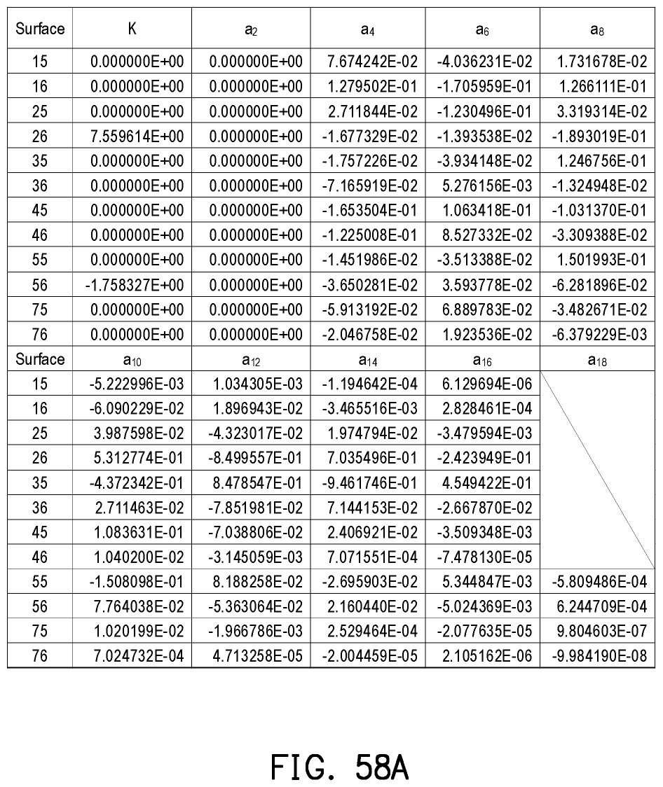

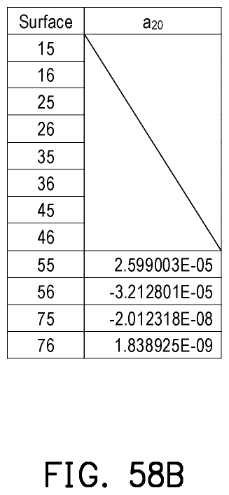

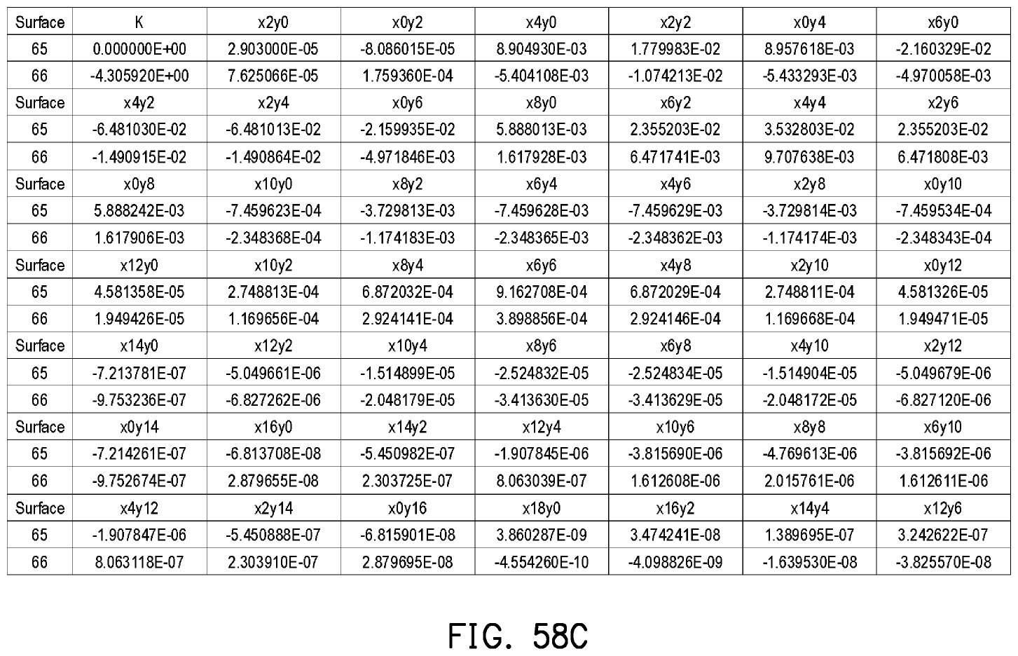

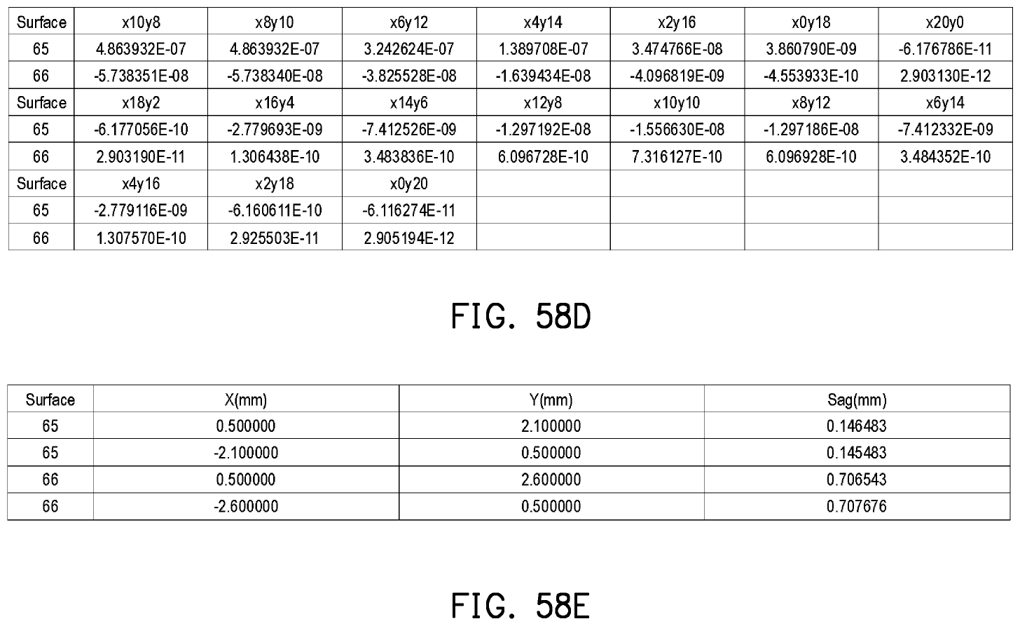

Aspheric surface coefficients of the object-side surface 15 of the first lens element 1 to the image-side surface 76 of the seventh lens element 7 in the eleventh embodiment in Formula (1) are shown in FIG. 58A and FIG. 58B. Coefficients of each term of the X^{m}Yⁿ of the object-side surface 65 and the image-side surface 66 of the sixth lens element 6 in the thirteenth embodiment in Formula (2) are shown in FIG. 58C and FIG. 58D. FIG. 58E shows the corresponding Sag values of the sixth lens element of the tenth embodiment of the disclosure at the two selected coordinate values on the XY plane.

In addition, the relationships between important parameters of the optical imaging lens 10 in the thirteenth embodiment is shown in FIG. 76.

Longitudinal spherical aberrations of the thirteenth embodiment are shown in FIG. 56A, and imaging point deviations of off-axis rays at different heights are controlled within a range of ±0.018 mm. In two field curvature aberration diagrams of FIG. 56B and FIG. 56C, focal length variations of three representative wavelengths in an entire field of view fall within a range of ±0.5 mm. A distortion aberration diagram of FIG. 56D shows that distortion aberrations of the tenth embodiment are retained within a range of ±4%.

Based on the above, it can be seen that the TTL in the thirteenth embodiment is smaller than the TTL in the tenth embodiment, the longitudinal spherical aberration in the thirteenth embodiment is smaller than the longitudinal spherical aberration in the tenth embodiment, and the distortion aberration in the thirteenth embodiment is smaller than the distortion aberration in the tenth embodiment.

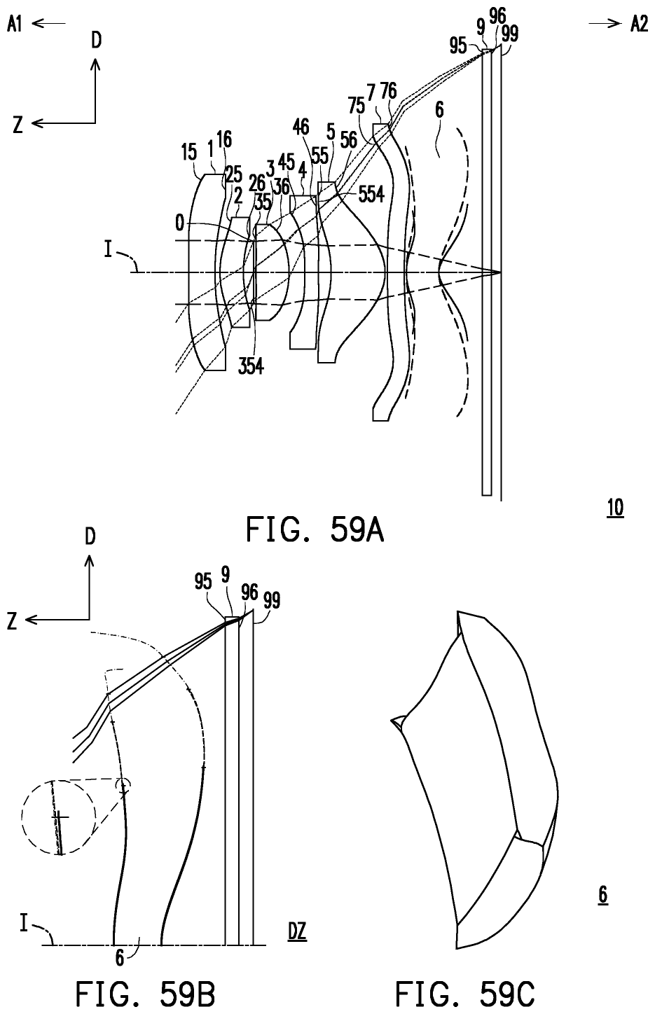

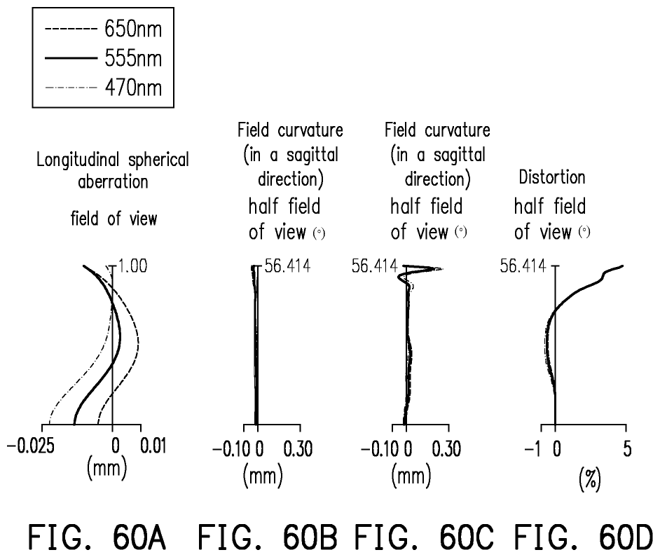

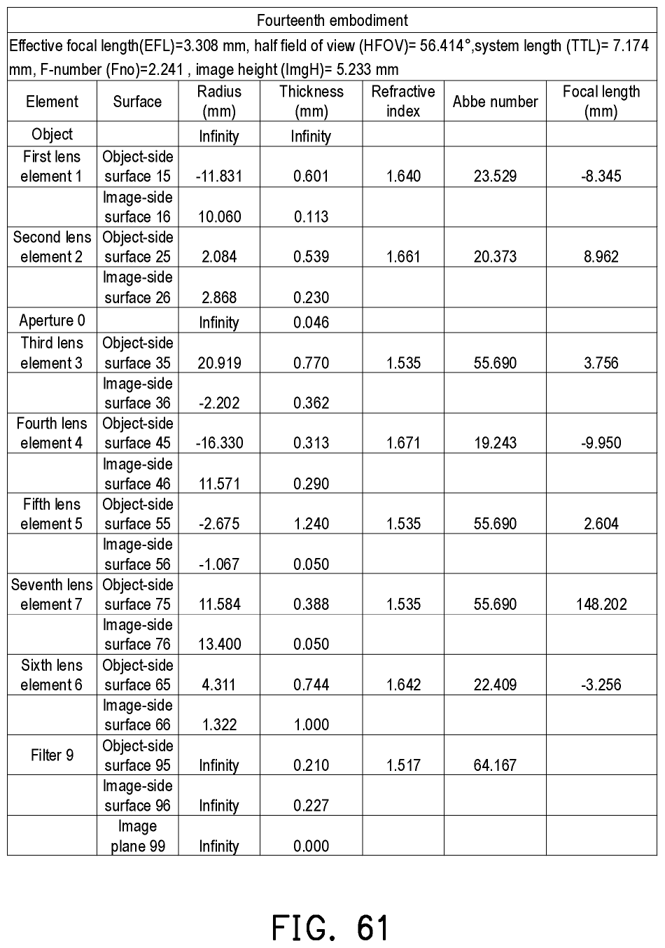

FIG. 59A is a schematic diagram of an optical imaging lens according to a fourteenth embodiment of the disclosure. FIG. 59B is an enlarged radial cross-sectional view of the sixth lens element of FIG. 59A crossed by different planes. FIG. 59C is a schematic diagram of the appearance of the sixth lens element of FIG. 59A. FIG. 60A to FIG. 60D are diagrams of longitudinal spherical aberrations and astigmatic aberrations of the optical imaging lens according to the fourteenth embodiment. Referring to FIG. 59A to FIG. 59C, first, the fourteenth embodiment of the optical imaging lens 10 of the disclosure is basically similar to the tenth embodiment, which differs as follows: optical data, aspheric surface coefficients, and parameters between the lens elements 1, 2, 3, 4, 5, 6, and 7 are different to some extent. In addition, in the present embodiment, the periphery region 354 of the object-side surface 35 of the third lens element 3 is concave. The periphery region 554 of the object-side surface 55 of the fifth lens element 5 is concave. Herein, it should be noted that, for clearly presenting the diagram, reference numbers of optical axis regions and periphery regions with surface structures similar to that of in the tenth embodiment are omitted in FIG. 59A and FIG. 59B.

Detailed optical data of the optical imaging lens 10 in the fourteenth embodiment is shown in FIG. 61, and the optical imaging lens 10 in the fourteenth embodiment has an EFL of 3.308 mm, an HFOV of 56.414°, a Fno of 5.233, a TTL of 7.174 mm, and an image height of 5.233 mm.

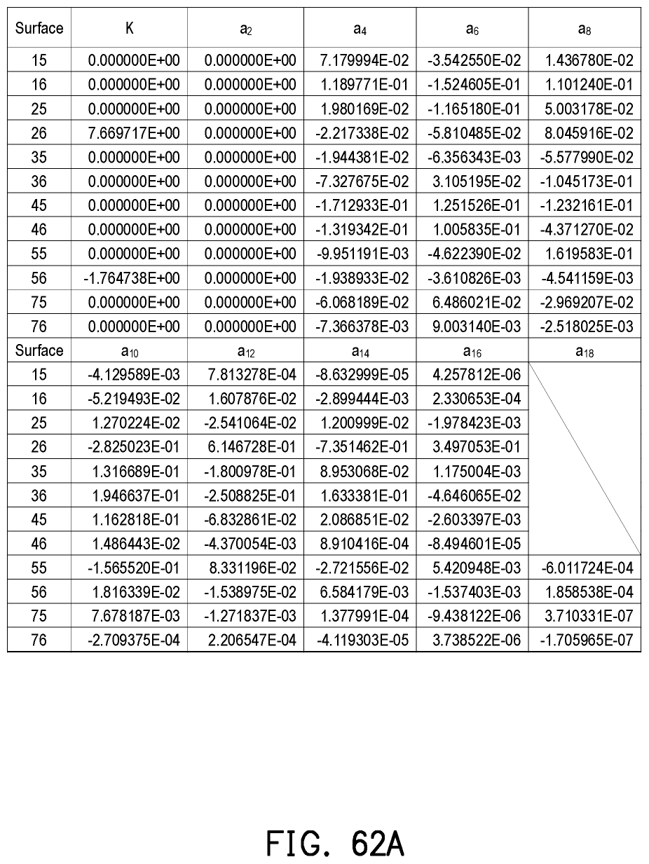

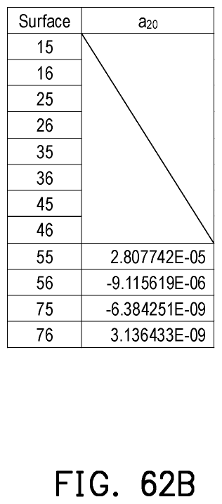

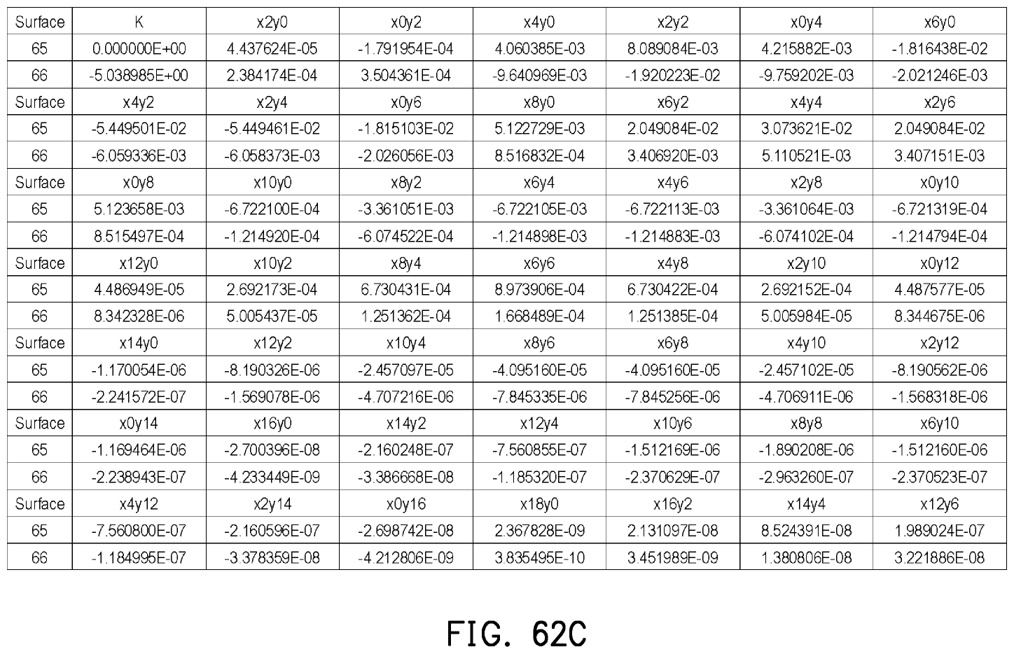

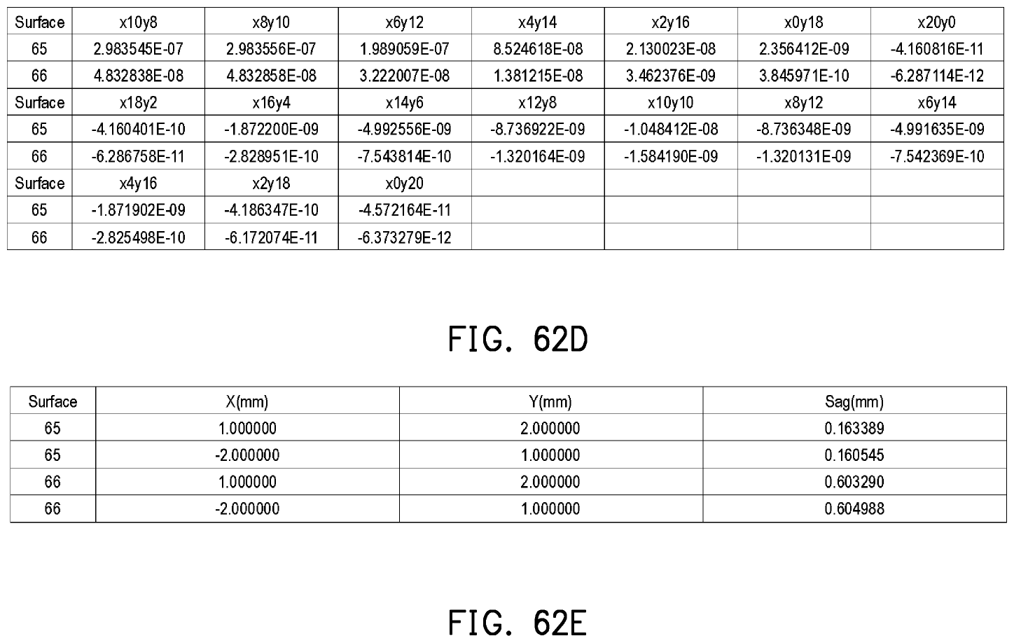

Aspheric surface coefficients of the object-side surface 15 of the first lens element 1 to the image-side surface 76 of the seventh lens element 7 in the eleventh embodiment in Formula (1) are shown in FIG. 62A and FIG. 62B. Coefficients of each term of the X^{m}Yⁿ of the object-side surface 65 and the image-side surface 66 of the sixth lens element 6 in the fourteenth embodiment in Formula (2) are shown in FIG. 62C and FIG. 62D. FIG. 62E shows the corresponding Sag values of the sixth lens element of the fourteenth embodiment of the disclosure at the two selected coordinate values on the XY plane.

In addition, the relationships between important parameters of the optical imaging lens 10 in the fourteenth embodiment is shown in FIG. 76.

Longitudinal spherical aberrations of the fourteenth embodiment are shown in FIG. 60A, and imaging point deviations of off-axis rays at different heights are controlled within a range of ±0.01 mm. In two field curvature aberration diagrams of FIG. 60B and FIG. 60C, focal length variations of three representative wavelengths in an entire field of view fall within a range of ±0.3 mm. A distortion aberration diagram of FIG. 60D shows that distortion aberrations of the tenth embodiment are retained within a range of ±5%.

Based on the above, it can be seen that the TTL in the fourteenth embodiment is smaller than the TTL in the tenth embodiment, longitudinal spherical aberration in the fourteenth embodiment is smaller than the longitudinal spherical aberration in the tenth embodiment.

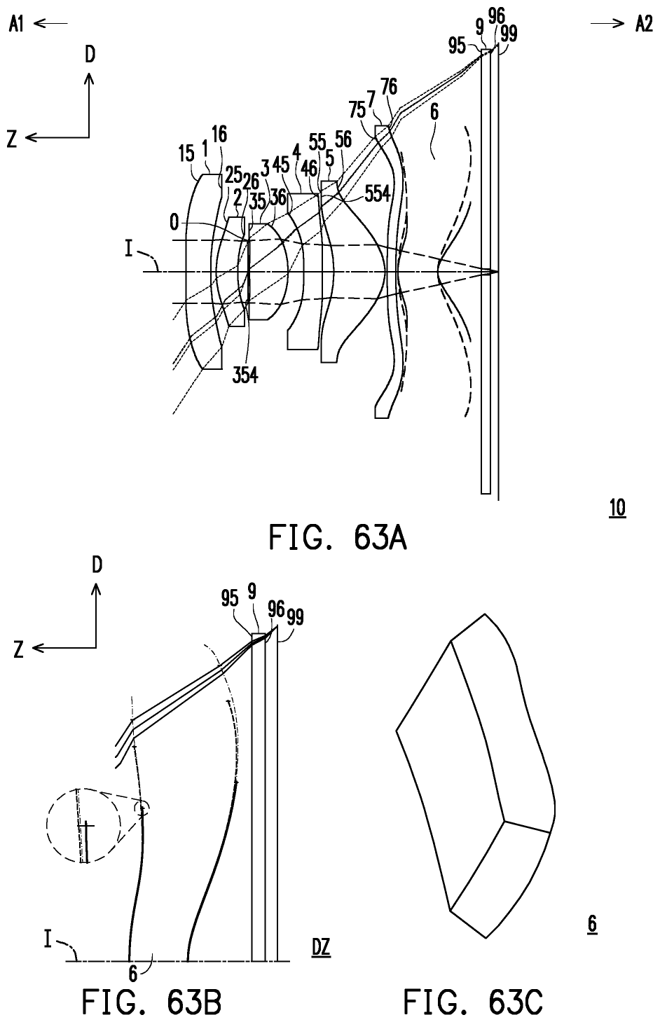

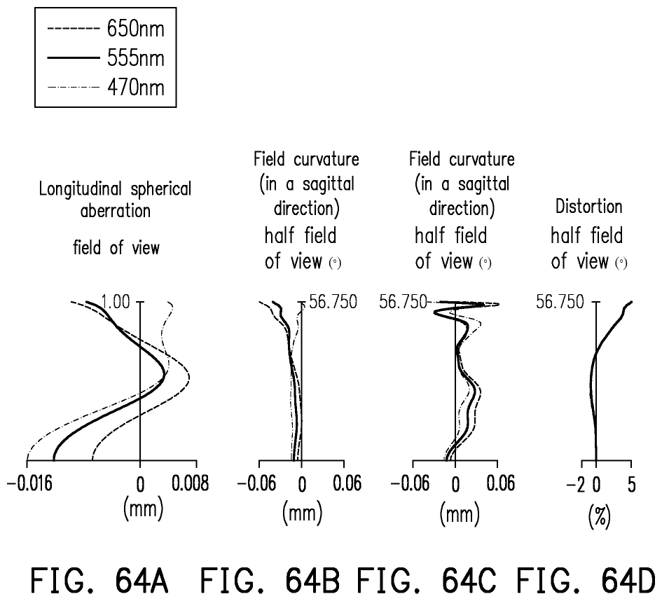

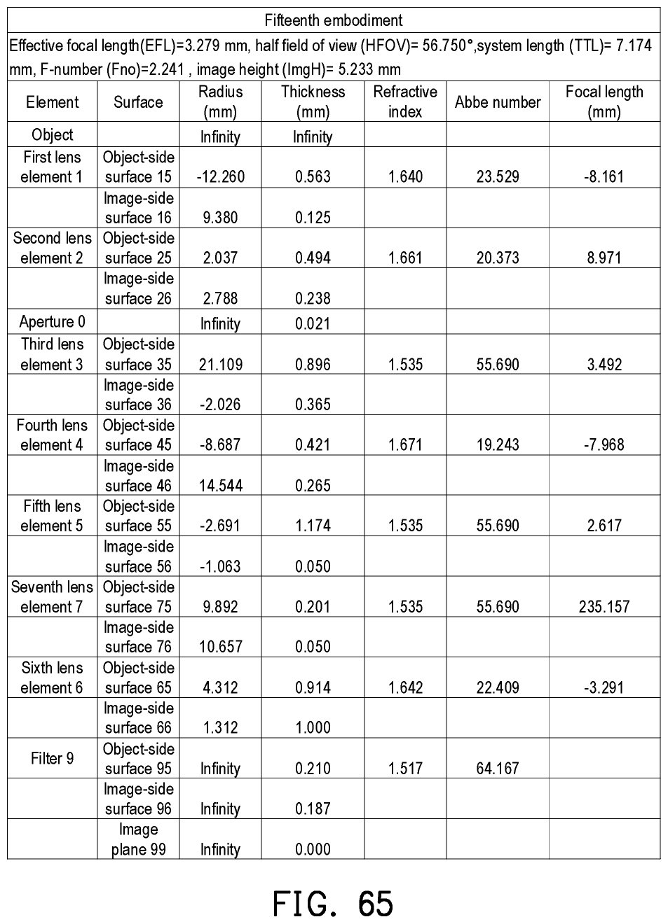

FIG. 63A is a schematic diagram of an optical imaging lens according to a fifteenth embodiment of the disclosure. FIG. 63B is an enlarged radial cross-sectional view of the sixth lens element of FIG. 63A crossed by different planes. FIG. 63C is a schematic diagram of the appearance of the sixth lens element of FIG. 63A. FIG. 64A to FIG. 64D are diagrams of longitudinal spherical aberrations and astigmatic aberrations of the optical imaging lens according to the fifteenth embodiment. Referring to FIG. 63A to FIG. 63C, first, the fifteenth embodiment of the optical imaging lens 10 of the disclosure is basically similar to the tenth embodiment, which differs as follows: optical data, aspheric surface coefficients, and parameters between the lens elements 1, 2, 3, 4, 5, 6, and 7 are different to some extent. In addition, in the present embodiment, the periphery region 354 of the object-side surface 35 of the third lens element 3 is concave. The periphery region 554 of the object-side surface 55 of the fifth lens element 5 is concave. Herein, it should be noted that, for clearly presenting the diagram, reference numbers of optical axis regions and periphery regions with surface structures similar to that of in the tenth embodiment are omitted in FIG. 63A and FIG. 63B.

Detailed optical data of the optical imaging lens 10 in the fifteenth embodiment is shown in FIG. 65, and the optical imaging lens 10 in the fifteenth embodiment has an EFL of 3.279 mm, an HFOV of 56.750°, a Fno of 2.241, a TTL of 7.174 mm, and an image height of 5.233 mm.

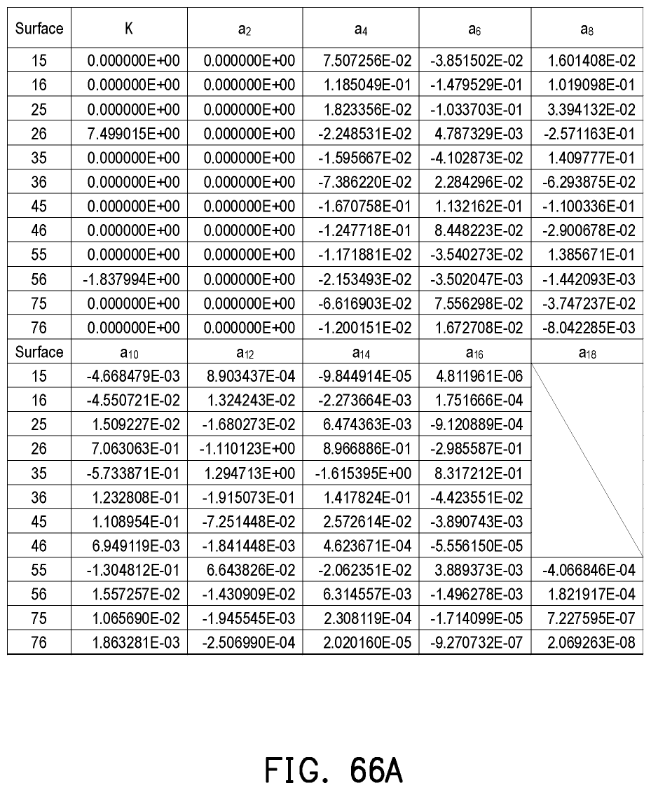

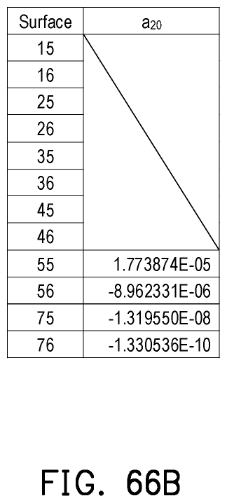

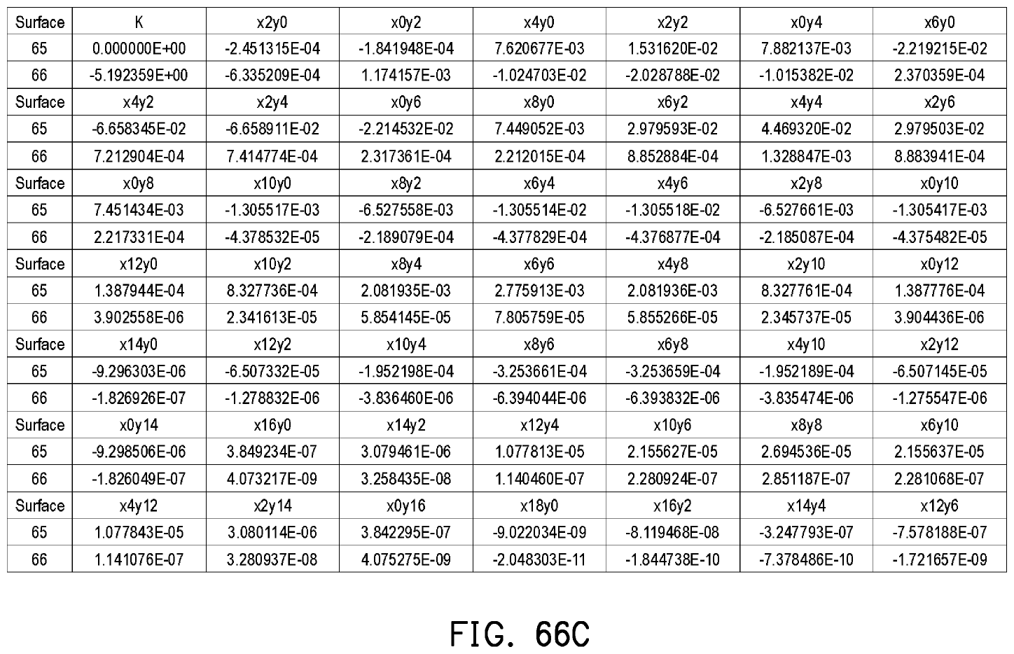

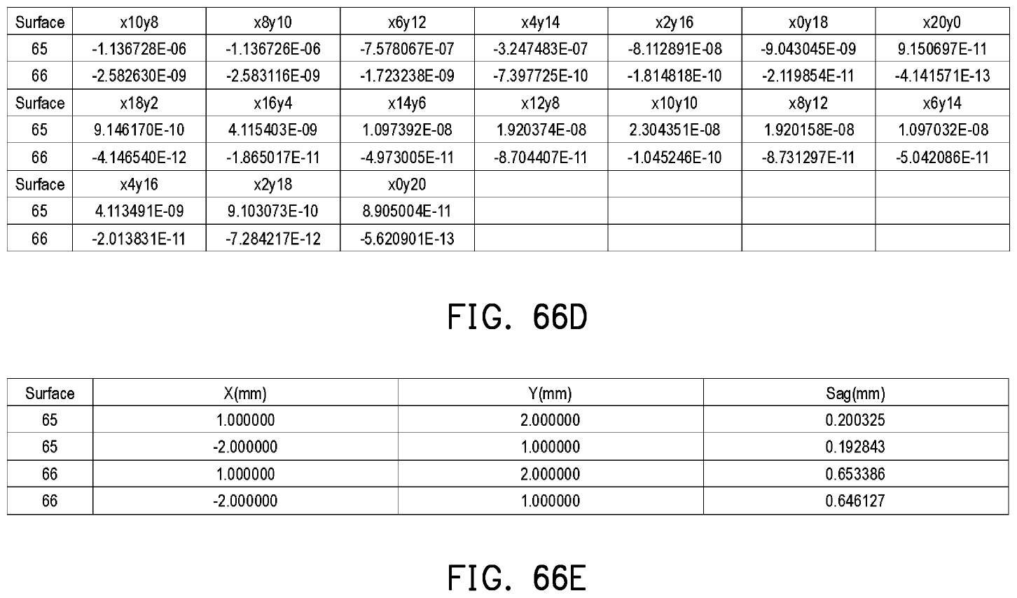

Aspheric surface coefficients of the object-side surface 15 of the first lens element 1 to the image-side surface 76 of the seventh lens element 7 in the eleventh embodiment in Formula (1) are shown in FIG. 66A and FIG. 66B. Coefficients of each term of the X^{m}Yⁿ of the object-side surface 65 and the image-side surface 66 of the sixth lens element 6 in the tenth embodiment in Formula (2) are shown in FIG. 66C and FIG. 66D. FIG. 66E shows the corresponding Sag values of the sixth lens element of the fifteenth embodiment of the disclosure at the two selected coordinate values on the XY plane.

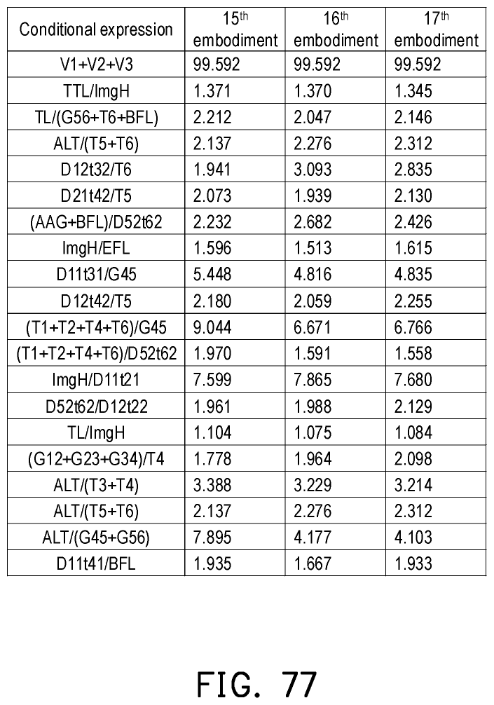

In addition, the relationships between important parameters of the optical imaging lens 10 in the fifteenth embodiment is shown in FIG. 77.

Longitudinal spherical aberrations of the fifteenth embodiment are shown in FIG. 64A, and imaging point deviations of off-axis rays at different heights are controlled within a range of ±0.016 mm. In two field curvature aberration diagrams of FIG. 64B and FIG. 64C, focal length variations of three representative wavelengths in an entire field of view fall within a range of ±0.06 mm. A distortion aberration diagram of FIG. 64D shows that distortion aberrations of the tenth embodiment are retained within a range of ±5%.

Based on the above, it can be seen that the TTL in the fifteenth embodiment is smaller than the TTL in the tenth embodiment, longitudinal spherical aberration in the fifteenth embodiment is smaller than the longitudinal spherical aberration in the tenth embodiment, and field curvature aberration in the fifteenth embodiment is smaller than the field curvature aberration in the tenth embodiment.

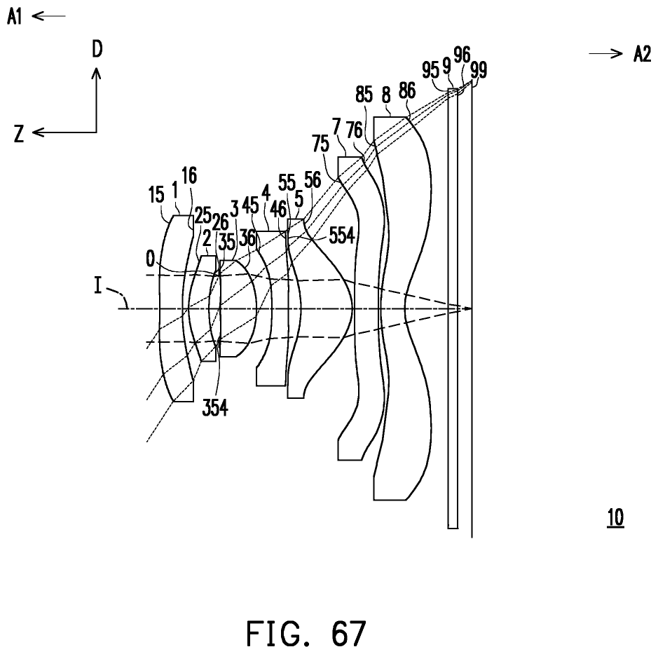

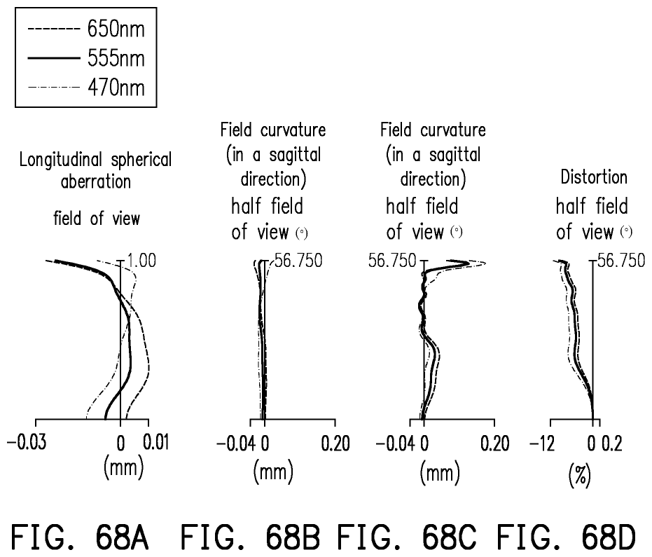

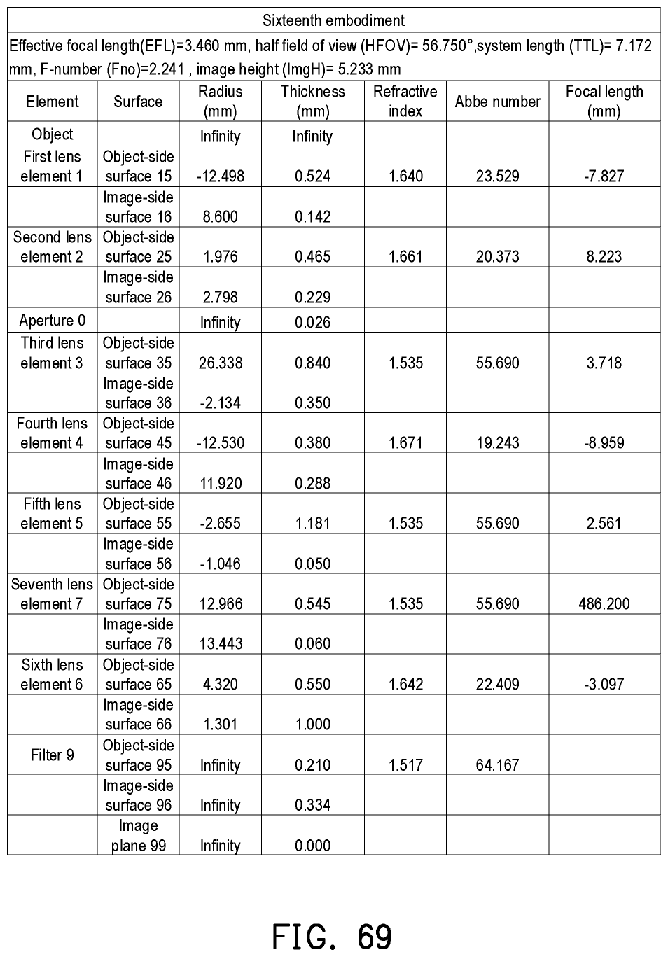

FIG. 67 is a schematic diagram of an optical imaging lens according to a sixteenth embodiment of the disclosure. FIG. 68A to FIG. 68D are diagrams of longitudinal spherical aberrations and astigmatic aberrations of the optical imaging lens according to the sixteenth embodiment. Referring to FIG. 67A to FIG. 67C, first, the sixteenth embodiment of the optical imaging lens 10 of the disclosure is basically similar to the tenth embodiment, which differs as follows: optical data, aspheric surface coefficients, and parameters between the lens elements 1, 2, 3, 4, 5, 6, and 7 are different to some extent. In addition, in the present embodiment, the periphery region 354 of the object-side surface 35 of the third lens element 3 is concave. The periphery region 554 of the object-side surface 55 of the fifth lens element 5 is concave. All of the lens elements in the sixteenth embodiment of the optical imaging lens 10 are aspherical lenses. Herein, it should be noted that, for clearly presenting the diagram, reference numbers of optical axis regions and periphery regions with surface structures similar to that of in the tenth embodiment are omitted in FIG. 67.

Detailed optical data of the optical imaging lens 10 in the sixteenth embodiment is shown in FIG. 69, and the optical imaging lens 10 in the sixteenth embodiment has an EFL of 3.460 mm, an HFOV of 56.750°, a Fno of 2.241, a TTL of 7.172 mm, and an image height of 5.233 mm.

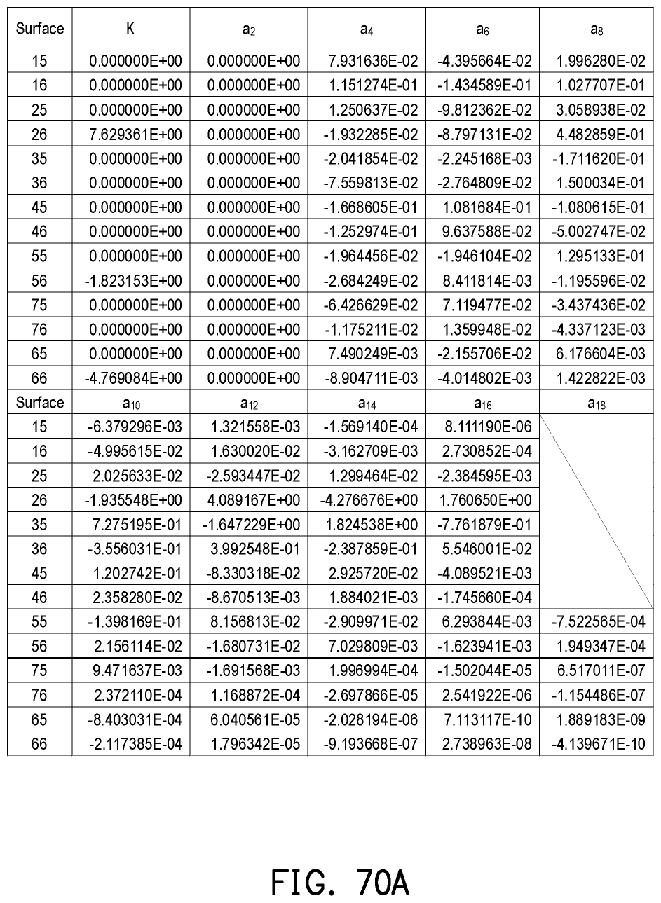

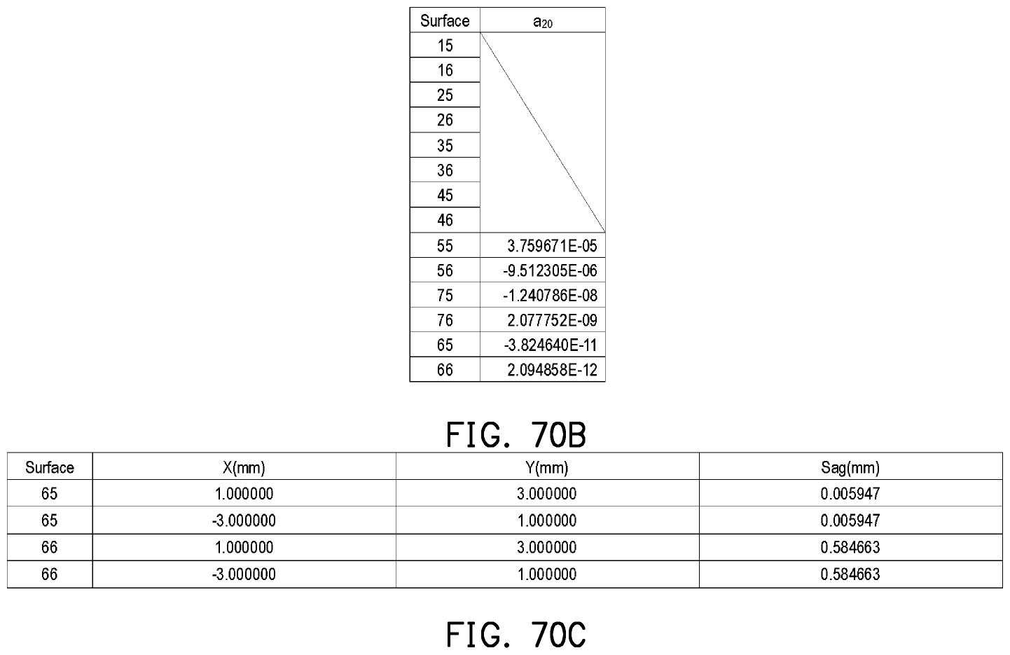

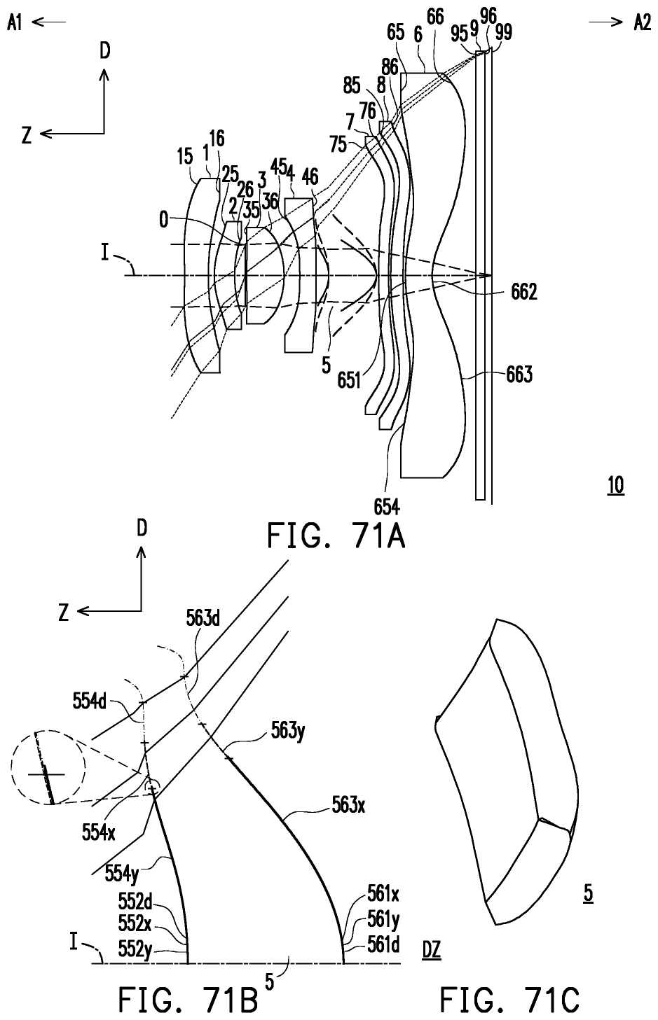

Aspheric surface coefficients of the object-side surface 15 of the first lens element 1 to the image-side surface 76 of the seventh lens element 7 in the sixteenth embodiment in Formula (1) are shown in FIG. 70A and FIG. 70B. FIG. 70C shows the corresponding Sag values of the sixth lens element of the sixteenth embodiment of the disclosure at the two selected coordinate values on the XY plane.

In addition, the relationships between important parameters of the optical imaging lens 10 in the sixteenth embodiment is shown in FIG. 77.

Longitudinal spherical aberrations of the sixteenth embodiment are shown in FIG. 68A, and imaging point deviations of off-axis rays at different heights are controlled within a range of ±0.03 mm. In two field curvature aberration diagrams of FIG. 68B and FIG. 68C, focal length variations of three representative wavelengths in an entire field of view fall within a range of ±0.18 mm. A distortion aberration diagram of FIG. 68D shows that distortion aberrations of the tenth embodiment are retained within a range of ±1.2%.

Based on the above, it can be seen that the TTL in the sixteenth embodiment is smaller than the TTL in the tenth embodiment, field curvature aberration in the sixteenth embodiment is smaller than the field curvature aberration in the tenth embodiment, and the distortion aberration in the sixteenth embodiment is smaller than the distortion aberration in the tenth embodiment.

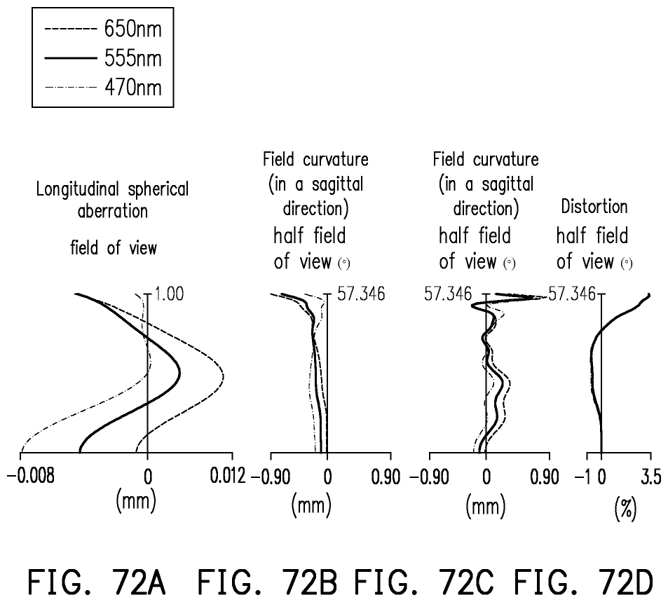

FIG. 71A is a schematic diagram of an optical imaging lens according to a seventeenth embodiment of the disclosure. FIG. 71B is an enlarged radial cross-sectional view of the fifth lens element of FIG. 71A crossed by different planes. FIG. 71C is a schematic diagram of the appearance of the fifth lens element of FIG. 71A. FIG. 72A to FIG. 72D are diagrams of longitudinal spherical aberrations and astigmatic aberrations of the optical imaging lens according to the seventeenth embodiment. Referring to FIG. 71A, an optical imaging lens 10 in the seventeenth embodiment of the disclosure sequentially includes a first lens element 1, a second lens element 2, an aperture 0, a third lens element 3, a fourth lens element 4, a fifth lens element 5, a seventh lens element 7, a eighth lens element 8, a sixth lens element 6, and a filter 9 from an object side A1 to an image side A2 along an optical axis I of the optical imaging lens 10. After entering the optical imaging lens 10, rays emitted from a to-be-photographed object pass through the first lens element 1, the second lens element 2, the aperture 0, the third lens element 3, the fourth lens element 4, the fifth lens element 5, the seventh lens element 7, the eighth lens element 8, the sixth lens element 6, and the filter 9, and form an image on an image plane 99. The filter 9 is disposed between an image-side surface 66 of the sixth lens element 6 and the image plane 99. It should be noted that, the object side is a side facing the to-be-photographed object, and the image side is a side facing the image plane 99. In the present embodiment, the filter 9 is an IR cut filter.

In the present embodiment, the eighth lens element 8 of the optical imaging lens 10 includes an object-side surfaces 85 facing the object side and allowing imaging rays to pass through and an image-side surfaces 86 facing the image side and allowing the imaging rays to pass through.

The difference in the surface structures of the lens element between the seventeenth embodiment and the first embodiment will be described in detail in the following paragraphs. For brevity, the reference numbers omitted are as that of shown in the first and tenth embodiment.

In the present embodiment, the fifth lens element 5 is a free-form lens element. Please refer to FIG. 71B, in the intersection curves of the object-side surface 55 and the image-side surface 56 of the fifth lens element 5 crossed by the first reference plane, an optical axis region 552x of the object-side surface 55 of the fifth lens element 5 is concave, and a periphery region 554x of the object-side surface 55 of the fifth lens element 5 is concave. An optical axis region 561x of the image-side surface 56 of the fifth lens element 5 is convex, and a periphery region 563x of the image-side surface 56 of the fifth lens element 5 is convex.

In the intersection curves of the object-side surface 55 and the image-side surface 56 of the fifth lens element 5 crossed by the second reference plane, an optical axis region 552y of the object-side surface 55 of the fifth lens element 5 is concave, and a periphery region 554y of the object-side surface 55 of the fifth lens element 5 is concave. An optical axis region 561y of the image-side surface 56 of the fifth lens element 5 is convex, and a periphery region 563y of the image-side surface 56 of the fifth lens element 5 is convex.

In the intersection curves of the object-side surface 55 and the image-side surface 56 of the fifth lens element 5 crossed by the third reference plane, an optical axis region 552d of the object-side surface 55 of the fifth lens element 5 is concave, and a periphery region 554d of the object-side surface 55 of the fifth lens element 5 is concave. An optical axis region 561d of the image-side surface 56 of the fifth lens element 5 is convex, and a periphery region 563d of the image-side surface 56 of the fifth lens element 5 is convex.

The sixth lens element 6 is aspherical lens. An optical axis region 651 of the object-side surface 65 of the sixth lens element 6 is convex, and a periphery region 654 of the object-side surface 65 of the sixth lens element 6 is concave. An optical axis region 662 of the image-side surface 66 of the sixth lens element 6 is concave, and a periphery region 663 of the image-side surface 66 of the sixth lens element 6 is convex.

The eighth lens element 8 has positive refracting power. The eighth lens element 8 is made from a plastic material. An optical axis region 851 of the object-side surface 85 of the eighth lens element 8 is convex, and a periphery region 854 of the object-side surface 85 of the eighth lens element 8 is concave. An optical axis region 862 of the image-side surface 86 of the eighth lens element 8 is concave, and a periphery region 863 of the image-side surface 86 of the eighth lens element 8 is convex. In the present embodiment, both the object-side surface 85 and the image-side surface 86 of the eighth lens element 8 are aspheric surfaces.

In the present embodiment, only the above eight lens elements of the optical imaging lens 10 have refracting power.

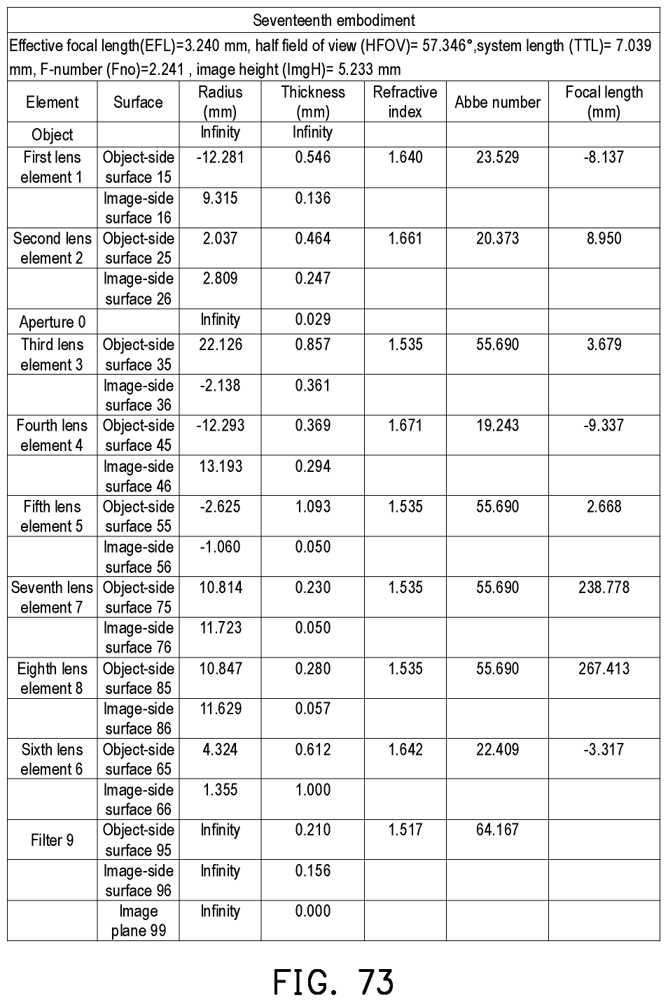

Detailed optical data of the optical imaging lens 10 in the seventeenth embodiment is shown in FIG. 73, and the optical imaging lens 10 in the seventeenth embodiment has an EFL of 3.240 mm, an HFOV of 57.346°, a Fno of 2.241, a TTL of 7.039 mm, and an image height of 5.233 mm.

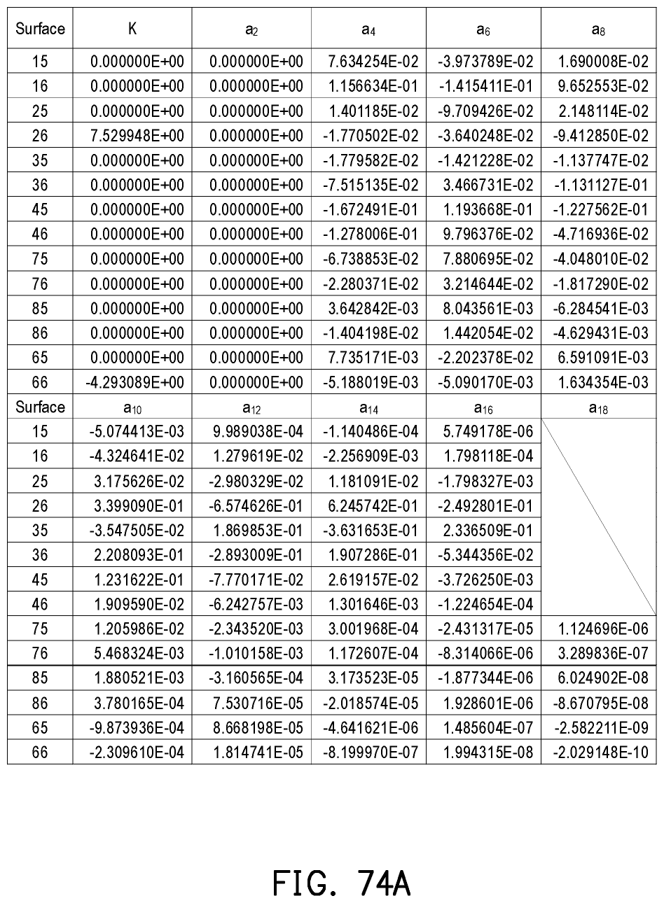

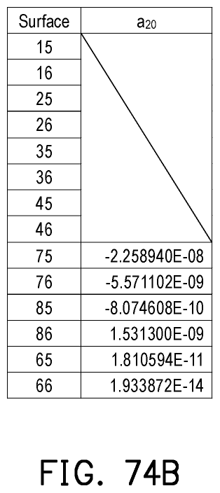

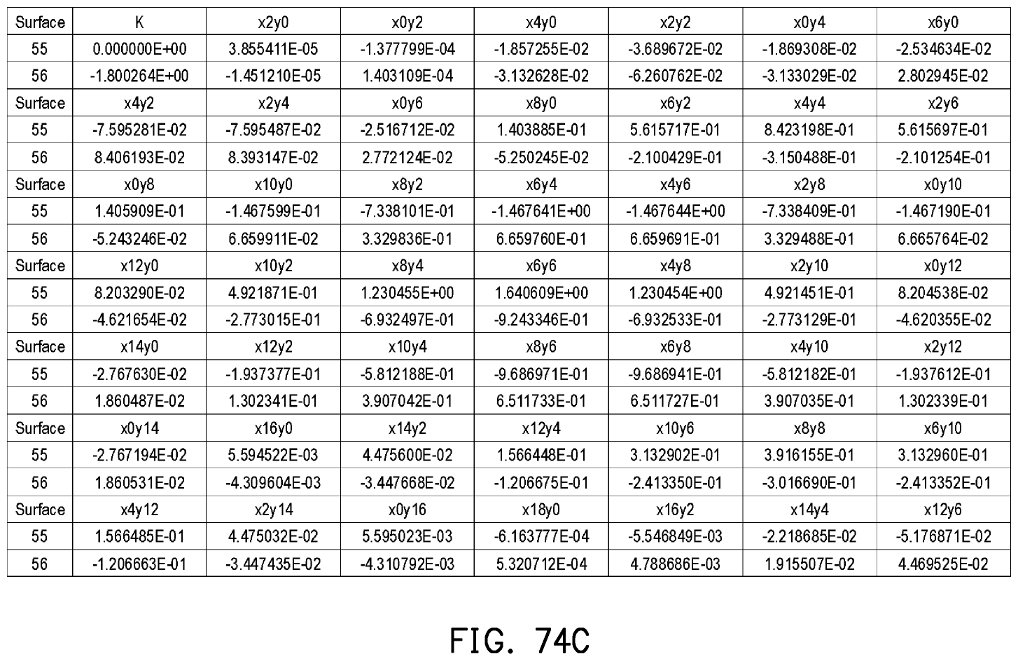

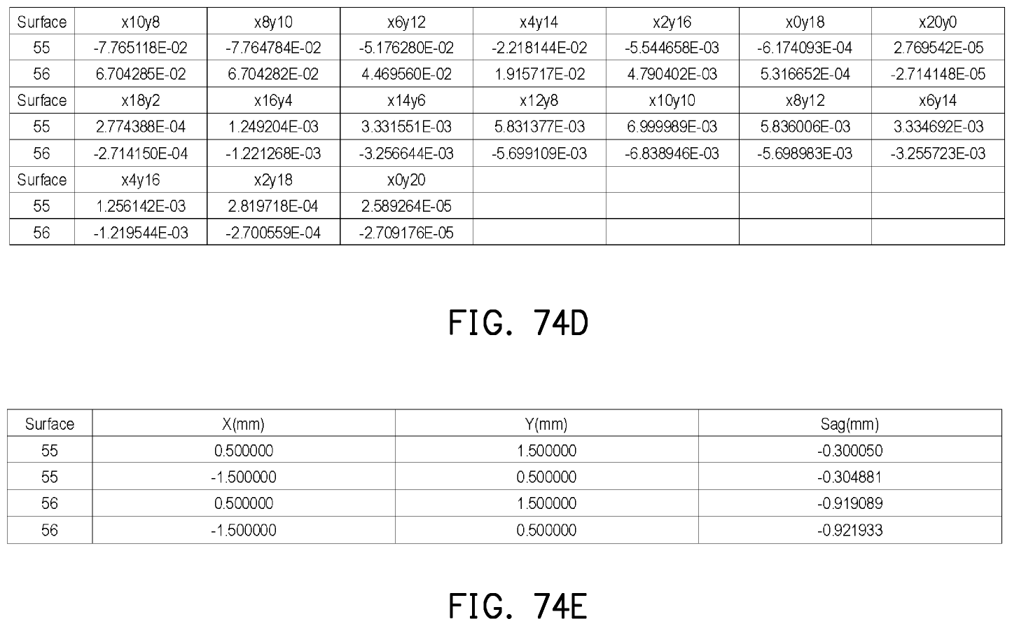

Aspheric surface coefficients of the object-side surface 15 of the first lens element 1 to the image-side surface 86 of the eighth lens element 8 in the seventeenth embodiment in Formula (1) are shown in FIG. 74A and FIG. 74B.

Coefficients of each term of the X^{m}Yⁿ of the object-side surface 65 and the image-side surface 66 of the sixth lens element 6 in the seventeenth embodiment in Formula (2) are shown in FIG. 74C and FIG. 74D. FIG. 74E shows the corresponding Sag values of the sixth lens element of the seventeenth embodiment of the disclosure at the two selected coordinate values on the XY plane.

In addition, the relationships between important parameters of the optical imaging lens 10 in the seventeenth embodiment is shown in FIG. 77.

Wherein, it is defined:

T8 is a thickness of the eighth lens element 8 along the optical axis I;

G78 is a distance from the image-side surface 76 of the seventh lens element 7 to the object-side surface 85 of the eighth lens element 8 along the optical axis I;

G86 is a distance from the image-side surface 86 of the eighth lens element 8 to the object-side surface 65 of the sixth lens element 6 along the optical axis I;

In addition, it is defined:

f8 is a focal length of the eighth lens element 8;

n8 is a refractive index of the eighth lens element 8; and

V8 is an Abbe number of the eighth lens element 8.

Further referring to FIG. 72A to FIG. 72D, FIG. 72A illustrates longitudinal spherical aberrations according to the seventeenth embodiment, FIG. 72B and FIG. 72C respectively illustrate field curvature aberrations in a sagittal direction and field curvature aberrations in a tangential direction on the image plane 99 in cases of wavelengths 470 nm, 555 nm, and 650 nm according to the seventeenth embodiment. The longitudinal spherical aberrations of the seventeenth embodiment are shown in FIG. 72A, and curves of all the wavelengths are quite close to each other and approach the middle. It indicates that off-axis rays of all the wavelengths at different heights are focused near an imaging point. From deflection amplitude of the curves of all the wavelengths, it can be seen that imaging point deviations of the off-axis rays at different heights are controlled within a range of ±0.018 mm. Therefore, a spherical aberration of a same wavelength is definitely reduced in the seventeenth embodiment. In addition, the three representative wavelengths are also quite close to each other. It indicates that imaging positions of rays of different wavelengths are quite focused. Therefore, chromatic and astigmatic aberrations are also definitely reduced.

In the two field curvature aberration diagrams of FIG. 72B and FIG. 72C, focal length variations of the three representative wavelengths in an entire field of view fall within a range of ±0.09 mm. It indicates that astigmatic aberrations can be effectively eliminated by the optical system in the seventeenth embodiment. The distortion aberration diagram of FIG. 72D shows that the distortion aberrations of the seventeenth embodiment are retained within a range of ±3.5%. It indicates that the distortion aberrations of the seventeenth embodiment satisfy an imaging quality requirement of the optical system. To be specific, different from an existing optical lens, the first embodiment can still provide desired imaging quality when the TTL is reduced to approximately 7.039 mm. Therefore, the seventeenth embodiment can have a shorter length and achieve desired imaging quality while maintaining desired optical properties.

Further refer to FIG. 75 to FIG. 77, which are table diagrams of optical parameters in the first embodiment to the seventeenth embodiment.

The optical imaging lens of the disclosure further satisfies the conditional expression: 1.400≤ImgH/EFL for the ratio of the parameter of the optical element to the length of the optical imaging lens 10 being maintained to be within an appropriate range to avoid that any one of the parameter of the optical element is too large and consequently causes the aberration of the whole the optical imaging system not easily to be corrected, or to avoid that any one of the parameter of the optical element is too small for the optical element to be produced, or prevent the assembly from being affected or the manufacturing difficulty from increased by the any overly small parameter. Wherein, a preferable range is 1.400≤ImgH/EFL≤1.800.

The optical imaging lens of the disclosure further satisfies the following conditional expressions for maintaining the thicknesses of and gaps between the respective lens elements at appropriate values to prevent any of the parameters from being excessively great and thus making it difficult to miniaturize the whole optical imaging lens or prevent any of the parameters from being excessively small and thus influencing assembling or increasing the manufacturing difficulty.

The optical imaging lens 10 may satisfy the following conditional expression: TTL/ImgH≤1.500, and more preferably may satisfy: 1.000≤TTL/ImgH≤1.500.

The optical imaging lens 10 may satisfy the following conditional expression: TL/(G56+T6+BFL)≤3.100, and more preferably may satisfy: 1.800≤TL/(G56+T6+BFL)≤3.100.

The optical imaging lens 10 may satisfy the following conditional expression: ALT/(T5+T6)≤2.800, and more preferably may satisfy: 1.700≤ALT/(T5+T6)≤2.800.

The optical imaging lens 10 may satisfy the following conditional expression: D12t32/T6≤3.600, and more preferably may satisfy: 1.500≤D12t32/T6≤3.600.

The optical imaging lens 10 may satisfy the following conditional expression: D21t42/T5≤2.800, and more preferably may satisfy: 1.100≤D21t42/T≤2.800.

The optical imaging lens 10 may satisfy the following conditional expression: (AAG+BFL)/D52t62≤3.500, and more preferably may satisfy: 2.000≤(AAG+BFL)/D52t62≤3.500.

The optical imaging lens 10 may satisfy the following conditional expression: D11t31/G45≤8.000, and more preferably may satisfy: 1.400≤D11t31/G45≤8.000.

The optical imaging lens 10 may satisfy the following conditional expression: D12t42/T5≤4.000, and more preferably may satisfy: 1.100≤D12t42/T5≤4.000.

The optical imaging lens 10 may satisfy the following conditional expression: (T1+T2+T4+T6)/G4≤8.000, and more preferably may satisfy: 2.000≤(T1+T2+T4+T6)/G45≤8.000.

The optical imaging lens 10 may satisfy the following conditional expression: (T1+T2+T4+T6)/D52t62≤3.000, and more preferably may satisfy: 1.200≤(T1+T2+T4+T6)/D52t62≤3.000.

The optical imaging lens 10 may satisfy the following conditional expression: TL/ImgH≤1.200, and more preferably may satisfy: 0.800≤TL/ImgH≤1.200.

The optical imaging lens 10 may satisfy the following conditional expression: (G12+G23+G34)/T4≤2.400, and more preferably may satisfy: 0.500≤(G12+G23+G34)/T4≤2.400.

The optical imaging lens 10 may satisfy the following conditional expression: ALT/(T3+T4)≤3.900, and more preferably may satisfy: 2.100≤ALT/(T3+T4)≤3.900.

The optical imaging lens 10 may satisfy the following conditional expression: ALT/(T5+T6)≤2.500, and more preferably may satisfy: 1.500≤ALT/(T5+T6)≤2.500.

The optical imaging lens 10 may satisfy the following conditional expression: ALT/(G45+G56)≤7.900, and more preferably may satisfy: 2.900≤ALT/(G45+G56)≤7.900.

The optical imaging lens 10 may satisfy the following conditional expression: D11t41/BFL≤2.000, and more preferably may satisfy: 1.200≤D11t41/BFL≤2.000.

In addition, it is optional to select a random combination relationship of the parameters in the embodiment to limit the optical system to further the design of the optical system having the same structure in the present disclosure. Due to the unpredictability of the design of an optical system, with the framework set forth in the embodiments of the disclosure, the optical imaging lens satisfying said conditions can be characterized by the reduced system length, the enlarged available aperture, the improved imaging quality, or the improved assembly yield, such that the shortcomings described in the related art can be better prevented.

The aforementioned limitation relations are provided in an exemplary sense and can be randomly and selectively combined and applied to the embodiments of the disclosure in different manners; the disclosure should not be limited to the above examples. In implementation of the disclosure, apart from the above-described relations, it is also possible to add additional detailed structure such as more concave and convex curvatures arrangement of a specific lens element or a plurality of lens elements so as to enhance control of system property and/or resolution. It should be noted that the above-described details can be optionally combined and applied to the other embodiments of the disclosure under the condition where they are not in conflict with one another.

Based on the above, the optical imaging lens 10 in the embodiments of the disclosure can achieve the following effects and advantages:

i. The longitudinal spherical aberrations, the astigmatic aberrations, and the distortion aberrations of the respective embodiments of the present disclosure meet the protocol of use. In addition, the off-axis rays of the three representing wavelengths, i.e., red, green, and blue, in different heights are all concentrated at a vicinity of the imaging point. The extents of deviation of the respective curves show that the imaging point deviations of the off-axis rays in different heights are controlled, so a desirable suppressing ability against spherical aberration, image aberration, and distortion aberration is rendered. The imaging quality data further suggest that the distances among the three representing wavelengths, i.e., red, green, and blue, are close to each other, indicating that the embodiments of the present disclosure are able to desirably concentrate rays of different wavelengths in various states and thus exhibit an excellent chromatic dispersion suppressing ability. Therefore, a desirable imaging quality is rendered.

ii. The optical imaging lens 10 in the embodiments of the disclosure may increase the image height, enlarge field of view angle and make the absolute value of the distortion being equal to or smaller than 5% at the same time, by designing the refracting power of the first lens element 1 as negative refracting power, designing a periphery region 264 of the image-side surface 26 of the second lens element 2 as concave, designing optical axis region 552 of the object-side surface 55 of the fifth lens element 5 as concave and operating together with the one of the following combinations (1)-(3).

(1) An optical axis region 361 of the image-side surface 36 of the third lens element 3 is convex, an optical axis region 462 of the image-side surface 46 of the fourth lens element 4 is concave, a periphery region 663 of the image-side surface 66 of the sixth lens element 6 is convex and the optical imaging lens 10 further satisfies the conditional expression V1+V2+V3≤110.000, preferably may satisfy: 90.000≤V1+V2+V3≤110.000.

(2) A periphery region 354 of the object-side surface 35 of the third lens element 3 is concave, an optical axis region 361 of the image-side surface 36 of the third lens element 3 is convex, the fifth lens element 5 has positive refracting power, and the optical imaging lens 10 further satisfies the conditional expression V1+V2+V3≤110.000, preferably may satisfy: 90.000≤V1+V2+V3≤110.000.

(3) An optical axis region 462 of the image-side surface 46 of the fourth lens element 4 is concave, the fifth lens element 5 has positive refracting power, an optical axis region 651 of the object-side surface 65 of the sixth lens element 6 is convex and the optical imaging lens 10 further satisfies the conditional expressions: ImgH/D11t21≥4.000, D52t62/D12t22≥1.600, preferably may satisfy: 4.000≤ImgH/D11t21≤12.000, 1.600≤D52t62/D12t22≤2.600.

One of the object-side surface and the image-side surface of the lens element of the embodiments of the disclosure is aspherical surface and acts in concert with the design of concave/convex surface shapes of the lens elements so as to enhance the yield of injection molding manufacturing.

One of the object-side surface and the image-side surface of the lens element of the embodiments of the disclosure is free form surface. The curve which is intersected by the free form surface and the first reference plane containing the optical axis is the first curve. The curve which is intersected by the free form surface and the second reference plane containing the optical axis is the second curve. The first reference plane and the second reference plane intersect on the optical axis and do not coincides with each other. When the first curve on the first reference plane is rotated onto the second reference plane with the optical axis as the rotation axis, the first curve and the second curve do not coincides with each other, and acts in concert with the design of concave/convex surface shapes of the lens elements in favor of fine tuning different aberrations of the optical imaging lens, especially the absolute value of the distortion aberration is equal to or smaller than 5.000%. The absolute value of the distortion aberration is equal to or smaller than 4.000% if acting in concert with the eight lens elements. The free form surface acts in concert with the light-shielding film with the rectangular clear hole is in favor of reducing stray lights.

The free form surface of the embodiments of the disclosure satisfies the following conditions: a perpendicular distance between the free form surface at X=a and Y=b, and a tangent plane at a vertex of the free form surface on the optical axis I constitutes a SagA. And a perpendicular distance between the free form surface at X=−b and Y=a, and a tangent plane at a vertex of the free form surface on the optical axis I constitutes a SagB. Where SagA is not equal to SagB. This may provide an optical imaging lens with a large field of view angle while maintaining desired imaging quality that the absolute value of the distortion aberration is less than 6.000%, wherein the difference between SagA and SagB is larger than lens production tolerance, and the lens production tolerance of the optical imaging lens adapted to the portable electronic apparatus is smaller than 1.000 μm.

The optical effective radius of the curve intersected by the free form surface of the embodiments of the disclosure and the first reference plane is different from the optical effective radius of the curve intersected by the free form surface and the second reference plane, so as to correct the aberration such as distortion aberration by designing different shape of the optical effective radius.

In the above free form surfaces in the embodiments of the disclosure, when the first curve on the first reference plane is rotated onto the second reference plane with the optical axis as the rotation axis, the maximum difference between the first curve and the second curve in a direction along the optical axis is greater than lens production tolerance, this may contribute to reduce distortion and other aberrations through designing different curvatures in different directions. Wherein the lens production tolerance of the optical imaging lens adapted to the portable electronic apparatus is smaller than 1.000 μm. When the free form surfaces satisfy: the difference between the corresponding Sag values at the two selected coordinate values on the XY plane is greater than lens production tolerance, this may contribute to reduce distortion and other aberrations through designing different curvatures in different directions, wherein the lens production tolerance of the optical imaging lens adapted to the portable electronic apparatus is smaller than 1.000 μm.

In brief, after the free form surface is introduced into the lens element in the embodiments of the disclosure, more parameters may further be used for designing the surface structures of the lens element (i.e., the flexibility of design is increased) to facilitate the reducing of distortion aberration.

A numerical range including maximum and minimum values that is obtained based on combination and proportional relationships of the optical parameters disclosed in the embodiments of the disclosure may be implemented according thereto.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An optical imaging lens, sequentially comprising a first lens element, a second lens element, a third lens element, a fourth lens element, a fifth lens element, a seventh lens element and a sixth lens element from an object side to an image side along an optical axis, wherein each of the first lens element to the seventh lens element comprises an object-side surface facing the object side and allowing imaging rays to pass through and an image-side surface facing the image side and allowing the imaging rays to pass through, wherein,
the first lens element is arranged to be a lens element in a first order from the object side to the image side and the first lens element has negative refracting power, and an optical axis region of the image-side surface of the first lens element is concave;
the second lens element is arranged to be a lens element in a second order from the object side to the image side;
the third lens element is arranged to be a lens element in a third order from the object side to the image side, and a periphery region of the object-side surface of the third lens element is convex;
the fourth lens element is arranged to be a lens element in a fourth order from the object side to the image side;
the fifth lens element is arranged to be a lens element in a fifth order from the object side to the image side;
the seventh lens element is arranged to be a lens element in a sixth order from the object side to the image side;
the sixth lens element is arranged to be a lens element in a last order from the object side to the image side, each of the object-side surface and the image-side surface of the sixth lens element is a free form surface,
wherein the lens elements of the optical imaging lens are only the above seven lens elements,
wherein a first reference plane and a second reference plane both include the optical axis, and an optical effective radius of a first curve intersected by the free form surface and the first reference plane is different from an optical effective radius of a second curve intersected by the free form surface and the second reference plane.

2. The optical imaging lens according to claim 1, wherein the free form surface satisfies the following condition: a tangent plane is tangent to the free form surface at a reference point, the optical axis passes through the reference point and is perpendicular to the tangent plane, the tangent plane intersects the first reference plane on an X-axis, the tangent plane intersects the second reference plane on a Y-axis, the reference point, the X axis and the Y axis form an XY coordinate plane, there is a first coordinate X=a, Y=b on the XY coordinate plane, a vertical distance between the first coordinate and the free form surface is SagA, there is a second coordinate X=−b, Y=a on the XY coordinate plane, and a vertical distance between the second coordinate and the free form surface is SagB, wherein SagA is not equal to Sag B.

3. The optical imaging lens according to claim 1, wherein the optical imaging lens further satisfies the following conditional expression: D21t42/T5≤2.800, wherein D21t42 is a distance from the object-side surface of the second lens element to the image-side surface of the fourth lens element along the optical axis, and T5 is a thickness of the fifth lens element along the optical axis.

4. The optical imaging lens according to claim 1, wherein the optical imaging lens further satisfies the following conditional expression: ALT/(T5+T6)≤2.800, wherein ALT is a sum of thicknesses of the first lens element, the second lens element, the third lens element, the fourth lens element, the fifth lens element and the sixth lens element along the optical axis, T5 is a thickness of the fifth lens element along the optical axis, and T6 is a thickness of the sixth lens element along the optical axis.

5. The optical imaging lens according to claim 1, wherein the optical imaging lens further satisfies the following conditional expression: (T1+T2+T4+T6)/D52t62≤3.000, wherein T1 is a thickness of the first lens element along the optical axis, T2 is a thickness of the second lens element along the optical axis, T4 is a thickness of the fourth lens element along the optical axis, T6 is a thickness of the sixth lens element along the optical axis, and D52t62 is a distance from the image-side surface of the fifth lens element to the image-side surface of the sixth lens element along the optical axis.

6. The optical imaging lens according to claim 1, wherein an optical axis region of the object-side surface of the fourth lens element is concave.

7. The optical imaging lens according to claim 1, wherein a thickness of the sixth lens element on the optical axis is greater than a thickness of the seventh lens element on the optical axis.

8. An optical imaging lens, sequentially comprising a first lens element, a second lens element, a third lens element, a fourth lens element, a fifth lens element, a seventh lens element and a sixth lens element from an object side to an image side along an optical axis, wherein each of the first lens element to the seventh lens element comprises an object-side surface facing the object side and allowing imaging rays to pass through and an image-side surface facing the image side and allowing the imaging rays to pass through, wherein,
the first lens element is arranged to be a lens element in a first order from the object side to the image side and the first lens element has negative refracting power;
the second lens element is arranged to be a lens element in a second order from the object side to the image side and the second lens element has positive refracting power;
the third lens element is arranged to be a lens element in a third order from the object side to the image side, and a periphery region of the object-side surface of the third lens element is convex;
the fourth lens element is arranged to be a lens element in a fourth order from the object side to the image side;
the fifth lens element is arranged to be a lens element in a fifth order from the object side to the image side, and an optical axis region of the object-side surface of the fifth lens element is concave;
the seventh lens element is arranged to be a lens element in a sixth order from the object side to the image side;
the sixth lens element is arranged to be a lens element in a last order from the object side to the image side, each of the object-side surface and the image-side surface of the sixth lens element is a free form surface,
wherein the lens elements of the optical imaging lens are only the above seven lens elements,
wherein a first reference plane and a second reference plane both include the optical axis, and an optical effective radius of a first curve intersected by the free form surface and the first reference plane is different from an optical effective radius of a second curve intersected by the free form surface and the second reference plane.

9. The optical imaging lens according to claim 8, wherein in the free form surface, when the first curve on the first reference plane is rotated onto the second reference plane with the optical axis as a rotation axis, a maximum difference between the first curve and the second curve in a direction along the optical axis is greater than a production tolerance of the optical imaging lens.

10. The optical imaging lens according to claim 8, wherein the optical imaging lens further satisfies the following conditional expression: D11t31/G45≤8.000, wherein D11t31 is a distance from the object-side surface of the first lens element to the object-side surface of the third lens element along the optical axis, and G45 is a distance from the image-side surface of the fourth lens element to the object-side surface of the fifth lens element along the optical axis.

11. The optical imaging lens according to claim 8, wherein the optical imaging lens further satisfies the following conditional expression: ALT/(T3+T4)≤3.900, wherein ALT is a sum of thicknesses of the first lens element, the second lens element, the third lens element, the fourth lens element, the fifth lens element and the sixth lens element along the optical axis, T3 is a thickness of the third lens element along the optical axis, and T4 is a thickness of the fourth lens element along the optical axis.

12. The optical imaging lens according to claim 8, wherein the optical imaging lens further satisfies the following conditional expression: (T1+T2+T4+T6)/G45≤8.000, wherein T1 is a thickness of the first lens element along the optical axis, T2 is a thickness of the second lens element along the optical axis, T4 is a thickness of the fourth lens element along the optical axis, T6 is a thickness of the sixth lens element along the optical axis, and G45 is a distance from the image-side surface of the fourth lens element to the object-side surface of the fifth lens element along the optical axis.

13. The optical imaging lens according to claim 8, wherein an optical axis region of the image-side surface of the fifth lens element is convex.

14. The optical imaging lens according to claim 8, wherein a thickness of the fifth lens element on the optical axis is greater than a thickness of the third lens element on the optical axis.

15. An optical imaging lens, sequentially comprising a first lens element, a second lens element, a third lens element, a fourth lens element, a fifth lens element, a seventh lens element and a sixth lens element from an object side to an image side along an optical axis, wherein each of the first lens element to the seventh lens element comprises an object-side surface facing the object side and allowing imaging rays to pass through and an image-side surface facing the image side and allowing the imaging rays to pass through, wherein,
the first lens element is arranged to be a lens element in a first order from the object side to the image side and the first lens element has negative refracting power;
the second lens element is arranged to be a lens element in a second order from the object side to the image side;
the third lens element is arranged to be a lens element in a third order from the object side to the image side, and a periphery region of the object-side surface of the third lens element is convex;
the fourth lens element is arranged to be a lens element in a fourth order from the object side to the image side and an optical axis region of the image-side surface of the fourth lens element is concave;
the fifth lens element is arranged to be a lens element in a fifth order from the object side to the image side and an optical axis region of the object-side surface of the fifth lens element is concave;
the seventh lens element is arranged to be a lens element in a sixth order from the object side to the image side;
the sixth lens element is arranged to be a lens element in a last order from the object side to the image side, each of the object-side surface and the image-side surface of the sixth lens element is a free form surface,
wherein the lens elements of the optical imaging lens are only the above seven lens elements,
wherein a first reference plane and a second reference plane both include the optical axis, and an optical effective radius of a first curve intersected by the free form surface and the first reference plane is different from an optical effective radius of a second curve intersected by the free form surface and the second reference plane.

16. The optical imaging lens according to claim 15, wherein the first reference plane and the second reference plane intersect on the optical axis and do not coincide with each other, and when the first curve on the first reference plane is rotated onto the second reference plane with the optical axis as a rotation axis, the first curve and the second curve do not coincide with each other.

17. The optical imaging lens according to claim 15, wherein the optical imaging lens further satisfies the following conditional expression: D12t42/T5≤4.000, wherein D12t42 is a distance from the image-side surface of the first lens element to the image-side surface of the fourth lens element along the optical axis, and T5 is a thickness of the fifth lens element along the optical axis.

18. The optical imaging lens according to claim 15, wherein the optical imaging lens further satisfies the following conditional expression: ALT/(G45+G56)≤7.900, wherein ALT is a sum of thicknesses of the first lens element, the second lens element, the third lens element, the fourth lens element, the fifth lens element and the sixth lens element along the optical axis, G45 is a distance from the image-side surface of the fourth lens element to the object-side surface of the fifth lens element along the optical axis, and G56 is a distance from the image-side surface of the fifth lens element to the object-side surface of the sixth lens element along the optical axis.

19. The optical imaging lens according to claim 15, wherein the optical imaging lens further satisfies the following conditional expression: TL/(G56+T6+BFL)≤3.100, wherein TL is a distance from the object-side surface of the first lens element to the image-side surface of the sixth lens element along the optical axis, G56 is a distance from the image-side surface of the fifth lens element to the object-side surface of the sixth lens element along the optical axis, T6 is a thickness of the sixth lens element along the optical axis, and BFL is a distance from the image-side surface of the sixth lens element to an image plane along the optical axis.

20. The optical imaging lens according to claim 15, wherein the optical imaging lens further satisfies the following conditional expression: 1.400≤ImgH/EFL, wherein ImgH is an image height of the optical imaging lens, and EFL is an effective focal length of the optical imaging lens.
